(19) United States
(12) Patent Application Publication
(10) Pub. No.: US 2024/0388631 A1
(43) Pub. Date: Nov. 21, 2024

(54) OCCUPANT-CENTERED PREDICTIVE CONTROL OF DEVICES IN FACILITIES

(71) Applicant: View, Inc., Milpitas, CA (US)

(72) Inventors: Jack Kendrick Rasmus-Vorrath, Mountain House, CA (US); Galen Burrell, Louisville, CO (US); Roberto Alejandro Menchaca, San Jose, CA (US); Qingjun Wang, Vernon, CT (US); Nidhi Satyacharan Tiwari, San Jose, CA (US)

(21) Appl. No.: 18/688,561

(22) PCT Filed: Aug. 31, 2022
(86) PCT No.: PCT/US2022/075717

§ 371 Date: Mar. 1, 2024

Related U.S. Application Data
(63) Continuation-in-part of application No. 17/250,586, filed on Feb. 5, 2021.
(63) Continuation-in-part of application No. PCT/US19/46524, filed on Aug. 14, 2019.
(63) Continuation-in-part of application No. PCT/US19/23268, filed on Mar. 20, 2019.
Application No. PCT/US19/23268 is a continuation-in-part of application No. 16/013,770, filed on Jun. 20, 2018, now Pat. No. 10,802,372.
Application No. PCT/US19/46524 is a continuation-in-part of application No. 16/438,177, filed on Jun. 11, 2019, now Pat. No. 11,405,465.
Application No. 16/438,177 is a continuation of application No. 14/391,122, filed on Oct. 7, 2014, now Pat. No. 10,365,531.
(63) Continuation-in-part of application No. 15/347,677, filed on Nov. 9, 2016, now Pat. No. 10,048,561.
Application No. 15/347,677 is a continuation-in-part of application No. PCT/US2015/029675, filed on May 7, 2015.
Application No. 15/347,677 is a continuation-in-part of application No. 13/772,969, filed on Feb. 21, 2013, now Pat. No. 9,638,978.
(60) Provisional application No. 63/240,117, filed on Sep. 2, 2021.
(60) Provisional application No. 62/764,821, filed on Aug. 15, 2018.
(60) Provisional application No. 62/745,920, filed on Oct. 15, 2018.
(60) Provisional application No. 62/805,841, filed on Feb. 14, 2019.
(60) Provisional application No. 62/646,260, filed on Mar. 21, 2018.
(60) Provisional application No. 62/666,572, filed on May 3, 2018.
(60) Provisional application No. 61/624,175, filed on Apr. 13, 2012.
(60) Provisional application No. 61/991,375, filed on May 9, 2014.

(51) Int. Cl. H04L 67/125; G02F 1/163; G08C 17/02; G08C 23/04; H04Q 9/00

(52) U.S. Cl. CPC H04L 67/125; G02F 1/163; G08C 17/02; G08C 23/04; H04Q 9/00; G08C 2201/40; G08C 2201/93

(57) ABSTRACT

In various embodiments, methods, systems, software, and apparatuses for controlling devices of a facility are provided, e.g., based on user input and/or user preferences.

### RELATED APPLICATIONS

This application claim priority from U.S. Provisional Patent Application Ser. No. 63/240,117, filed Sep. 2, 2021, titled “OCCUPANT-CENTERED PREDICTIVE CONTROL OF DEVICES IN FACILITIES,” which is hereby incorporated by reference in its entirety for all purposes. This application relates as a Continuation-in-Part to International Patent Application Serial No. PCT/US21/27418, filed Apr. 15, 2021, titled “INTERACTION BETWEEN AN ENCLOSURE AND ONE OR MORE OCCUPANTS,” which claims priority from U.S. Provisional Patent Application Ser. No. 63/080,899, filed Sep. 21, 2020, titled “INTERACTION BETWEEN AN ENCLOSURE AND ONE OR MORE OCCUPANTS,” from U.S. Provisional Application Ser. No. 63/052,639, filed Jul. 16, 2020, titled “INDIRECT INTERACTIVE INTERACTION WITH A TARGET IN AN ENCLOSURE,” and from U.S. Provisional Application Ser. No. 63/010,977, filed Apr. 16, 2020, titled “INDIRECT INTERACTION WITH A TARGET IN AN ENCLOSURE.” This application also relates as a Continuation-in-Part of U.S. Patent Application Ser. No. 17/249,148 filed Feb. 22, 2021, titled “CONTROLLING OPTICALLY-SWITCHABLE DEVICES,” which is a Continuation of U.S. patent application Ser. No. 16/096,557, filed Oct. 25, 2018, titled “CONTROLLING OPTICALLY-SWITCHABLE DEVICES,” which is a National Stage Entry of International Patent Application Serial No. PCT/US17/29476, filed Apr. 25, 2017, titled “CONTROLLING OPTICALLY-SWITCHABLE DEVICES,” which claims priority from U.S. Provisional Application Ser. No. 62/327,880, filed Apr. 26, 2016, titled “CONTROLLING OPTICALLY-SWITCHABLE DEVICES,” which is a Continuation-in-Part of U.S. Patent Application Ser. No. 14/391,122, filed Oct. 7, 2014, now U.S. Pat. No. 10,365,531, issued Jul. 30, 2019, titled “APPLICATIONS FOR CONTROLLING OPTICALLY SWITCHABLE DEVICES,” which is a National Stage Entry of International Patent Application Serial No. PCT/US13/36456, filed Apr. 12, 2013, titled “APPLICATIONS FOR CONTROLLING OPTICALLY SWITCHABLE DEVICES,” which claims priority from U.S. Provisional Application Ser. No. 61/624,175, filed Apr. 13, 2012, titled “APPLICATIONS FOR CONTROLLING OPTICALLY SWITCHABLE DEVICES.” This application also relates as a Continuation-in-Part of U.S. patent application Ser. No. 16/946,947, filed Jul. 13, 2020, titled “AUTOMATED COMMISSIONING OF CONTROLLERS IN A WINDOW NETWORK,” which is a Continuation of U.S. patent application Ser. No. 16/462,916, filed May 21, 2019, titled “AUTOMATED COMMISSIONING OF CONTROLLERS IN A WINDOW NETWORK,” which is a Continuation of U.S. patent application Ser. No. 16/082,793, filed Sep. 6, 2018, and issued as U.S. Pat. No. 10,935,864 on Mar. 1, 2021, “titled “METHOD OF COMMISSIONING ELECTROCHROMIC WINDOWS.” U.S. patent application Ser. No. 16/462,916, filed May 21, 2019, titled “AUTOMATED COMMISSIONING OF CONTROLLERS IN A WINDOW NETWORK,” is also a National Stage Entry of International Patent Application Serial No. PCT/US17/62634, filed Nov. 20, 2017, titled “AUTOMATED COMMISSIONING OF CONTROLLERS IN A WINDOW NETWORK,” which claims priority from U.S. Provisional Patent Application Ser. No. 62/551,649, filed Aug. 29, 2017, titled “AUTOMATED COMMISSIONING OF CONTROLLERS IN A WINDOW NETWORK,” and from U.S. Provisional Patent Application Ser. No. 62/426,126, filed Nov. 23, 2016, titled “AUTOMATED COMMISSIONING OF CONTROLLERS IN A WINDOW NETWORK.” This application also relates as a Continuation-in-Part of U.S. patent application Ser. No. 16/950,774, filed Nov. 17, 2020, titled “DISPLAYS FOR TINTABLE WINDOWS,” which is a Continuation of U.S. Patent Application Ser. No. 16/608,157, filed Oct. 24, 2019, titled “DISPLAYS FOR TINTABLE WINDOWS,” which is a National Stage Entry of International Patent Application Serial No. PCT/US18/29476, filed Apr. 25, 2018, titled “DISPLAYS FOR TINTABLE WINDOWS,” which claims priority to (i) U.S. Provisional Patent Application Ser. No. 62/607,618, filed Dec. 19, 2017, titled “ELECTROCHROMIC WINDOWS WITH TRANSPARENT DISPLAY TECHNOLOGY FIELD,” (ii) U.S. Provisional Patent Application Ser. No. 62/523,606, filed Jun. 22, 2017, titled “ELECTROCHROMIC WINDOWS WITH TRANSPARENT DISPLAY TECHNOLOGY,” (iii) U.S. Provisional Patent Application Ser. No. 62/507,704, filed May 17, 2017, titled “ELECTROCHROMIC WINDOWS WITH TRANSPARENT DISPLAY TECHNOLOGY,” (iv) U.S. Provisional Patent Application Ser. No. 62/506,514, filed May 15, 2017, titled “ELECTROCHROMIC WINDOWS WITH TRANSPARENT DISPLAY TECHNOLOGY,” and (v) U.S. Provisional Patent Application Ser. No. 62/490,457, filed Apr. 26, 2017, titled “ELECTROCHROMIC WINDOWS WITH TRANSPARENT DISPLAY TECHNOLOGY.” This application also relates as a Continuation-in-Part of U.S. Patent Application Ser. No. 17/083,128, filed Oct. 28, 2020, titled “BUILDING NETWORK,” which is a Continuation of U.S. patent application Ser. No. 16/664,089, filed Oct. 25, 2019, titled “BUILDING NETWORK,” that is a National Stage Entry of International Patent Application Serial No. PCT/US19/30467, filed May 2, 2019, titled “EDGE NETWORK FOR BUILDING SERVICES,” which claims priority to U.S. Provisional Patent Application Ser. No. 62/666,033, filed May 2, 2018, titled “EDGE NETWORK FOR BUILDING SERVICES,” U.S. patent application Ser. No. 17/083,128, is also a Continuation-in-Part of International Patent Application Serial No. PCT/US18/29460, filed Apr. 25, 2018, titled “TINTABLE WINDOW SYSTEM FOR BUILDING SERVICES,” that claims priority to U.S. Provisional Patent Application Ser. No. 62/607,618, to U.S. Provisional Patent Application Ser. No. 62/523,606, to U.S. Provisional Patent Application Ser. No. 62/507,704, to U.S. Provisional Patent Application Ser. No. 62/506,514, and to U.S. Provisional Patent Application Ser. No. 62/490,457. This application also relates as a Continuation-in-Part of U.S. patent application Ser. No. 17/081,809, filed Oct. 27, 2020, titled “TINTABLE WINDOW SYSTEM COMPUTING PLATFORM,” which is a Continuation of U.S. Patent Application Ser. No. 16/608,159, filed Oct. 24, 2019, titled “TINTABLE WINDOW SYSTEM COMPUTING PLATFORM,” that is a National Stage Entry of International Patent Application Serial No. PCT/US18/29406, filed Apr. 25, 2018, titled “TINTABLE WINDOW SYSTEM COMPUTING PLATFORM,” which claims priority to U.S. Provisional Patent Application Ser. No. 62/607,618, U.S. Provisional Patent Application Ser. No. 62/523,606, U.S. Provisional Patent Application Ser. No. 62/507,704, U.S. Provisional Patent Application Ser. No. 62/506,514, and U.S. Provisional Patent Application Ser. No. 62/490,457. This application also relates as a Continuation-in-Part of U.S. patent application Ser. No. 17/232,598, filed Apr. 16, 2021, titled “TANDEM VISION WINDOW AND MEDIA DISPLAY,” that is a National Stage Entry of International Patent Application Serial No. PCT/US20/53641, filed Sep. 30, 2020, titled “TANDEM VISION WINDOW AND MEDIA DISPLAY,” which claims priority to U.S. Provisional Patent Application Ser. No. 62/911,271, filed Oct. 5, 2019, titled “TANDEM VISION WINDOW AND TRANSPARENT DISPLAY,” to U.S. Provisional Patent Application Ser. No. 62/952,207, filed Dec. 20, 2019, titled “TANDEM VISION WINDOW AND TRANSPARENT DISPLAY,” to U.S. Provisional Patent Application Ser. No. 62/975,706, filed Feb. 12, 2020, titled “TANDEM VISION WINDOW AND MEDIA DISPLAY,” to U.S. Provisional Patent Application Ser. No. 63/085,254, filed Sep. 30, 2020, titled “TANDEM VISION WINDOW AND MEDIA DISPLAY.” This application also relates as a Continuation-in-Part of International Application Serial No. PCT/US2021/052587, filed Sep. 29, 2021, titled “DISPLAY CONSTRUCT FOR MEDIA PROJECTION AND WIRELESS CHARGING,” which claims benefit of priority to: U.S. Provisional Patent Application Ser. No. 63/170,245, filed Apr. 2, 2021, titled “DISPLAY CONSTRUCT FOR MEDIA PROJECTION AND WIRELESS CHARGING,” of U.S. Provisional Patent Application Ser. No. 63/154,352, filed Feb. 26, 2021, titled “DISPLAY CONSTRUCT FOR MEDIA PROJECTION AND WIRELESS CHARGING,” and of U.S. Provisional Patent Application Ser. No. 63/115,842, filed Nov. 19, 2020, titled “DISPLAY CONSTRUCT FOR MEDIA PROJECTION.” This application also relates as a Continuation-in-Part to U.S. patent application Ser. No. 17/250,586, filed Feb. 5, 2021, titled “CONTROL METHODS AND SYSTEMS USING EXTERNAL 3D MODELING AND NEURAL NETWORKS,” which is a National Stage Entry of International Patent Application Serial No. PCT/US19/46524, filed Aug. 14, 2019, titled “CONTROL METHODS AND SYSTEMS USING EXTERNAL 3D MODELING AND NEURAL NETWORKS,” which claims benefit of and priority to U.S. Provisional Patent Application Ser. No. 62/764,821, filed Aug. 15, 2018, titled “CONTROL METHODS AND SYSTEMS USING EXTERNAL 3D MODELING AND NEURAL NETWORKS,” to U.S. Provisional Patent Application Ser. No. 62/745,920, filed Oct. 15, 2018, titled “CONTROL METHODS AND SYSTEMS USING EXTERNAL 3D MODELING AND NEURAL NETWORKS,” and to U.S. Provisional Patent Application Ser. No. 62/805,841, filed Feb. 14, 2019, titled “CONTROL METHODS AND SYSTEMS USING EXTERNAL 3D MODELING AND NEURAL NETWORKS.” International Patent Application Serial No. PCT/US19/46524 is also a Continuation-in-Part of International Patent Application Serial No. PCT/US19/23268, filed Mar. 20, 2019, titled “CONTROL METHODS AND SYSTEMS USING EXTERNAL 3D MODELING AND SCHEDULE-BASED,” which claims benefit of and priority to U.S. Provisional Patent Application Ser. No. 62/646,260, filed Mar. 21, 2018, titled “METHODS AND SYSTEMS FOR CONTROLLING TINTABLE WINDOWS WITH CLOUD DETECTION,” and U.S. Provisional Patent Application Ser. No. 62/666,572, filed May 3, 2018, titled “CONTROL METHODS AND SYSTEMS USING EXTERNAL 3D MODELING AND SCHEDULE-BASED COMPUTING,” International Application Serial No. PCT/US19/23268 is a Continuation-in-Part of U.S. patent application Ser. No. 16/013,770, filed Jun. 20, 2018, titled “CONTROL METHOD FOR TINTABLE WINDOWS,” which is a Continuation of U.S. patent application Ser. No. 15/347,677, filed Nov. 9, 2016, titled “CONTROL METHOD FOR TINTABLE WINDOWS,” U.S. patent application Ser. No. 15/347,677 is a Continuation-in-Part of International Patent Application Serial No. PCT/US15/29675, filed May 7, 2015, titled “CONTROL METHOD FOR TINTABLE WINDOWS,” which claims benefit and priority to U.S. Provisional Patent Application Ser. No. 61/991,375, filed May 9, 2014, titled “CONTROL METHOD FOR TINTABLE WINDOWS,” U.S. patent application Ser. No. 15/347,677 is also a Continuation-in-Part of U.S. patent application Ser. No. 13/772,969, filed Feb. 21, 2013, titled “CONTROL METHOD FOR TINTABLE WINDOWS.” International Patent Application Serial No. PCT/US19/46524 is also a Continuation-in-Part of U.S. Patent Application Ser. No. 16/438,177, filed Jun. 11, 2019, titled “APPLICATIONS FOR CONTROLLING OPTICALLY SWITCHABLE DEVICES,” which is a Continuation of U.S. Patent Application Ser. No. 14/391,122, filed Oct. 7, 2014, titled “APPLICATIONS FOR CONTROLLING OPTICALLY SWITCHABLE DEVICES;” U.S. patent application Ser. No. 14/391,122, is a National Stage Entry of International Patent Application Serial No. PCT/US13/36456, filed Apr. 12, 2013, titled “APPLICATIONS FOR CONTROLLING OPTICALLY SWITCHABLE DEVICES,”, which claims priority to and benefit of U.S. Provisional Application Ser. No. 61/624,175, filed Apr. 13, 2012, titled “APPLICATIONS FOR CONTROLLING OPTICALLY SWITCHABLE DEVICES,” each of these applications is hereby incorporated by reference in its entirety and for all purposes. This application also relates as a Continuation-in-Part to U.S. patent application Ser. No. 17/666,355, filed Feb. 7, 2022, titled “APPLICATIONS FOR CONTROLLING OPTICALLY SWITCHABLE WINDOWS,” which is a continuation of U.S. Patent Application Ser. No. 16/438,177, filed Jun. 11, 2019, which is a Continuation of U.S. Patent Application Ser. No. 14/391,122, filed Oct. 7, 2014, which is a National Stage Entry of International Patent Application Serial No. PCT/US13/36456, filed Apr. 12, 2013, which claims the benefit of U.S. Provisional Application Ser. No. 61/624,175, filed Apr. 13, 2012. Each of the above recited patent applications is entirely incorporated herein by reference.

### BACKGROUND

Devices that can be controlled to alter an environment (e.g., of a facility or building) may be prescriptively controlled, for example, based on objective factors. However, such prescriptive control may not account for individual preferences. Controlling environmental control devices based on objective factors may cause individuals to be uncomfortable in their environment.

### SUMMARY

Various aspects disclosed herein alleviate as least part of the above-referenced shortcomings. Various aspects herein relate to user preferences in the form of user input that may be used to train a behavioral model. The behavioral model may be used to learn individual preferences for a particular user and/or predicted preferences based at least in part on historic preference of the user, similar users and/or facilities. The behavioral model can be used to recommend one or more actions (e.g., one or more overrides of device states) such that an action can be implemented based at least in part on learned user preferences and/or a permission hierarchy associated with users.

In another aspect, a method for controlling a facility, the method comprises: receiving an input from a user indicating that a first state of a device of the facility is to be altered to a second state, which input is received through a network; predicting a third state for the device at a future time at least in part by using a machine learning model that considers the input from the user; and suggesting the third state and/or (II) conditioning the device to be at the third state at the future time.

In some embodiments, the input is received via an application executing on a user device of the user. In some embodiments, suggesting the third state is to the user via the application executing on the user device. In some embodiments, suggesting the third state comprises (a) suggesting conditioning the device to be at the third state at the future time and/or (b) suggesting conditioning the device to be at the third state at a plurality of future times responsive to determining that a set of conditions have occurred, which set of conditions are under which the input was received. In some embodiments, the method comprises providing a user response to the suggestion to the machine learning model. In some embodiments, the machine learning model constructs a training sample based at least in part on the input received, and wherein the training sample is usable to generate future predictions by the machine learning model. In some embodiments, the facility is a first facility, wherein the user is a first user, and wherein the future predictions (i) are related to a second facility other than the first facility and/or (ii) are related to a second user other than the first user. In some embodiments, the device is a tintable window. In some embodiments, the device is an environmental conditioning system component, a security system component, a health system component, an electrical system component, a communication system component, and/or a personnel convection system component. In some embodiments, the personnel convection system comprises an elevator. In some embodiments, the environmental conditioning system comprises an HVAC component, or a lighting system component. In some embodiments, the communication system comprises a transparent media display. In some embodiments, the transparent media display (i) comprises a transparent organic light emitting diode array, and/or (ii) is operatively coupled to a tintable window. In some embodiments, the input is indicative of a user request to override the first state of the device to the second state of the device. In some embodiments, the first state was determined by a prescriptive model that determined the first state based at least in part on sensor readings associated with the facility, scheduling information associated with the facility, and/or weather information associated with a geographic location of the facility. In some embodiments, the input is received under a set of conditions, and wherein conditioning the device to be at the third state at the future time is responsive to detection of the set of conditions occurring at the future time. In some embodiments, suggesting the third state comprises suggesting the third state to a user other than the user from whom the input was received. In some embodiments, the third state is equal to the first state or the second state. In some embodiments, the machine learning model considers the input at least in part by causing the device to be conditioned at the third state at the future time. In some embodiments, the machine learning model considers the input at least in part by determining whether one or more parameters associated with the input match one or more parameters of (i) a rule-based pattern generated by the machine learning model and/or (ii) a heuristic used by the machine learning model. In some embodiments, the one or more parameters comprise timing information, user identifier information, building type information associated with the facility, and/or sensor information. In some embodiments, the sensor information is indicative of sun penetration depth, vertical and/or horizontal shadow, and/or light level. In some embodiments, the sensor information is indicative of activity level and/or occupancy level, in an enclosure of the facility. In some embodiments, the third state is associated with the rule-based pattern and/or heuristic matched. In some embodiments, the rule-based pattern and/or heuristic is generated based at least in part on data received from a plurality of users other than the user. In some embodiments, the data received from the plurality of users is associated with a plurality of enclosures of the facility, a plurality of facilities other than the facility, or any combination thereof. In some embodiments, the plurality of facilities have been identified as sharing at least one common characteristic with the facility based at least in part on a clustering of the plurality of facilities. In some embodiments, the at least one common characteristic comprises geographic information, weather pattern information, social preferences information, and/or building type information. In some embodiments, the machine learning model further considers a location of the user within and/or relative to the facility. In some embodiments, the location of the user within the facility is determined based at least in part on geolocation techniques, wherein the geolocation techniques optionally comprise radio frequency (RF) transmitting and/or sensing, and wherein the radio frequency optically comprises ultra-wideband (UWB) frequency. In some embodiments, the device is identified based at least in part on the location of the user within the facility. In some embodiments, the network is a network of the facility, wherein optionally at least a portion of the network (i) is a first network installed in the facility, (ii) is disposed in an envelope of the facility, (iii) is configured to transmit power and communication on a single cable, (iv) is configured to transmit a plurality of communication protocols.

In another aspect, an apparatus for controlling a facility, the apparatus comprises at least one processor configured to (I) operatively couple to a network and (II) execute, or direct execution of any of the methods disclosed above. In some embodiments, the at least one processor is part of a mobile device. In some embodiments, at least a portion of the at least one processor is included in at least one controller.

In another aspect, an apparatus for controlling a facility, the apparatus comprises at least one processor configured to: operatively couple to a network; receive, or direct receipt of, an input from a user indicating that a first state of a device of the facility is to be altered to a second state, which input is received through the network; receive, or direct receipt of, information indicative of a predicted third state for the device at a future time, wherein the predicted third state is determined by a machine learning model that considers the input from the user; and (I) suggest, or direct suggesting, to transition the device to the third state to be presented to the user and/or (II) receive, or direct receipt of, an indication that the device has been conditioned to be at the third state.

In another aspect, a non-transitory computer-readable program instructions for controlling a facility, the non-transitory computer-readable program instructions, when read by one or more processors operatively coupled to a network, cause the one or more processors to execute operations comprises executing, or directing execution of, any of the methods disclosed above. In some embodiments, the input is received from the user via a software application, and wherein the one or more processors are operatively coupled to the software application. In some embodiments, the software application is stored on the non-transitory computer-readable program instructions.

In another aspect, a non-transitory computer-readable program instructions for controlling a facility, the non-transitory computer-readable program instructions, when read by one or more processors, cause the one or more processors to execute operations comprises: receiving, or directing receipt of, an input from a user indicating that a first state of a device of the facility is to be altered to a second state, which input is received through a network; receiving, or directing receipt of, information indicative of a predicted third state for the device at a future time, wherein the predicted third state is determined by a machine learning model that considers the input from the user; and (I) presenting, or direction presentation of, a suggestion to transition to the third state and/or (II) receiving, or directing receipt of, an indication that the device has been conditioned to be at the third state.

In another aspect, a system for controlling a facility, the system comprises: a network configured to: (I) operatively couple to a device of the facility; and (II) transmit one or more signals associated with any of the methods disclosed above. In some embodiments, the device of the facility comprises a tintable window, a sensor, an emitter, a transceiver, a controller, a device ensemble, or an antenna. In some embodiments, the device ensemble comprises (a) sensors, (b) a transceiver, or (c) a sensor and an emitter, and wherein the device ensemble is house in a housing. In some embodiments, the network is configured to utilize a single cable to transmit power and communication. In some embodiments, the network is configured to transmit signals abiding by different communication protocols using a single cable. In some embodiments, the different communication protocols comprise cellular protocols, media protocols, control protocols, or data protocols. In some embodiments, the network is configured to transmit a signal to condition the device of the facility to be in a first state.

In another aspect, a system for controlling a facility, the system comprises: a network configured to: operatively couple to a device of the facility; transmit an input from a user indicating that a first state of the device of the facility is to be altered to a second state, which input is received through the network. transmit a prediction of a third state for the device at a future time, wherein the prediction is determined at least in part by using a machine learning model that considers the input from the user; and transmit (I) a suggestion of the third state and/or (II) instructions that condition the device to be at the third state at the future time. In some embodiments, the network is configured to transmit a signal to condition the device of the facility to be in a first state.

In another aspect, an apparatus for controlling a facility, the apparatus comprises at least one controller that is configured to: operatively couple to a device of the facility; condition, or direct conditioning of, the device of the facility to be in a first state of a plurality of state comprising the first state, a second state, and a third state; and condition, or direct conditioning of, the device to be at the third state at a future time, wherein the third state is predicted at the future time by a machine learning model that considers input from a user indicating that the first state of the device of the facility is to be altered to a second state, which input is received through a network. In some embodiments, the at least one controller is part of a hierarchical control system. In some embodiments, the hierarchical control system comprises at least three hierarchical levels.

In another aspect, a non-transitory computer-readable program instructions for controlling a facility, the non-transitory computer-readable program instructions, when read by one or more processors operatively coupled to the device of the facility, cause the one or more processors to execute operations comprises: operatively couple to a device of the facility; conditioning, or causing conditioning of, a device of the facility to be in a first state of a plurality of state comprising the first state, a second state, and a third state; and conditioning, or causing conditioning of, the device to be at the third state at a future time, wherein the third state is predicted at the future time by a machine learning model that considers input from a user indicating that the first state of the device of the facility is to be altered to a second state, which input is received through a network.

In some embodiments, at least one of the one or more processors are associated with a server. In some embodiments, the server is located in the facility. In some embodiments, the server is associated with a cloud service. In some embodiments, at least one processor is included in a microcontroller. In some embodiments, the microcontroller is part of a device ensemble comprising (a) sensors, (b) a transceiver, or (c) a sensor and an emitter, housed in a housing. In some embodiments, the device ensemble is located in a fixture of the facility, wherein the fixture comprises a floor, a ceiling, a wall, or a framing component.

In another aspect, a method for controlling a facility, the method comprises: obtaining from a user an input indicative of a preference associated with a present state of a device of the facility under a set of conditions, which input is obtained through a network; updating a database to include the input of the user; identifying, based at least in part on the database, an action to be associated with the set of conditions; and transmitting through the network one or more signals associated with the action.

In some embodiments, the input comprises feedback from the user regarding the present state of the device. In some embodiments, the action comprises conditioning the device to be at a future time at a different state other than the present state. In some embodiments, the action comprises suggesting conditioning the device to be at a future time at a different state other than the present state. In some embodiments, suggestion of the conditioning is provided to a user other than the user from whom the input is obtained. In some embodiments, the action to be associated with the set of conditions is identified at least in part by identifying (i) a rule-based pattern and/or (ii) heuristic associated with the set of conditions. In some embodiments, the set of conditions comprises timing information, user identifier information, building type information associated with the facility, and/or sensor information. In some embodiments, the sensor information is indicative of sun penetration depth, vertical and/or horizontal shadow, and/or light level. In some embodiments, the action is identified based at least in part on input obtained from a plurality of users other than the user. In some embodiments, the action is identified based at least in part on input obtained in association with a plurality of enclosures of the facility, a plurality of facilities other than the facility, or any combination thereof. In some embodiments, the device is a tintable window, and wherein the present state comprises a present tint level of the tintable window. In some embodiments, the one or more signals transmitted through the network cause the tintable window to transition to a different tint level associated with the action identified. In some embodiments, the device is: (i) an environmental conditioning system component, (ii) a security system component, (iii) a health system component, (iv) an electrical system component, (v) a communication system component, and/or (vi) a personnel convection system component. In some embodiments, the personnel convection system comprises an elevator. In some embodiments, the environmental conditioning system comprises (I) a heating, ventilation, and air conditioning (HVAC) system component, or (II) a lighting system component. In some embodiments, the communication system comprises a transparent media display. In some embodiments, the transparent media display (i) comprises a transparent organic light emitting diode (TOLED) array, and/or (ii) is operatively coupled to a tintable window. In some embodiments, the method further comprises: (I) obtaining a user response to the action identified; and (II) updating the database to include the user response to the action identified.

In another aspect, an apparatus for controlling a facility, the apparatus comprises at least one processor configured to (I) operatively couple to a network and (II) execute, or direct execution of, any of the methods disclosed above. In some embodiments, the at least one processor is part of a mobile device. In some embodiments, at least a portion of the at least one processor is included in at least one controller.

In another aspect, an apparatus for controlling a facility, the apparatus comprises at least one processor configured to: operatively couple to a device of the facility; obtain from a user, or direct obtainment of, an input indicative of a preference associated with a present state of the device of the facility under a set of conditions, which input is obtained through a network; transmit an indication of the input of the user, which transmission causes a database to be updated to include the input of the user; and receive one or more signals associated with an action, wherein the action is associated with the set of conditions, and wherein the action has been identified based at least in part on the database.

In another aspect, a non-transitory computer-readable program instructions for controlling a facility, the non-transitory computer-readable program instructions, when read by one or more processors operatively coupled to a network, cause the one or more processors to execute operations comprises executing, or directing execution of any of the methods disclosed above. In some embodiments, the input obtained from the user is obtained via a software application, and wherein the one or more processors are operative coupled to the software application. In some embodiments, the software application is stored on the non-transitory computer-readable program instructions.

In another aspect, a non-transitory computer-readable program instructions for controlling a facility, the non-transitory computer-readable program instructions, when read by one or more processors, cause the one or more processors to execute operations comprises: operatively coupling to a device of the facility; obtaining, or directing obtainment of, an input indicative of a preference associated with a present state of the device of the facility under a set of conditions, which input is obtained through a network; transmitting, or directing transmission of, an indication of the input of the user, which transmission causes a database to be updated to include the input of the user; and receiving, or directing receipt of, one or more signals associated with an action, wherein the action is associated with the set of conditions, and wherein the action has been identified based at least in part on the database.

In another aspect, a system for controlling a facility, the system comprises: a network configured to operatively couple to a device of the facility; and Direct transmitting of one or more signals associated with any of the methods disclosed above. In some embodiments, the device of the facility comprises a tintable window, a sensor, an emitter, a transceiver, a controller, a device ensemble, or an antenna. In some embodiments, the device ensemble comprises (a) sensors, (b) a transceiver, or (c) a sensor and an emitter, which device ensemble is enclosed in a housing. In some embodiments, the network is configured to transmit power and communication using a single cable. In some embodiments, the network is configured to transmit signals abiding by different communication protocols using a single cable. In some embodiments, the different communication protocols comprise cellular protocols, media protocols, control protocols, or data protocols. In some embodiments, the network is configured to transmit a signal to condition the device of the facility to be in a first state.

In another aspect, a system for controlling a facility, the system comprises: a network configured to: operatively couple to a device of the facility; transmit an input obtained from a user, the input indicative of a preference associated with a present state of a device of the facility under a set of conditions, which input is obtained through the network; transmit an indication of the input to a database, which transmission causes the database to be updated to include the input of the user; transmit an identification of an action, wherein the action is associated with the set of conditions, and wherein the action is identified based at least in part on the database; and transmit one or more signals associated with the action. In some embodiments, the network is configured to transmit a signal to condition the device of the facility to be in a first state.

In another aspect, an apparatus for controlling a facility, the apparatus comprises at least one controller configured to: operatively couple to a device of the facility; condition, or direct conditioning of, the device of the facility to a present state; and receive, or direct receipt of, one or more signals associated with an action, wherein the action is associated with a set of conditions and is identified based at least in part on a database, and wherein the action is identified in response to a user input indicative of a preference associated with the present state of the device of the facility under the set of conditions, which input is obtained through a network. In some embodiments, the at least one controller is part of a hierarchical control system. In some embodiments, the hierarchical control system comprises at least three hierarchical levels.

In another aspect, a non-transitory computer-readable program instructions for controlling a facility, the non-transitory computer-readable program instructions, when read by one or more processors, cause the one or more processors to execute operations comprises: operatively couple to a device of the facility; causing the device of the facility to be conditioned to a present state; and receiving, or directing receipt of, one or more signals associated with an action, wherein the action is associated with a set of conditions and is identified based at least in part on a database, and wherein the action is identified response to a user input indicative of a preference associated with the present state of the device of the facility under the set of conditions, which input is obtained through a network. In some embodiments, at least one of the one or more processors are associated with a server. In some embodiments, the server is located in the facility. In some embodiments, the server is associated with a cloud service. In some embodiments, at least one processor is a microcontroller. In some embodiments, the microcontroller is part of a device ensemble comprising (a) sensors, (b) a transceiver, or (c) a sensor and an emitter, which device ensemble is enclosed in a housing. In some embodiments, the device ensemble is located in a fixture of the facility, wherein the fixture comprises a floor, a ceiling, a wall, or a framing component.

In another aspect, a method for controlling a facility, the method comprises: receiving an input from a user, which input is indicative of a preference associated with a state of a device of the facility, which input is received through a network; determining whether to alter the state of the device based at least in part (i) on the input and (ii) on a user permission scheme, which determination of whether to alter the state of the device results in a positive determination or in a negative determination; and using the positive determination to alter the state of the device.

In some embodiments, the input is a feedback on a recommended state of the device. In some embodiments, the positive determination occurs in response to determining that the input indicates change of the state of the device of the facility and the user has permission to alter the state of the device. In some embodiments, the negative determination occurs in response to determining that the input does not indicate a change in the state of the device of the facility and/or the user does not have permission to alter the present state of the device. In some embodiments, the device is a tintable window, and wherein the state of the device comprises a tint state of the tintable window. In some embodiments, in response to the determination of whether to alter the state of the device results in the negative determination, the state of the device is not altered. In some embodiments, the device is an environmental conditioning system component, a security system component, a health system component, an electrical system component, a communication system component, and/or a personnel convection system component. In some embodiments, the personnel convection system comprises an elevator. In some embodiments, the environmental conditioning system comprises an HVAC component, or a lighting system component. In some embodiments, the communication system comprises a transparent media display. In some embodiments, the transparent media display (i) comprises a transparent organic light emitting diode array, and/or (ii) is operatively coupled to a tintable window. In some embodiments, the user permission scheme varies over time. In some embodiments, the user permission scheme varies over time based at least in part on energy considerations associated with the facility, health considerations associated with occupants of the facility, safety considerations associated with the facility, and/or jurisdictional considerations associated with the facility. In some embodiments, the user permission scheme indicates permissions for the user that vary based at least in part on a geographic location of the user relative to the facility. In some embodiments, the user permission scheme is based at least in part on a role of the user within an organization. In some embodiments, the user permission scheme is based at least in part on input from a plurality of users other than the user. In some embodiments, the user permission scheme indicates that the user is not permitted to alter the state of the device in response to determining that a majority of the plurality of users disagree with the input indicative of the preference.

In another aspect, an apparatus for controlling a facility, the apparatus comprises at least one processor configured to (I) operatively couple to a network and (II) execute, or direct execution of any of the methods disclosed above. In some embodiments, the at least one processor is part of a mobile device. In some embodiments, at least a portion of the at least one processor is included in at least one controller.

In another aspect, an apparatus for controlling a facility, the apparatus comprises at least one processor configured to: operatively couple to a device of the facility and to a network; receive, or direct receipt of, an input from a user, which input is indicative of a preference associated with a state of the device of the facility, which input is received through the network; determining, or directing determination of, whether to alter the state of the device based at least in part (i) on the input and (ii) on a user permission scheme, which determination of whether to alter the state of the device results in a positive determination or in a negative determination; and alter, or direct alteration of, the state of the device based at least in part on the positive determination.

In another aspect, a non-transitory computer-readable program instructions for controlling a facility, the non-transitory computer-readable program instructions, when read by one or more processors operatively coupled to a network, cause the one or more processors to execute operations comprises executing, or directing execution of any of the methods disclosed above. In some embodiments, the input is received from the user through a software application, and wherein at least one processor of the one or more processors executes the software application. In some embodiments, the software application is stored in the non-transitory computer-readable program instructions.

In another aspect, a non-transitory computer-readable program instructions for controlling a facility, the non-transitory computer-readable program instructions, when read by one or more processors, cause the one or more processors to execute operations comprises: operatively couple to a device of the facility and to a network; receiving, or directing receipt of, an input from a user, which input is indicative of a preference associated with a state of the device of the facility, which input is received through the network; determining, or directing determination of, whether to alter the state of the device based at least in part (i) on the input and (ii) on a user permission scheme, which determination of whether to alter the state of the device results in a positive determination or in a negative determination; and altering, or directing alteration of, the state of the device based at least in part on the positive determination.

In another aspect, a system for controlling a facility, the system comprises: a network configured to operatively couple to a device of the facility; and direct transmitting of one or more signals associated with any of the methods disclosed above. In some embodiments, the device of the facility comprises a tintable window, a sensor, an emitter, a transceiver, a controller, a device ensemble, or an antenna. In some embodiments, the device ensemble comprises (a) sensors, (b) a transceiver, or (c) a sensor and an emitter, which device ensemble is enclosed in a housing. In some embodiments, the network is configured to transmit power and communication using a single cable. In some embodiments, the network is configured to transmit signals abiding by different communication protocols using a single cable. In some embodiments, the different communication protocols comprise cellular protocols, media protocols, control protocols, or data protocols. In some embodiments, the network is configured to transmit a signal to condition the device of the facility to be in a first state.

In another aspect, a system for controlling a facility, the system comprises: a network configured to: transmit an input from a user, which input is indicative of a preference associated with a state of a device of the facility, which input is received through the network; transmit a determination of whether to alter the state of the device, wherein the determination is based at least in part (i) on the input and (ii) on a user permission scheme, which determination of whether to alter the state of the device results in a positive determination or in a negative determination; transmit instructions to alter the state of the device using the positive determination. In some embodiments, the network is configured to transmit a signal to condition the state of the device to be in a first state.

In another aspect, an apparatus for controlling a facility, the apparatus comprises at least one controller configured to: operatively couple to a device of the facility, and to a network; condition, or direct conditioning of, the device to a state of the device; determining, or directing determination of, whether to alter the state of the device based at least in part (i) on an input from a user and (ii) on a user permission scheme, which determination of whether to alter the state of the device results in a positive determination or in a negative determination, which input is received through the network; and alter, or direct alteration of, the state of the device based at least in part on the positive determination. In some embodiments, the at least one controller is configured to receive the input from the user from a database of user input in memory, and wherein the at least one controller is operatively coupled to the memory. In some embodiments, the input is received from the user through a software application, and wherein the at least one controller is operatively coupled to the software application. In some embodiments, the software application is stored in a non-transitory computer readable medium, and wherein the at least one controller is operatively coupled to the non-transitory computer readable medium.

In another aspect, a non-transitory computer-readable program instructions for controlling a facility, the non-transitory computer-readable program instructions, when read by one or more processors, cause the one or more processors to execute operations comprises: operatively couple to a device of the facility and to a network; condition, or directing conditioning of, the device to a state of the device; determining, or directing determination of, whether to alter the state of the device based at least in part (i) on an input from a user and (ii) on a user permission scheme, which determination of whether to alter the state of the device results in a positive determination or in a negative determination; and altering, or directing alteration of, the state of the device based at least in part on the positive determination, which input is received through the network. In some embodiments, at least one of the one or more processors are associated with a server. In some embodiments, the server is located in the facility. In some embodiments, the server is associated with a cloud service. In some embodiments, at least one processor is a microcontroller. In some embodiments, the microcontroller is part of a device ensemble comprising (a) sensors, (b) a transceiver, or (c) a sensor and an emitter, which device ensemble is enclosed in a housing. In some embodiments, the device ensemble is located in a fixture of the facility, wherein the fixture comprises a floor, a ceiling, a wall, or a framing component.

In some embodiments, the network is a local network. In some embodiments, the network comprises a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. In some embodiments, the communication comprises media communication facilitating stills, music, or moving picture streams (e.g., movies or videos). In some embodiments, the communication comprises data communication (e.g., sensor data). In some embodiments, the communication comprises control communication, e.g., to control the one or more nodes operatively coupled to the networks. In some embodiments, the network comprises a first (e.g., cabling) network installed in the facility. In some embodiments, the network comprises a (e.g., cabling) network installed in an envelope of the facility (e.g., in an envelope of a building included in the facility).

In another aspect, the present disclosure provides systems, apparatuses (e.g., controllers), and/or non-transitory computer-readable medium or media (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In some embodiments, one controller of the at least one controller is configured to perform two or more operations. In some embodiments, two different controllers of the at least one controller are configured to each perform a different operation.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product (e.g., inscribed on one or more non-transitory medium) in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable program instructions (e.g., included in a program product comprising one or more non-transitory medium) comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium or media comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium or media coupled thereto. The non-transitory computer-readable medium comprises machine-executable code that, upon execution by the one or more processors, implements any of the methods disclosed herein and/or effectuates directions of the controller(s) disclosed herein.

In another aspect, the present disclosure provides a non-transitory computer readable program instructions that, when read by one or more processors, causes the one or more processors to execute any operation of the methods disclosed herein, any operation performed (or configured to be performed) by the apparatuses disclosed herein, and/or any operation directed (or configured to be directed) by the apparatuses disclosed herein.

In some embodiments, the program instructions are inscribed in a non-transitory computer readable medium or media. In some embodiments, at least two of the operations are executed by one of the one or more processors. In some embodiments, at least two of the operations are each executed by different processors of the one or more processors.

In another aspect, the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can be a building automation and control networks protocol (BACnet). For example, a communication protocol may facilitate cellular communication abiding by at least a 2nd, 3rd, 4th, or 5th generation cellular communication protocol.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 shows a perspective view of an enclosure (e.g., a building) and a control system;

FIG. 2 schematically depicts a processing system;

FIG. 3 shows a block diagram of an example master controller (MC);

FIG. 4 shows a block diagram of an example network controller (NC);

FIG. 5 illustrates an example control;

FIG. 6 shows an apparatus including a sensor ensemble and its components and connectivity options;

FIG. 7 is a schematic diagram of an example of a building and a building management system (BMS).

FIG. 8 is schematic diagram depicting the general system architecture of systems and users involved in maintaining clear sky models on a cloud network and controlling the tintable windows of a building based on data derived from output from the models, according to various implementations.

FIG. 9 an illustrated example of the flow of data communicated between system components.

FIG. 10 schematically depicts use of a behavioral model.

FIG. 11 schematically depicts interaction of various layers of control components.

FIG. 12 schematically depicts use of a behavioral model.

FIG. 13 illustrates use of direct and indirect feedback in connection with a behavioral model.

FIG. 14 illustrates use of user feedback in connection with a behavioral model.

FIG. 15 shows example user interfaces.

FIG. 16 shows example user interfaces.

FIG. 17 is a flow chart for a control method.

FIG. 18 is a flow chart for a control method.

FIG. 19 is a flow chart for a control method.

FIG. 20 is a flow chart for a control method.

FIG. 21 is a flow chart for a control method.

FIG. 22 is a flow chart for a control method.

FIG. 23 is a schematic illustration of a system for a remote device presenting a user interface for an application that controls a device on a network.

FIG. 24 depicts an enclosure communicatively coupled to its digital twin representation;

FIG. 25 schematically shows a building and a network.

FIG. 26 schematically shows an electrochromic device;

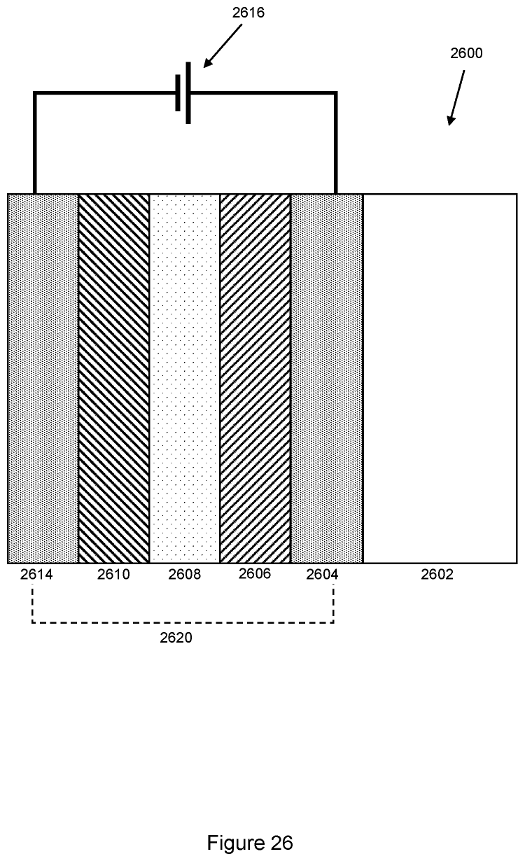

FIG. 27 shows a cross-sectional view of an example electrochromic window;

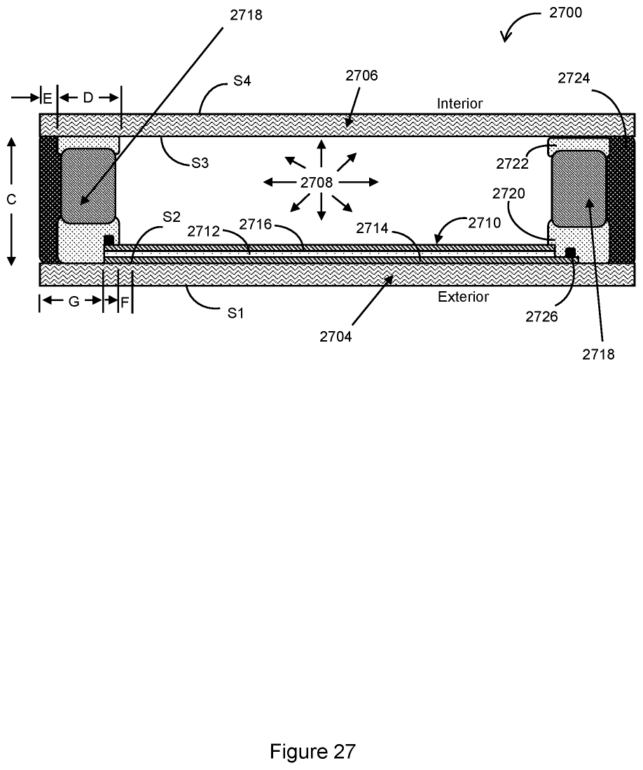

FIG. 28 illustrates a voltage profile as a function of time;

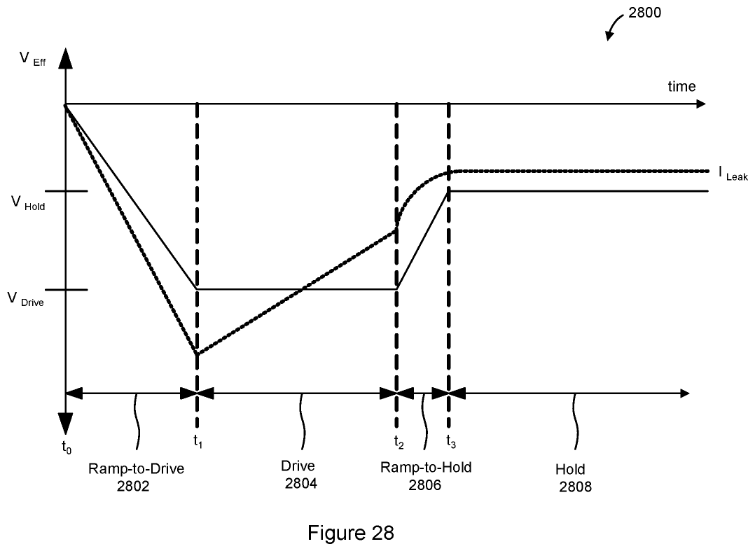

FIG. 29 shows a flow chart for a control method;

FIG. 30 shows various control system components and their description;

FIG. 31 shows operations and associated data related to a simulation process; and

FIG. 32 shows graphs of sensor values as a function of time.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling. The non-physical coupling may comprise signal-induced coupling (e.g., wireless coupling). Coupled can include physical coupling (e.g., physically connected), or non-physical coupling (e.g., via wireless communication). Additionally, in the following description, the phrases “operable to,” “adapted to,” “configured to,” “designed to,” “programmed to,” or “capable of” may be used interchangeably where appropriate.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

The following detailed description is directed to specific example implementations for purposes of disclosing the subject matter. Although the disclosed implementations are described in sufficient detail to enable those of ordinary skill in the art to practice the disclosed subject matter, this disclosure is not limited to particular features of the specific example implementations described herein. On the contrary, the concepts and teachings disclosed herein can be implemented and applied in a multitude of different forms and ways without departing from their spirit and scope. For example, while the disclosed implementations focus on electrochromic windows (also referred to as smart windows), some of the systems, devices and methods disclosed herein can be made, applied or used without undue experimentation to incorporate, or while incorporating, other types of optically switchable devices that are actively switched/controlled, rather than passive coatings such as thermochromic coatings or photochromic coatings that tint passively in response to the sun's rays. Some other types of actively controlled optically switchable devices include liquid crystal devices, suspended particle devices, and micro-blinds, among others. For example, some or all of such other optically switchable devices can be powered, driven or otherwise controlled or integrated with one or more of the disclosed implementations of controllers described herein.

In some embodiments, an enclosure comprises an area defined by at least one structure (e.g., fixture). The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame and/or wooden frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, an airplane, a ship, a vehicle, or a rocket).

In some embodiments, the enclosure encloses an atmosphere. The atmosphere may comprise one or more gases. The gases may include inert gases (e.g., comprising argon or nitrogen) and/or non-inert gases (e.g., comprising oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), debris (e.g., dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), debris (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity and/or content of the gas in the enclosure may be (e.g., substantially) similar throughout the enclosure. The velocity and/or content of the gas in the enclosure may be different in different portions of the enclosure (e.g., by flowing gas through to a vent that is coupled with the enclosure). The gas content may comprise relative gas ratio.

In some embodiments, a network infrastructure is provided in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network may comprise one or more levels of encryption. The network may be communicatively coupled to the cloud and/or to one or more servers external to the facility. The network may support at least a fourth generation wireless (4G), or a fifth-generation wireless (5G) communication. The network may support cellular signals external and/or internal to the facility. The downlink communication network speeds may have a peak data rate of at least about 5 Gigabits per second (Gb/s), 10 Gb/s, or 20 Gb/s. The uplink communication network speeds may have a peak data rate of at least about 2 Gb/s, 5 Gb/s, or 10 Gb/s. The network infrastructure can be provided in a facility that includes electrically switchable windows. Examples of components of the network infrastructure include a high speed backhaul. The network infrastructure may include at least one cable, switch, (e.g., physical) antenna, transceivers, sensor, transmitter, receiver, radio, processor and/or controller (that may comprise a processor). The network infrastructure may be operatively coupled to, and/or include, a wireless network. The network infrastructure may comprise wiring (e.g., comprising an optical fiber, twisted cable, or coaxial cable). One or more devices (e.g., sensors and/or emitters) can be deployed (e.g., installed) in an environment, e.g., as part of installing the network infrastructure and/or after installing the network infrastructure. The device(s) may be communicatively coupled to the network. The network may comprise a power and/or communication network. The device can be self-discovered on the network, e.g., once it couples (e.g., on its attempt to couple) to the network. The network structure may comprise peer to peer network structure, or client-server network structure. The network may or may not have a central coordination entity (e.g., server(s) or another stable host). The network may be a local network. The network may comprise a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. The communication may comprise media communication facilitating stills, music, or moving picture streams (e.g., movies or videos). The communication may comprise data communication (e.g., sensor data). The communication may comprise control communication, e.g., to control the one or more nodes operatively coupled to the networks. The network may comprise a first (e.g., cabling) network installed in the facility. The network may comprise a (e.g., cabling) network installed in an envelope of the facility (e.g., such as in an envelope of an enclosure of the facility. For example, in an envelope of a building included in the facility).

In some embodiments, a network uses one or more communication protocols to transmit communications between devices operatively coupled to the network. The devices may include user devices (e.g., mobile phones, tablet computer, wearable computers, desktop computers, laptop computers, gaming consoles, vehicle information and/or entertainment systems, or the like), controllable devices (e.g., one or more tintable windows, a media display, components of an HVAC system, components of a lighting system, or the like), intermediate controllers that transmit and/or receive communications from other controllers (e.g., a master controller, an end (e.g., local) controller, etc.), or the like. In some embodiments, the communication protocols may include automation control protocols. In some embodiments, control protocols may be used to transmit instructions to devices that may be controlled, for example, instructions to perform particular actions. Examples of control protocols include: a vehicle bus standard that allows controllers and/or devices to communicate with each other without use of an intermediate host computer, such as Controller Area Network (CAN) protocol or CAN-based protocols (e.g., 11939, ISO11783, etc.); an automotive network communications protocol, such as FlexRay; a vehicle-based or automotive-based high-speed serial communications and/or isochronous real-time data transfer protocol, such as IDB-1394; a communication bus protocol for devices within a vehicle, such as IEBus; a serial communications control protocol (e.g., 11708, or other serial communications control protocols); a communications protocol for on-board diagnostics of vehicle components, such as Keyword Protocol 2000 (KWP2000); a serial network protocol for communication between components of a vehicle, such as Logical Interconnect Network (LIN); a high-speed multimedia network technology for communication of audio, voice, video and/or other data, such as Media Oriented Systems Transport (MOST); a real-time distributed computing and/or communication protocol for intravehicle communication, such as UAVCAN; a vehicle bus protocol that uses a serial protocol, such as Vehicle Area Network (VAN), or the like. In some embodiments, the communication protocols may include cellular communication protocols. Cellular communication protocols may comprise a fourth generation (4G) communication protocol and/or a fifth generation (5G) communication protocol. In some embodiments, the communication protocols may include media protocols. Media protocols may include one or more protocols used to stream, present, and/or control presentation of media content on media devices and/or displays. Examples of media protocols include: a network control protocol to control streaming media servers and/or establishing and/or controlling media sessions, such as real-time streaming protocol (RTSP); a network protocol for delivering media content (e.g., video and/or audio) over Internet Protocol (IP) networks, such as real-time transport protocol (RTCP); a protocol associated with the IP suite, such as transmission control protocol (TCP); unicast protocols used for one-to-one communication between devices; multicast protocols for one-to-many communication between devices, or the like. In some embodiments, a network may be configured to use combinations of different communication protocols. For example, the network may be configured to receive data from a first device using a first communications protocol and transmit data to a second device using a second communications protocol. In one example, the network can receive data from the first device using a wireless communications protocol (e.g., 4G cellular communications protocol, 5G cellular communications protocol, or the like) and transmit data to the second device using an automation control protocol (e.g., a CAN protocol or a CAN-based protocol, VAN, etc.). In some embodiments, the network may be configured to translate instructions and/or other data from one protocol to another, different protocol. In some embodiments, the network may be configured to identify a protocol to be used based at least in part on an identity of a device (or a type of device) that is sending and/or receiving communications.

In another embodiment the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can comprise a building automation and control networks protocol (BACnet). The network may be configured for (e.g., include hardware facilitating) communication protocols comprising BACnet (e.g., BACnet/SC), LonWorks, Modbus, KNX, European Home Systems Protocol (EHS), BatiBUS, European Installation Bus (EIB or Instabus), zigbee, Z-wave, Insteon, X10, Bluetooth, or WiFi. The network may be configured to transmit the control related protocol. A communication protocol may facilitate cellular communication abiding by at least a 2^{nd}, 3^{rd}, 4^{th}, or 5^{th} generation cellular communication protocol. The (e.g., cabling) network may comprise a tree, line, or star topologies. The network may comprise interworking and/or distributed application models for various tasks of the building automation. The control system may provide schemes for configuration and/or management of resources on the network. The network may permit binding of parts of a distributed application in different nodes operatively coupled to the network. The network may provide a communication system with a message protocol and models for the communication stack in each node (capable of hosting distributed applications (e.g., having a common Kernel). The control system may comprise programmable logic controller(s) (PLC(s)). In some embodiments, the network may utilize a vehicle bus standard (e.g., by utilizing a CANBus protocol, a CANOpen protocol, or the like) that allows various controllers and/or devices to communicate (e.g., transmit and/or receive message) with each other directly (e.g., without using an intermediate host computer). In some implementations, messages may be transmitted sequentially. In some implementations, messages may be prioritized for transmission on the bus.

In some embodiments, prioritization may be based at least in part on priorities of devices. In one example, in instances in which two or more devices transmit messages simultaneously and/or concurrently, messages may be transmitted via the bus based at least in part on priorities of the two or more devices.

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows).

The tintable window may be disposed in a (non-transitory) facility such as a building, and/or in a transitory facility (e.g., vehicle) such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, a building management system (BMS) is a computer-based control system. The BMS can be installed in a facility to monitor and otherwise control (e.g., regulate, manipulate, restrict, direct, monitor, adjust, modulate, vary, alter, restrain, check, guide, or manage) the facility. For example, the BMS may control one or more devices communicatively coupled to the network. The one or more devices may include mechanical and/or electrical equipment such as ventilation, lighting, power systems, elevators, fire systems, and/or security systems. Controllers (e.g., nodes and/or processors) may be suited for integration with a BMS. A BMS may include hardware. The hardware may include interconnections by communication channels to one or more processors (e.g., and associated software), e.g., for maintaining one or more conditions in the facility. The one or more conditions in the facility may be according to preference(s) set by a user (e.g., an occupant, a facility owner, and/or a facility manager). For example, a BMS may be implemented using a local area network, such as Ethernet. The software can utilize, e.g., internet protocols and/or open standards. One example is software from Tridium, Inc. (of Richmond, Va.). One communication protocol that can be used with a BMS is BACnet (building automation and control networks). A node can be any addressable circuitry. For example, a node can be a circuitry that has an Internet Protocol (IP) address.

In some embodiments, a BMS may be implemented in a facility, e.g., a multi-story building. The BMS may function (e.g., also) to control one or more characteristics of an environment of the facility. The one or more characteristics may comprise: temperature, carbon dioxide levels, gas flow, various volatile organic compounds (VOCs), and/or humidity in a building. There may be mechanical devices that are controlled by a BMS such as one or more heaters, air conditioners, blowers, and/or vents. To control the facility environment, a BMS may turn these various devices on and/or off under defined conditions. A core function of a BMS may be to maintain a comfortable environment for occupants of the environment, e.g., while minimizing heating and cooling costs and/or demand. A BMS can be used to control one or more of the various systems. A BMS may be used to optimize the synergy between various systems. For example, the BMS may be used to conserve energy and lower building operation costs.

In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m², from about 250 m² to about 1000 m², or from about 1000 m² to about 2000 m²). The building may comprise an area of at least about 1000 square feet (sqft), 2000 sqft, 5000 sqft, 10000 sqft, 100000 sqft, 150000 sqft, 200000 sqft, or 500000 sqft. The building may comprise an area between any of the above mentioned areas (e.g., from about 1000 sqft to about 5000 sqft, from about 5000 sqft to about 500000 sqft, or from about 1000 sqft to about 500000 sqft). The building may comprise an area of at least about 100 m², 200 m², 500 m², 1000 m², 5000 m², 10000 m², 25000 m², or 50000 m². The building may comprise an area between any of the above mentioned areas (e.g., from about 100m² to about 1000 m², from about 500m² to about 25000 m², from about 100m² to about 50000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions. The facility may comprise at least about 1, 2, 5, 10, 50, 100, 150, 200, 250, 300, 350, 400, 420, 450, 500, or 550 windows (e.g., tintable windows). The windows may be divided into zones (e.g., based at least in part on the location, façade, floor, ownership, utilization of the enclosure (e.g., room) in which they are disposed, any other assignment metric, random assignment, or any combination thereof. Allocation of windows to the zone may be static or dynamic (e.g., based on a heuristic). There may be at least about 2, 5, 10, 12, 15, 30, 40, or 46 windows per zone.

In some embodiments, a local controller (e.g., window controller) is integrated with a BMS. The local controller may be directly connected to the device (e.g., without any (e.g., lower hierarchy) intervening controller between the local controller and the device). For example, the local controller can be configured to control one or more devices of the facility. For example, the window controller can be configured to control one or more tintable windows (e.g., electrochromic windows). In one embodiment, the one or more electrochromic windows include at least one all solid state and inorganic electrochromic device, but may include more than one electrochromic device, e.g., where each lite or pane of an IGU is tintable. In one embodiment, the one or more electrochromic windows include only all solid state and inorganic electrochromic devices. In one embodiment, the electrochromic windows are multistate electrochromic windows. Examples of tintable windows can be found in, in U.S. patent application Ser. No. 12/851,514, filed Aug. 5, 2010, titled “MULTIPANE ELECTROCHROMIC WINDOWS,” which is incorporated herein by reference in its entirety.

In some embodiments, one or more devices such as sensors, emitters, and/or actuators, are operatively coupled to at least one controller and/or processor. Sensor readings may be obtained by one or more processors and/or controllers. A controller may comprise a processing unit (e.g., CPU or GPU). A controller may receive an input (e.g., from at least one device or projected media). The controller may comprise circuitry, electrical wiring, optical wiring, socket, and/or outlet. A controller may receive an input and/or deliver an output. A controller may comprise multiple (e.g., sub-) controllers. An operation (e.g., as disclosed herein) may be performed by a single controller or by a plurality of controllers. At least two operations may be each preconformed by a different controller. At least two operations may be preconformed by the same controller. A device and/or media may be controlled by a single controller or by a plurality of controllers. At least two devices and/or media may be controlled by a different controller. At least two devices and/or media may be controlled by the same controller. The controller may be a part of a control system. The control system may comprise a master controller, floor (e.g., comprising network controller) controller, or a local controller. The local controller may be a target controller. For example, the local controller may be a window controller (e.g., controlling an optically switchable window), enclosure controller, or component controller. The controller may be a part of a hierarchal control system. They hierarchal control system may comprise a main controller that directs one or more controllers, e.g., floor controllers, local controllers (e.g., window controllers), enclosure controllers, and/or component controllers. The target may comprise a device or a media. The device may comprise an electrochromic window, a sensor, an emitter, an antenna, a receiver, a transceiver, or an actuator.

In some embodiments, the network infrastructure is operatively coupled to one or more controllers. In some embodiments, a physical location of the controller type in the hierarchal control system changes. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater). In one embodiment, a floor controller may direct one or more window controllers, one or more enclosure controllers, one or more component controllers, or any combination thereof. The floor controller may comprise a floor controller. For example, the floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. For example, a floor controller may be assigned to a portion of the local controllers disposed in the facility. For example, a floor controller may be assigned to a portion of the floors of a facility. A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system. A controller may receive one or more inputs. A controller may generate one or more outputs. The controller may be a single input single output controller (SISO) or a multiple input multiple output controller (MIMO). A controller may interpret an input signal received. A controller may acquire data from the one or more components (e.g., sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (PI) control, or proportional-integral-derivative (PID) control. Control may comprise open loop control, or closed loop control. A controller may comprise closed loop control. A controller may comprise open loop control. A controller may comprise a user interface. A user interface may comprise (or operatively coupled to) a keyboard, keypad, mouse, touch screen, microphone, speech recognition package, camera, imaging system, or any combination thereof. Outputs may include a display (e.g., screen), speaker, or printer. In some embodiments, a local controller controls one or more devices and/or media (e.g., media projection). For example, a local controller can control one or more IGUs, one or more sensors, one or more output devices (e.g., one or more emitters), one or more media, or any combination thereof.

In some embodiments, a BMS includes a multipurpose controller. By incorporating feedback (e.g., of the controller), a BMS can provide, for example, enhanced: 1) environmental control, 2) energy savings, 3) security, 4) flexibility in control options, 5) improved reliability and usable life of other systems (e.g., due to decreased reliance thereon and/or reduced maintenance thereof), 6) information availability and/or diagnostics, 7) higher productivity from personnel in the building (e.g., staff), and various combinations thereof. These enhancements may derive automatically controlling any of the devices. In some embodiments, a BMS may not be present. In some embodiments, a BMS may be present without communicating with a master network controller. In some embodiments, a BMS may communicate with a portion of the levels in the hierarchy of controllers. For example, the BMS may communicate (e.g., at a high level) with a master network controller. In some embodiments, a BMS may not communicate with a portion of the levels in the hierarchy of controllers of the control system. For example, the BMS may not communicate with the local controller and/or intermediate controller. In certain embodiments, maintenance on the BMS would not interrupt control of the devices communicatively coupled to the control system. In some embodiments, the BMS comprises at least one controller that may or may not be part of the hierarchical control system.

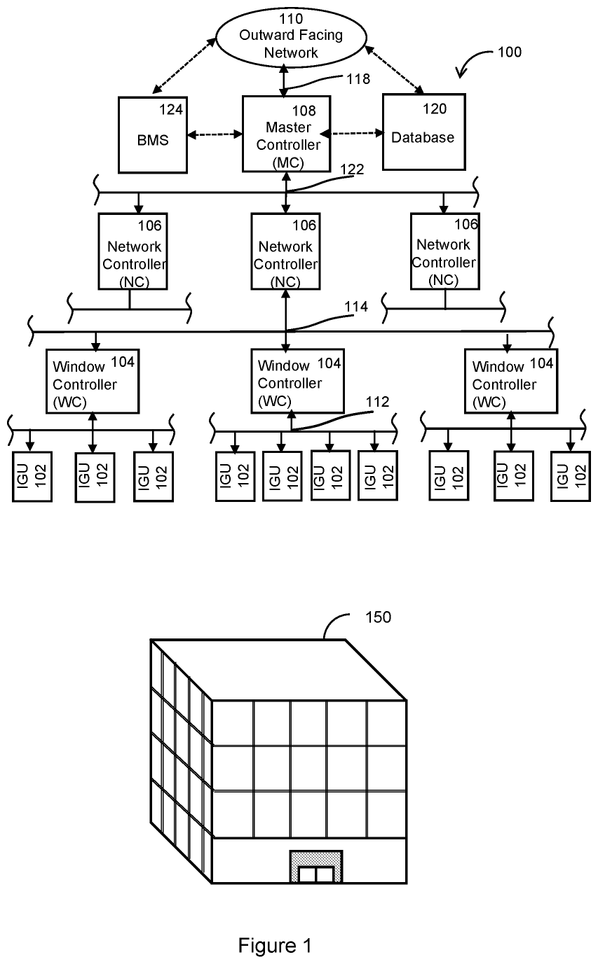

FIG. 1 shows an example of a control system architecture 100 disposed at least partly in an enclosure (e.g., building) 150. Control system architecture 100 comprises a master controller 108 that controls floor controllers 106, that in turn control local controllers 104. In the example shown in FIG. 1, a master controller 108 is operatively coupled (e.g., wirelessly and/or wired) to a building management system (BMS) 124 and to a database 120. Arrows in FIG. 1 represents communication pathways. A controller may be operatively coupled (e.g., directly/indirectly and/or wired and/wirelessly) to an external source 110. Master controller 108 may control floor controllers that include network controllers 106, that may in turn control local controllers such as window controllers 104. Floor controllers 106 may also be include network controllers (NC). In some embodiments, the local controllers (e.g., 106) control one or more targets such as IGUs 102, one or more sensors, one or more output devices (e.g., one or more emitters), media, or any combination thereof. The external source may comprise a network. The external source may comprise one or more sensor or output device. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be monodirectional or bidirectional. In the example shown in FIG. 1, the communication all communication arrows are meant to be bidirectional (e.g., 118, 122, 114, and 112).

The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. A plurality of devices (e.g., sensors and/or emitters) may be disposed in a container and may constitute an ensemble (e.g., a digital architectural element). The ensemble may comprise at least two devices of the same type. The ensemble may comprise at least two devices of a different type. The devices in the ensemble may be operatively coupled to the same electrical board. The electrical board may comprise circuitry. The electrical board may comprise, or be operatively coupled to a controller (e.g., a local controller). The control system may control the one or more devices (e.g., sensors). The control system may control one or more components of a building management system (e.g., lightening, security, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein. Examples of a digital architectural element can be found in International Patent Application Serial No. PCT/US20/70123 that is incorporated herein by reference in its entirety.

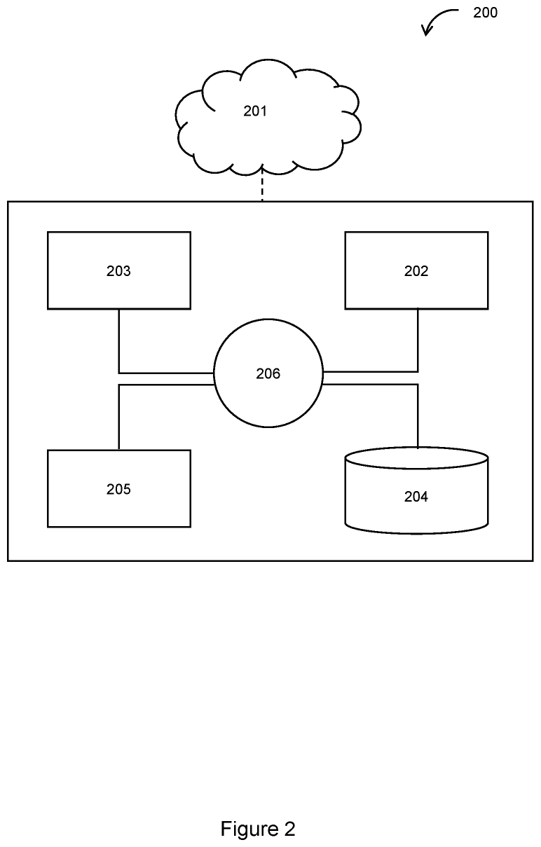

FIG. 2 shows a schematic example of a computer system 200 that is programmed or otherwise configured to one or more operations of any of the methods provided herein. The computer system can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 206) (also “processor,” “computer” and “computer processor” used herein). The computer system may include memory or memory location (e.g., 202) (e.g., random-access memory, read-only memory, flash memory), electronic storage unit (e.g., 204) (e.g., hard disk), communication interface (e.g., 203) (e.g., network adapter) for communicating with one or more other systems, and peripheral devices (e.g., 205), such as cache, other memory, data storage and/or electronic display adapters. In the example shown in FIG. 2, the memory 202, storage unit 204, interface 203, and peripheral devices 205 are in communication with the processing unit 206 through a communication bus (solid lines), such as a motherboard. The storage unit can be a data storage unit (or data repository) for storing data. The computer system can be operatively coupled to a computer network (“network”) (e.g., 201) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 202. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 200 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 202 or electronic storage unit 204. The machine executable or machine-readable code can be provided in the form of software. During use, the processor 206 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion. In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein. The controller may be operatively (communicatively) coupled to control logic (e.g., code embedded in a software) in which its operation(s) are embodied.

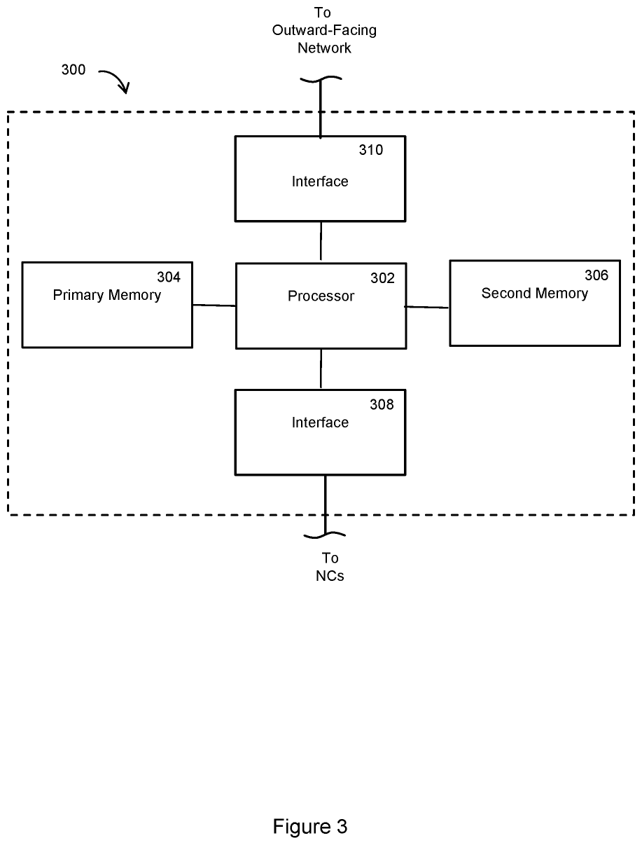

In some embodiments, optically switchable windows forms or occupies substantial portions of a building envelope. For example, the optically switchable windows can form substantial portions of the walls, facades and even roofs of a corporate office building, other commercial building or a residential building. A distributed network of controllers can be used to control the optically switchable windows. For example, a network system may be operable to control a plurality of IGUs. One primary function of the network system is controlling the optical states of electrochromic devices (ECDs) (or other optically switchable devices) within the IGUs. In some implementations, one or more windows can be multi-zoned windows, for example, where each window includes two or more independently controllable ECDs or zones. In some embodiments, the network system 300 (of FIG. 3) is operable to control the electrical characteristics of the power signals provided to the IGUs. For example, the network system can generate and communicate tinting instructions (also referred to herein as “tint commands”) which control voltages applied to the ECDs within the IGUs.

In some embodiments, another function of the network system is to acquire status information from the IGUs (hereinafter “information” is used interchangeably with “data”). For example, the status information for a given IGU can include an identification of, or information about, a current tint state of the ECD(s) within the IGU. The network system also can be operable to acquire data from various sensors, such as temperature sensors, photosensors (also referred to herein as light sensors), humidity sensors, air flow sensors, or occupancy sensors, whether integrated on or within the IGUs or located at various other positions in, on or around the building.

The network system can include any suitable number of distributed controllers having various capabilities or functions. In some implementations, the functions and arrangements of the various controllers are defined hierarchically. For example, the network system can include a plurality of distributed window controllers (WCs), a plurality of network controllers (NCs), and a master controller (MC). The network controllers may be included in the floor controllers. In some implementations, the MC can communicate with and control tens or hundreds of NCs. In various implementations, the MC issues high level instructions to the NCs over one or more wired and/or wireless links. The instructions can include, for example, tint commands for causing transitions in the optical states of the IGUs controlled by the respective NCs. Each NC can, in turn, communicate with and control a number of WCs over one or more wired and/or wireless links. For example, each NC can control tens or hundreds of the WCs. Each WC can, in turn, communicate with, drive or otherwise control one or more respective IGUs over one or more wired and/or wireless links.

In some embodiments, the MC issues communications including tint commands, status request commands, data (for example, sensor data) request commands or other instructions. The MC 308 may issue such communications periodically, at certain predefined times of day (which may change based at least in part on the day of week or year), or based at least in part on the detection of particular events, conditions or combinations of events or conditions (for example, as determined by acquired sensor data or based at least in part on the receipt of a request initiated by a user or by an application or a combination of such sensor data and such a request). In some embodiments, when the MC determines to cause a tint state change in a set of one or more IGUs, the MC generates or selects a tint value corresponding to the desired tint state. In some embodiments, the set of IGUs is associated with a first protocol identifier (ID) (for example, a BACnet ID). The MC then generates and transmits a communication-referred to herein as a “primary tint command”-including the tint value and the first protocol ID over the link via a first communication protocol (for example, a BACnet compatible protocol). The MC may address the primary tint command to the particular NC that controls the particular one or more WCs that, in turn, control the set of IGUs to be transitioned.

In some embodiments, the NC receives the primary tint command including the tint value and the first protocol ID and maps the first protocol ID to one or more second protocol IDs. Each of the second protocol IDs may identify a corresponding one of the WCs. The NC may subsequently transmit a secondary tint command including the tint value to each of the identified WCs over the link via a second communication protocol. For example, each of the WCs that receives the secondary tint command can then select a voltage or current profile from an internal memory based at least in part on the tint value to drive its respectively connected IGUs to a tint state consistent with the tint value. Each of the WCs may then generate and provide voltage or current signals over the link to its respectively connected IGUs to apply the voltage or current profile, for example.

In some embodiments, the various targets (e.g., IGUs) are (e.g., advantageously) grouped into zones of targets (e.g., of EC windows). At least one zone (e.g., each of which zones) can include a subset of the targets (e.g., IGUs). For example, at least one (e.g., each) zone of targets (e.g., IGUs) may be controlled by one or more respective floor controllers (e.g., NCs) and one or more respective local controllers (e.g., WCs) controlled by these floor controllers (e.g., NCs). In some examples, at least one (e.g., each) zone can be controlled by a single floor controller (e.g., NC) and two or more local controllers (e.g., WCs) controlled by the single floor controller (e.g., NC). For example, a zone can represent a logical grouping of the targets (e.g., IGUs). Each zone may correspond to a set of targets (e.g., IGUs) in a specific location or area of the building that are driven together based at least in part on their location. For example, a building may have four faces or sides (a North face, a South face, an East Face and a West Face) and ten floors. In such a didactic example, each zone may correspond to the set of electrochromic windows on a particular floor and on a particular one of the four faces. At least one (e.g., each) zone may correspond to a set of targets (e.g., IGUs) that share one or more physical characteristics (for example, device parameters such as size or age). In some embodiments, a zone of targets (e.g., IGUs) is grouped based at least in part on one or more non-physical characteristics such as, for example, a security designation or a business hierarchy (for example, IGUs bounding managers' offices can be grouped in one or more zones while IGUs bounding non-managers' offices can be grouped in one or more different zones).

In some embodiments, at least one (e.g., each) floor controller (e.g., NC) is able to address all of the targets (e.g., IGUs) in at least one (e.g., each) of one or more respective zones. For example, the MC can issue a primary tint command to the floor controller (e.g., NC) that controls a target zone. The primary tint command can include an (e.g., abstract) identification of the target zone (hereinafter also referred to as a “zone ID”). For example, the zone ID can be a first protocol ID such as that just described in the example above. In such cases, the floor controller (e.g., NC) receives the primary tint command including the tint value and the zone ID and maps the zone ID to the second protocol IDs associated with the local controllers (e.g., WCs) within the zone. In some embodiments, the zone ID is a higher level abstraction than the first protocol IDs. In such cases, the floor controller (e.g., NC) can first map the zone ID to one or more first protocol IDs, and subsequently map the first protocol IDs to the second protocol IDs.

In some embodiments, the MC is coupled to one or more outward-facing networks via one or more wired and/or wireless links. For example, the MC can communicate acquired status information or sensor data to remote computers, mobile devices, servers, databases in or accessible by the outward-facing network. In some embodiments, various applications, including third party applications or cloud-based applications, executing within such remote devices are able to access data from or provide data to the MC. In some embodiments, authorized users or applications communicate requests to modify the tint states of various IGUs to the MC via the network. For example, the MC can first determine whether to grant the request (for example, based at least in part on power considerations or based at least in part on whether the user has the appropriate authorization) prior to issuing a tint command. The MC may then calculate, determine, select or otherwise generate a tint value and transmit the tint value in a primary tint command to cause the tint state transitions in the associated IGUs.

In some embodiments, a user submits such a request from a computing device, such as a desktop computer, laptop computer, tablet computer or mobile device (for example, a smartphone). The user's computing device may execute a client-side application that is capable of communicating with the MC, and in some examples, with a master controller application executing within the MC. In some embodiments, the client-side application may communicate with a separate application, in the same or a different physical device or system as the MC, which then communicates with the master controller application to affect the desired tint state modifications. For example, the master controller application or other separate application can be used to authenticate the user to authorize requests submitted by the user. The user may select a target to be manipulated (e.g., the IGUs to be tinted), and directly or indirectly inform the MC of the selections, e.g., by entering an enclosure ID (e.g., room number) via the client-side application.

In some embodiments, a mobile circuitry of a user (e.g., mobile electronic device or other computing device) can communicate, e.g., wirelessly with various local controllers (e.g., WCs). For example, a client-side application executing within a mobile circuitry of a user (e.g., mobile device) can transmit wireless communications including control signals related to a target to the local controller to control the target, which target is communicatively coupled to the local controller (e.g., via the network). For example, a user may initiate directing a tint state control signals to a WC to control the tint states of the respective IGUs connected to the WC. For example, the user can use the client-side application to control (e.g., maintain or modify) the tint states of the IGUs adjoining a room occupied by the user (or to be occupied by the user or others at a future time). For example, a user may initiate directing a sensor frequency change control signals to a local controller to control the data sampling rate of a sensor communicatively coupled to the local controller. For example, the user can use the client-side application to control (e.g., maintain or modify) the data sampling rate of the sensor adjoining a room occupied by the user (or to be occupied by the user or others at a future time). For example, a user may initiate directing a light intensity change control signals to a local controller to control the light of a lamp communicatively coupled to the local controller. For example, the user can use the client-side application to control (e.g., maintain or modify) the light intensity of the light adjoining a room occupied by the user (or to be occupied by the user or others at a future time). For example, a user may initiate directing a media projection change control signals to a local controller to control the media projected by a projector communicatively coupled to the local controller. For example, the user can use the client-side application to control (e.g., maintain or modify) the media projected by a projector in a room occupied by the user (or to be occupied by the user or others at a future time). The wireless communications can be generated, formatted and/or transmitted using various wireless network topologies and protocols, for example.

In some embodiments, the control signals sent to the local controller (e.g., WC) from a mobile circuitry (e.g., device) of a user (or other computing device) override a previously sent signal (e.g., a tint value previously received by the WC from the respective NC). The previously sent signal may be automatically generated, e.g., by the control system. In other words, the local controller (e.g., WC) may provide the applied voltages to the target (e.g., IGUs) based at least in part on the control signals from the mobile circuitry of the user (e.g., user's computing device), e.g., rather than based at least in part on the predetermined signal (e.g., the tint value). For example, a control algorithm or rule set stored in and executed by the local controller (e.g., WC) may dictate that one or more control signals from a mobile device of a user (e.g., an authorized user's computing device) that will take precedence over a respective signal received from the control system (e.g., a tint value received from the NC). In some embodiments, such as in high demand cases, control signals (such as a tint value from the NC) take precedence over any control signals received by the local controller (e.g., WC) from a mobile circuitry of a user (e.g., a user's computing device). A control algorithm or rule set may dictate that control signal (e.g., relating to tint) overrides from only certain users (or groups or classes of users) may take precedence based at least in part on permissions granted to such users. In some instances, other factors including time of day or the location of the target (e.g., IGUs) may influence the permission to override a predetermined signal of the control system.

In some embodiments, based at least in part on the receipt of a control signal from a mobile circuitry of a user (e.g., an authorized user's computing device), the MC uses information about a combination of known parameters to calculate, determine, select and/or otherwise generate a command signal (e.g., relating to a tint value) that provides (e.g., lighting) conditions requested by a (e.g., typical) user, e.g., while in some instances also using power efficiently. For example, the MC may determine a state of a target based at least in part on preset preferences defined by or for the particular user that requested the target status change via the mobile circuitry (e.g., via the computing device). For example, the MC may determine the tint value based at least in part on preset preferences defined by or for the particular user that requested the tint state change via the computing device. For example, the user may be required to enter a password or otherwise login or obtain authorization to request a change in a state of a target (e.g., tint state change). The MC may determine the identity of the user based at least in part on a password, a security token and/or an identifier of the particular mobile circuitry (e.g., mobile device or other computing device). After determining the identity of the user, the MC may then retrieve preset preferences for the user, and use the preset preferences alone or in combination with other parameters (such as power considerations and/or information from various sensors) to generate and transmit a status change of the target (e.g., tint value for use in tinting the respective IGUs).

In some embodiments, the network system includes wall switches, dimmers, or other (e.g., tint-state) controlling devices. A wall switch generally refers to an electromechanical interface connected to a local controller (e.g., WC). The wall switch can convey a target status change (e.g., tint) command to the local controller (e.g., WC), which can then convey the target status change (e.g., tint) command to an upper level controller such as a local controller (e.g., NC). Such control devices can be collectively referred to as “wall devices,” although such devices need not be limited to wall-mounted implementations (for example, such devices also can be located on a ceiling or floor or integrated on or within a desk or a conference table). For example, some or all of the offices, conference rooms, or other rooms of the building can include such a wall device for use in controlling the state of a target (e.g., tint states of the adjoining IGUs, or light state of a light bulb). For example, the IGUs adjoining a particular room can be grouped into a zone. Each of the wall devices can be operated by an end user (for example, an occupant of the respective room) to control the state of grouped targets (e.g., to control tint state or other functions or parameters of the IGUs that adjoin the room). For example, at certain times of the day, the adjoining IGUs may be tinted to a dark state to reduce the amount of light energy entering the room from the outside (for example, to reduce AC cooling requirements). For example, at certain times of the day, the adjoining heaters may be turned on to a warmer temperature to facilitate occupant comfort. In some embodiments, when a user requests to use a room then the user can operate the wall device to communicate one or more control signals to cause a (e.g., tint state) transition from one state of a target to another state (e.g., from the dark state to a lighter tint state of an IGU).

In some embodiments, each wall device includes one or more switches, buttons, dimmers, dials, or other physical user interface controls enabling the user to select a particular tint state or to increase or decrease a current tinting level of the IGUs adjoining the room. The wall device may include a display having a touchscreen interface enabling the user to select a particular tint state (for example, by selecting a virtual button, selecting from a dropdown menu or by entering a tint level or tinting percentage) or to modify the tint state (for example, by selecting a “darken” virtual button, a “lighten” virtual button, or by turning a virtual dial or sliding a virtual bar). In some embodiments, the wall device includes a docking interface enabling a user to physically and communicatively dock a mobile circuitry (e.g., portable device such as a smartphone, multimedia device, remote controller, virtual reality device, tablet computer, or other portable computing device (for example, an IPHONE, IPOD or IPAD produced by Apple, Inc. of Cupertino, CA)). The mobile circuitry may be embedded in a vehicle (e.g., car, motorcycle, drone, airplane). The mobile circuitry may be embedded in a robot. A circuitry may be embedded in (e.g., be part of) a virtual assistant AI technology, speaker, (e.g., smart speaker such as Google Nest, or Amazon Echo Dot). Coupling of the mobile circuitry to the network may be initiated by a user's presence in the enclosure, or by a user's coupling (e.g., weather remote or local) to the network. Coupling of the user to the network may be security (e.g., having one or more security layers, and/or require one or more security tokens (e.g., keys)). The presence of the user in the enclosure may be sensed (e.g., automatically) by using the sensor(s) that are coupled to the network. The minimum distance from the sensor at which the user is coupled to the network may be predetermined and/or adjusted. A user may override its coupling to the network. The user may be a manager, executive, owner, lessor, administrator of the network and/or facility. The user may be the user of the mobile circuitry. The ability to couple the mobile circuitry to the network may or may not be overridden by the user. The ability to alter the minimum coupling distance between the mobile circuitry and the network may or may not be overridden by the user. There may be a hierarchy of overriding permissions. The hierarchy may depend on the type of user and/or type of mobile circuitry. For example, a factory employee user may not be allowed to alter coupling of a production machinery to the network. For example, an employee may be allowed to alter the coupling distance of his/her company laptop computer to the network. For example, an employee may be permitted to allow or prevent coupling of her/his personal cellular phone and/or car to the network. For example, a visitor may be prevented from having the visitor's mobile circuitry connected to the network. The coupling to the network may be automatic and seamless (e.g., after the initial preference have been set). Seamless coupling may be without requiring input from the user.

In such an example, the user can control the tinting levels via input to the mobile circuitry (e.g., portable device), which is then received by the wall device through the docking interface and subsequently communicated to the control system (e.g., to the MC, NC, or WC). The mobile circuitry (e.g., portable device) may include an application for communicating with an API presented by the wall device.

In some embodiments, the wall device can transmit a request for a status change of a target (e.g., a tint state change) to the control system (e.g., to the MC). The control system (e.g., MC) might first determine whether to grant the request (for example, based at least in part on power considerations and/or based at least in part on whether the user has the appropriate authorizations or permissions). The control system (e.g., MC) could calculate, determine, select, and/or otherwise generate a status change (e.g., tint) value and transmit the status change (e.g., tint) value in a primary status change (e.g., tint) command to cause the target to change (e.g., cause the tint state transitions in the adjoining IGUs). For example, each wall device may be connected with the control system (e.g., the MC therein) via one or more wired links (for example, over communication lines such as CAN or Ethernet compliant lines and/or over power lines using power line communication techniques). For example, each wall device could be connected with the control system (e.g., the MC therein) via one or more wireless links. The wall device may be connected (via one or more wired and/or wireless connections) with an outward-facing network, which may communicate with the control system (e.g., the MC therein) via the link.

In some embodiments, the control system identifies the target (e.g., target device) associated with the wall device based at least in part on previously programmed or discovered information associating the wall device with the target. For example, the MC identifies the IGUs associated with the wall device based at least in part on previously programmed or discovered information associating the wall device with the IGUs. A control algorithm or rule set can be stored in and executed by the control system (e.g., the MC therein) to dictate that one or more control signals from a wall device take precedence over a tint value previously generated by the control system (e.g., the MC therein), for example. In times of high demand (for example, high power demand), a control algorithm or rule set stored in and executed by the control system (e.g., the MC therein) may be used to dictate that the tint value previously generated by the control system (e.g., the MC therein) takes precedence over any control signals received from a wall device.

In some embodiments, based at least in part on the receipt of a request or control signal to change to a state of a target (e.g., tint-state-change request or control signal) from a wall device, the control system (e.g., the MC therein) uses information about a combination of known parameters to generate a state change (e.g., tint) value that provides lighting conditions desirable for a typical user. Accordingly, the control system (e.g., the MC therein) may use power more efficiently. In some embodiments, the control system (e.g., the MC therein) can generate the state change (e.g., tint) value based at least in part on preset preferences defined by or for the particular user that requested the (e.g., tint) state change of the target via the wall device. For example, the user may be required to enter a password into the wall device or to use a security token or security fob such as the IBUTTON or other 1-Wire device to gain access to the wall device. The control system (e.g., the MC therein) may then determine the identity of the user, based at least in part on the password, security token and/or security fob. The control system (e.g., the MC therein) may retrieve preset preferences for the user. The control system (e.g., the MC therein) may use the preset preferences alone or in combination with other parameters (such as power considerations or information from various sensors, historical data, and/or user preference) to calculate, determine, select and/or otherwise generate a tint value for the respective IGUs.

In some embodiments, the wall device transmits a tint state change request to the appropriate control system (e.g., to the NC therein). A lower level of the control system (e.g., to the NC therein) may communicate the request, or a communication based at least in part on the request, to a higher level of the control system (e.g., to the MC). For example, each wall device can be connected with a corresponding NC via one or more wired links. In some embodiments, the wall device transmits a request to the appropriate NC, which then itself determines whether to override a primary tint command previously received from the MC or a primary or secondary tint command previously generated by the NC. As described below, the NC may generate tint commands without first receiving a tint command from an MC. In some embodiments, the wall device communicates requests or control signals directly to the WC that controls the adjoining IGUs. For example, each wall device can be connected with a corresponding WC via one or more wired links such as those just described for the MC or via a wireless link.

In some embodiments, the NC or the MC determines whether the control signals from the wall device should take priority over a tint value previously generated by the NC or the MC. As described above, the wall device is able to communicate directly with the NC. However, in some examples, the wall device can communicate requests directly to the MC or directly to a WC, which then communicates the request to the NC. In some embodiments, the wall device is able to communicate requests to a customer-facing network (such as a network managed by the owners or operators of the building), which then passes the requests (or requests based therefrom) to the NC either directly or indirectly by way of the MC. For example, a control algorithm or rule set stored in and executed by the NC or the MC can dictate that one or more control signals from a wall device take precedence over a tint value previously generated by the NC or the MC. In some embodiments (e.g., such as in times of high demand), a control algorithm or rule set stored in and executed by the NC or the MC dictates that the tint value previously generated by the NC or the MC takes precedence over any control signals received from a wall device.

In some embodiments, based at least in part on the receipt of a tint-state-change request or control signal from a wall device, the NC can use information about a combination of known parameters to generate a tint value that provides lighting conditions desirable for a typical user. In some embodiments, the NC or the MC generates the tint value based at least in part on preset preferences defined by or for the particular user that requested the tint state change via the wall device. For example, the user may be required to enter a password into the wall device or to use a security token or security fob such as the IBUTTON or other 1-Wire device to gain access to the wall device. In this example, the NC can communicate with the MC to determine the identity of the user, or the MC can alone determine the identity of the user, based at least in part on the password, security token or security fob. The MC may then retrieve preset preferences for the user, and use the preset preferences alone or in combination with other parameters (such as power considerations or information from various sensors) to calculate, determine, select, or otherwise generate a tint value for the respective IGUs.

In some embodiments, the control system (e.g., the MC therein) is coupled to an external database (or “data store” or “data warehouse”). The database can be a local database coupled with the control system (e.g., the MC therein) via a wired hardware link, for example. In some embodiments, the database is a remote database or a cloud-based database accessible by the control system (e.g., the MC therein) via an internal private network or over the outward-facing network. Other computing devices, systems, or servers also can have access to read the data stored in the database, for example, over the outward-facing network. One or more control applications or third party applications could also have access to read the data stored in the database via the outward-facing network. In some embodiments, the control system (e.g., the MC therein) stores in the database a record of all tint commands including the corresponding tint values issued by the control system (e.g., the MC therein). The control system (e.g., the MC therein) may also collect status and sensor data and store it in the database (which may constitute historical data). The local controllers (e.g., WCs) may collect the sensor data and/or status data from the enclosure and/or from other devices (e.g., IGUs) or media disposed in the enclosure, and communicate the sensor data and/or status data to the respective higher level controller (e.g., NCs) over the communication link. The data may move up the control chain, e.g., to the MC. For example, the controllers (e.g., NCs or the MC) may themselves be communicatively coupled (e.g., connected) to various sensors (such as light, temperature, or occupancy sensors) within the building, as well as (e.g., light and/or temperature) sensors positioned on, around, or otherwise external to the building (for example, on a roof of the building). In some embodiments, the control system (e.g., the NCs or the WCs) may also transmit status and/or sensor data (e.g., directly) to the database for storage.

In some embodiments, the network system is suited for integration with a smart thermostat service, alert service (for example, fire detection), security service and/or other appliance automation service. On example of a home automation service is NEST®, made by Nest Labs of Palo Alto, California, (NEST® is a registered trademark of Google, Inc. of Mountain View, California). As used herein, references to a BMS can in some implementations also encompass, or be replaced with, such other automation services.

In some embodiments, the e control system (e.g., the MC therein) and a separate automation service, such as a BMS, can communicate via an application programming interface (API). For example, the API can execute in conjunction with a (e.g., master) controller application (or platform) within the controller (e.g., MC), and/or in conjunction with a building management application (or platform) within the BMS. The controller (e.g., MC) and the BMS can communicate over one or more wired links and/or via the outward-facing network. For example, the BMS may communicate instructions for controlling the IGUs to the controller (e.g., MC), which then generate and transmit primary status (e.g., tint) commands of the target to the appropriate lower level controller(s) (e.g., to the NCs). The lower hierarchical level controllers (e.g., the NCs or the WCs) could communicate directly with the BMS (e.g., through a wired/hardware link and/or wirelessly through a wireless data link). In some embodiments, the BMS also receives data, such as sensor data, status data, and associated timestamp data, collected by one or more of the controllers in the control system (e.g., by the MC, the NCs, and/or the WCs). For example, the controller (e.g., MC) can publish such data over the network. In some embodiments in which such data is stored in a database, the BMS can have access to some or all of the data stored in the database.

In some embodiments, the controller (e.g., “the MC”) collectively refers to any suitable combination of hardware, firmware and software for implementing the functions, operations, processes, or capabilities described. For example, the MC can refer to a computer that implements a master controller application (also referred to herein as a “program” or a “task”). For example, the controller (e.g., MC) may include one or more processors. The processor(s) can be or can include a central processing unit (CPU), such as a single core or a multi-core processor. The processor can additionally include a digital signal processor (DSP) or a network processor in some examples. The processor could also include one or more application-specific integrated circuits (ASICs). The processor is coupled with a primary memory, a secondary memory, an inward-facing network interface, and an outward-facing network interface. The primary memory can include one or more high-speed memory devices such as, for example, one or more random-access memory (RAM) devices including dynamic-RAM (DRAM) devices. Such DRAM devices can include, for example, synchronous DRAM (SDRAM) devices and double data rate SDRAM (DDR SDRAM) devices (including DDR2 SDRAM, DDR3 SDRAM, and DDR4 SDRAM), thyristor RAM (T-RAM), and zero-capacitor (Z-RAM®), among other suitable memory devices.

In some embodiments, the secondary memory can include one or more hard disk drives (HDDs) or one or more solid-state drives (SSDs). In some embodiments, the memory can store processor-executable code (or “programming instructions”) for implementing a multi-tasking operating system such as, for example, an operating system based at least in part on a Linux® kernel. The operating system can be a UNIX®- or Unix-like-based operating system, a Microsoft Windows®-based operating system, or another suitable operating system. The memory may also store code executable by the processor to implement the master controller application described above, as well as code for implementing other applications or programs. The memory may also store status information, sensor data, or other data collected from network controllers, window controllers and various sensors.

In some embodiments, the controller (e.g., MC) is a “headless” system; that is, a computer that does not include a display monitor or other user input device. For example, an administrator or other authorized user can log in to or otherwise access the controller (e.g., MC) from a remote computer or mobile computing device over a network to access and retrieve information stored in the controller (e.g., MC), to write or otherwise store data in the controller (e.g., MC), and/or to control various: functions, operations, processes and/or parameters implemented or used by the controller (e.g., MC). The controller (e.g., MC) can include a display monitor and a direct user input device (for example, a mouse, a keyboard and/or a touchscreen).

In some embodiments, the inward-facing network interface enables one controller (e.g., MC) of the control system to communicate with various distributed controllers and/or various targets (e.g., sensors). The inward-facing network interface can collectively refer to one or more wired network interfaces and/or one or more wireless network interfaces (including one or more radio transceivers). For example, the inward-facing network interface can enable communication with downstream controllers (e.g., NCs) over the link. Downstream may refer to a lower level of control in the control hierarchy.

In some embodiments, the outward-facing network interface enables the controller (e.g., MC) to communicate with various computers, mobile circuitry (e.g., mobile devices), servers, databases, and/or cloud-based database systems, over one or more networks. The outward-facing network interface can collectively refer to one or more wired network interfaces and/or one or more wireless network interfaces (including one or more radio transceivers). In some embodiments, the various applications, including third party applications and/or cloud-based applications, executing within such remote devices can access data from or provide data to the controller (e.g., MC) or to the database via the controller (e.g., MC). For example, the controller (e.g., MC) may include one or more application programming interfaces (APIs) for facilitating communication between the controller (e.g., MC) and various third party applications. Some examples of APIs that controller(s) (e.g., MC) can enable can be found in International Patent Application Serial No. PCT/US15/64555 (Attorney Docket No. VIEWP073WO) filed Dec. 8, 2015, titled “MULTIPLE INTERACTING SYSTEMS AT A SITE,” which is incorporated herein by reference in its entirety. For example, third-party applications can include various monitoring services including thermostat services, alert services (e.g., fire detection), security services, and/or other appliance automation services. Additional examples of monitoring services and systems can be found in International Patent Application Serial No. PCT/US15/19031 (Attorney Docket No. VIEWP061WO) filed Mar. 5, 2015, titled “MONITORING SITES CONTAINING SWITCHABLE OPTICAL DEVICES AND CONTROLLERS,” which is incorporated herein by reference in its entirety.

In some embodiments, one or both of the inward-facing network interface and the outward-facing network interface can include a Building Automation and Control network (BACnet) compatible interface. BACnet is a communications protocol typically used in building automation and control networks and defined by the ASHRAE/ANSI 135 and ISO 16484-5 standards. The BACnet protocol broadly provides mechanisms for computerized building automation systems and devices to exchange information, e.g., regardless of the particular services they perform. For example, BACnet can be used to enable communication among (i) heating, ventilating, and air-conditioning control (HVAC) systems, (ii) lighting control systems, (iii) access and/or security control systems, (iv) fire detection systems, or (v) any combination thereof, as well as their associated equipment. In some examples, one or both of the inward-facing network interface and the outward-facing network interface can include an oBIX (Open Building Information Exchange) compatible interface or another RESTful Web Services-based interface.

In some embodiments, the controller (e.g., MC) can calculate, determine, select and/or otherwise generate a preferred state for the target (e.g., a tint value for one or more IGUs) based at least in part on a combination of parameters. For example, the combination of parameters can include time and/or calendar information such as the time of day, day of year or time of season. The combination of parameters may include solar calendar information such as, for example, the direction of the sun relative to the facility and/or target (e.g., IGUs). The direction of the sun relative to the facility and/or target (e.g., IGUs) may be determined by the controller (e.g., MC) based at least in part on time and/or calendar information, e.g., together with information known about the geographical location of the facility (e.g., building) on Earth and the direction that the target (e.g., IGUs) faces (e.g., in a North-East-Down coordinate system). The combination of parameters also can include exterior and/or interior environmental conditions. For example, the outside temperature (external to the building), the inside temperature (within a room adjoining the target IGUs), or the temperature within the interior volume of the IGUs. The combination of parameters may include information about the weather (for example, whether it is clear, sunny, overcast, cloudy, raining or snowing). Parameters such as the time of day, day of year, and/or direction of the sun can be programmed into and tracked by the control system (e.g., the MC therein). Parameters (such as the outside temperature, inside temperature, and/or IGU temperature) can be obtained from sensors in, on or around the building or sensors integrated with the target (e.g., on or within the IGUs). At times the target can comprise a sensor. Examples of algorithms, routines, modules, or other means for generating IGU tint values are described in U.S. patent application Ser. No. 13/772,969, filed Feb. 21, 2013, titled “CONTROL METHOD FOR TINTABLE WINDOWS,” and in International Patent Application Serial No. PCT/US15/29675, filed May 7, 2015, titled “CONTROL METHOD FOR TINTABLE WINDOWS,” each of which is hereby incorporated by reference in its entirety.

In some embodiments, at least one (e.g., each) device (e.g., ECD) within each IGU is capable of being tinted, e.g., responsive to a suitable driving voltage applied across the EC stack. The tint may be to (e.g., virtually) any tint state within a continuous tint spectrum defined by the material properties of the EC stack. However, the control system (e.g., the MC therein) may be programmed to select a tint value from a finite number of discrete tint values (e.g., tint values specified as integer values). In some such implementations, the number of available discrete tint values can be at least 2, 4, 8, 16, 32, 64, 128 or 256, or more. For example, a 2-bit binary number can be used to specify any one of four possible integer tint values, a 3-bit binary number can be used to specify any one of eight possible integer tint values, a 4-bit binary number can be used to specify any one of sixteen possible integer tint values, a 5-bit binary number can be used to specify any one of thirty-two possible integer tint values, and so on. At least one (e.g., each) tint value can be associated with a target tint level (e.g., expressed as a percentage of maximum tint, maximum safe tint, and/or maximum desired or available tint). For didactic purposes, consider an example in which the MC selects from among four available tint values: 0, 5, 10 and 15 (using a 4-bit or higher binary number). The tint values 0, 5, 10 and 15 can be respectively associated with target tint levels of 60%, 40%, 20% and 4%, or 60%, 30%, 10% and 1%, or another desired, advantageous, or suitable set of target tint levels.

FIG. 3 shows a block diagram of an example master controller (MC) 300. The MC 300 can be implemented in or as one or more computers, computing devices or computer systems (herein used interchangeably where appropriate unless otherwise indicated). For example, the MC 300 includes one or more processors 302 (also collectively referred to hereinafter as “the processor 302”). Processor 302 can be or can include a central processing unit (CPU), such as a single core or a multi-core processor. The processor 302 can additionally include a digital signal processor (DSP) or a network processor in some examples. The processor 302 could also include one or more application-specific integrated circuits (ASICs). The processor 302 is coupled with a primary memory 304, a secondary memory 306, an inward-facing network interface 308 and an outward-facing network interface 310. The primary memory 304 can include one or more high-speed memory devices such as, for example, one or more random-access memory (RAM) devices including dynamic-RAM (DRAM) devices. Such DRAM devices can include, for example, synchronous DRAM (SDRAM) devices and double data rate SDRAM (DDR SDRAM) devices (including DDR2 SDRAM, DDR3 SDRAM, and DDR4 SDRAM), thyristor RAM (T-RAM), and zero-capacitor (Z-RAM®), among other suitable memory devices.

In some embodiments, in some implementations the MC and the NC are implemented as a master controller application and a network controller application, respectively, executing within respective physical computers or other hardware devices. For example, each of the master controller application and the network controller application can be implemented within the same physical hardware. Each of the master controller application and the network controller application can be implemented as a separate task executing within a single computer device that includes a multi-tasking operating system such as, for example, an operating system based at least in part on a Linux® kernel or another suitable operating system.

In some embodiments, the master controller application and the network controller application can communicate via an application programming interface (API). In some embodiments, the master controller and network controller applications communicate over a loopback interface. By way of reference, a loopback interface is a virtual network interface, implemented through an operating system, which enables communication between applications executing within the same device. A loopback interface is typically identified by an IP address (often in the 127.0.0.0/8 address block in IPV4, or the 0:0:0:0:0:0:0:1 address (also expressed as: 1) in IPV6). For example, the master controller application and the network controller application can each be programmed to send communications targeted to one another to the IP address of the loopback interface. In this way, when the master controller application sends a communication to the network controller application, or vice versa, the communication does not need to leave the computer.

In some embodiments wherein the MC and the NC are implemented as master controller and network controller applications, respectively, there are generally no restrictions limiting the available protocols suitable for use in communication between the two applications. This generally holds true regardless of whether the master controller application and the network controller application are executing as tasks within the same or different physical computers. For example, there is no need to use a broadcast communication protocol, such as BACnet, which limits communication to one network segment as defined by a switch or router boundary. For example, the oBIX communication protocol can be used in some implementations for communication between the MC and the NCs.

In some embodiments, each of the NCs is implemented as an instance of a network controller application executing as a task within a respective physical computer. In some embodiments, at least one of the computers executing an instance of the network controller application also executes an instance of a master controller application to implement the MC. For example, while only one instance of the master controller application may be actively executing in the network system at any given time, two or more of the computers that execute instances of network controller application can have an instance of the master controller application installed. In this way, redundancy is added such that the computer currently executing the master controller application is no longer a single point of failure of the entire system. For example, if the computer executing the master controller application fails or if that particular instance of the master controller application otherwise stops functioning, another one of the computers having an instance of the master network application installed can begin executing the master controller application to take over for the other failed instance. In some embodiments, more than one instance of the master controller application may execute concurrently. For example, the functions, processes, or operations of the master controller application can be distributed to two (or more) instances of the master controller application.

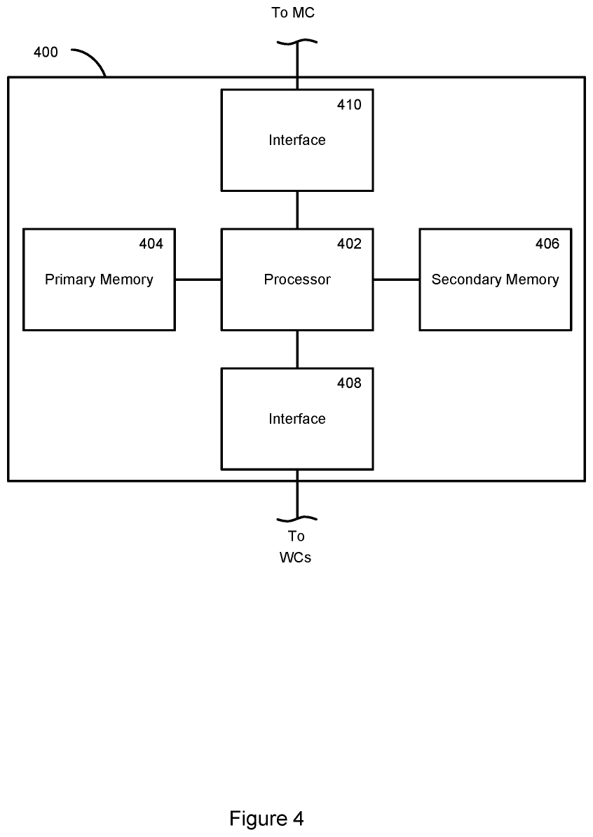

FIG. 4 shows a block diagram of an example network controller (NC) 400, which can be implemented in or as one or more network components, networking devices, computers, computing devices, or computer systems (herein used interchangeably where appropriate unless otherwise indicated). Reference to “the NC 400” collectively refers to any suitable combination of hardware, firmware, and software for implementing the functions, operations, processes or capabilities described. For example, the NC 400 can refer to a computer that implements a network controller application (also referred to herein as a “program” or a “task”). NC 400 includes one or more processors 402 (also collectively referred to hereinafter as “the processor 402”). In some embodiments, the processor 402 is implemented as a microcontroller or as one or more logic devices including one or more application-specific integrated circuits (ASICs) or programmable logic devices (PLDs), such as field-programmable gate arrays (FPGAs) or complex programmable logic devices (CPLDs). When implemented in a PLD, the processor can be programmed into the PLD as an intellectual property (IP) block or permanently formed in the PLD as an embedded processor core. The processor 402 may be or may include a central processing unit (CPU), such as a single core or a multi-core processor. The processor 402 is coupled with a primary memory 404, a secondary memory 406, a downstream network interface 408, and an upstream network interface 410. In some embodiments, the primary memory 404 can be integrated with the processor 402, for example, as a system-on-chip (SOC) package, or in an embedded memory within a PLD itself. The NC 400 may include one or more high-speed memory devices such as, for example, one or more RAM devices. In some embodiments, the secondary memory 406 can include one or more solid-state drives (SSDs) storing one or more lookup tables or arrays of values. The secondary memory 406 may store a lookup table that maps first protocol IDs (for example, BACnet IDs) received from the MC to second protocol IDs (for example, CAN IDs) each identifying a respective one of the WCs, and vice versa. In some embodiments, the secondary memory 406 stores one or more arrays or tables. The downstream network interface 408 enables the NC 400 to communicate with distributed WCs and/or various sensors. The upstream network interface 410 enables the NC 400 to communicate with the MC and/or various other computers, servers, or databases.

In some embodiments, when the MC determines to tint one or more IGUs, the MC writes a specific tint value to the AV in the NC associated with the one or more respective WCs that control the target IGUs. For example, the MC may generate a primary tint command communication including a BACnet ID associated with the WCs that control the target IGUs. The primary tint command also can include a tint value for the target IGUs. The MC may direct the transmission of the primary tint command to the NC using a network address such as, for example, an IP address or a MAC address. Responsive to receiving such a primary tint command from the MC through the upstream interface, the NC may unpackage the communication, map the BACnet ID (or other first protocol ID) in the primary tint command to one or more CAN IDs (or other second protocol IDs), and write the tint value from the primary tint command to a first one of the respective AVs associated with each of the CAN IDs.

In some embodiments, the NC then generates a secondary tint command for each of the WCs identified by the CAN IDs. Each secondary tint command may be addressed to a respective one of the WCs by way of the respective CAN ID. For example, each secondary tint command also can include the tint value extracted from the primary tint command. The NC may transmit the secondary tint commands to the target WCs through the downstream interface via a second communication protocol (for example, via the CANOpen protocol). In some embodiments, when a WC receives such a secondary tint command, the WC transmits a status value back to the NC indicating a status of the WC. For example, the tint status value can represent a “tinting status” or “transition status” indicating that the WC is in the process of tinting the target IGUs, an “active” or “completed” status indicating that the target IGUs are at the target tint state or that the transition has been finished, or an “error status” indicating an error. After the status value has been stored in the NC, the NC may publish the status information or otherwise make the status information accessible to the MC or to various other authorized computers or applications. In some embodiments, the MC requests status information for a particular WC from the NC based at least in part on intelligence, a scheduling policy, or a user override. For example, the intelligence can be within the MC or within a BMS. A scheduling policy can be stored in the MC, another storage location within the network system, or within a cloud-based system.

In some embodiments, the NC handles some of the functions, processes, or operations that are described above as being responsibilities of the MC. In some embodiments, the NC can include additional functionalities or capabilities not described with reference to the MC. For example, the NC may also include a data logging module (or “data logger”) for recording data associated with the IGUs controlled by the NC. In some embodiments, the data logger records the status information included in each of some or all of the responses to the status requests. For example, the status information that the WC communicates to the NC responsive to each status request can include a tint status value(S) for the IGUs, a value indicating a particular stage in a tinting transition (for example, a particular stage of a voltage control profile), a value indicating whether the WC is in a sleep mode, a tint value (C), a set point voltage set by the WC based at least in part on the tint value (for example, the value of the effective applied voltage V_{Eff}), an actual voltage level V_{Act} measured, detected or otherwise determined across the ECDs within the IGUs, an actual current level I_{Act} measured, detected or otherwise determined through the ECDs within the IGUs, and various sensor data, for example, collected from photosensors or temperature sensors integrated on or within the IGUs. The NC 500 may collect and queue status information in a messaging queue like RabbitMC, ActiveMQ or Kafka and stream the status information to the MC for subsequent processing such as data reduction/compression, event detection, etc., as further described herein.

In some embodiments, the data logger within the NC collects and stores the various information received from the WCs in the form of a log file such as a comma-separated values (CSV) file or via another table-structured file format. For example, each row of the CSV file can be associated with a respective status request, and can include the values of C, S, V_{Eff}, V_{Act} and I_{Act} as well as sensor data (or other data) received in response to the status request. In some implementations, each row is identified by a timestamp corresponding to the respective status request (for example, when the status request was sent by the NC, when the data was collected by the WC, when the response including the data was transmitted by the WC, or when the response was received by the NC). In some embodiments, each row also includes the CAN ID or other ID associated with the respective WC.

In some embodiments, each row of the CSV file includes the requested data for all of the WCs controlled by the NC. The NC may sequentially loop through all of the WCs it controls during each round of status requests. In some embodiments, each row of the CSV file is identified by a timestamp (for example, in a first column), but the timestamp can be associated with a start of each round of status requests, rather than each individual request. In one specific example, columns 2-6 can respectively include the values C, S, V_{Eff}, V_{Act} and I_{Act} for a first one of the WCs controlled by the NC, columns 7-11 can respectively include the values C, S, V_{Eff}, V_{Act} and I_{Act} for a second one of the WCs, columns 12-16 can respectively include the values C, S, V_{Eff}, V_{Act} and I_{Act} for a third one of the WCs, and so on and so forth through all of the WCs controlled by the NC. The subsequent row in the CSV file may include the respective values for the next round of status requests. In some embodiments, each row also includes sensor data obtained from photosensors, temperature sensors, or other sensors integrated with the respective IGUs controlled by each WC. For example, such sensor data values can be entered into respective columns between the values of C, S, V_{Eff}, V_{Act} and I_{Act} for a first one of the WCs but before the values of C, S, V_{Eff}, V_{Act} and I_{Act} for the next one of the WCs in the row. Each row can include sensor data values from one or more external sensors, for example, positioned on one or more facades or on a rooftop of the building. The NC may send a status request to the external sensors at the end of each round of status requests.

In some embodiments, the NC translates between various upstream and downstream protocols, for example, to enable the distribution of information between WCs and the MC or between the WCs and the outward-facing network. For example, the NC may include a protocol conversion module responsible for such translation or conversion services. The protocol conversion module may be programmed to perform translation between any of a number of upstream protocols and any of a number of downstream protocols. For example, such upstream protocols can include UDP protocols such as BACnet, TCP protocols such as oBix, other protocols built over these protocols as well as various wireless protocols. Downstream protocols can include, for example, CANopen, other CAN-compatible protocol, and various wireless protocols including, for example, protocols based at least in part on the IEEE 802.11 standard (for example, WiFi), protocols based at least in part on the IEEE 802.15.4 standard (for example, ZigBee, 6LoWPAN, ISA 100.11a, WirelessHART or MiWi), protocols based at least in part on the Bluetooth standard (including the Classic Bluetooth, Bluetooth high speed and Bluetooth low energy protocols and including the Bluetooth v4.0, v4.1 and v4.2 versions), or protocols based at least in part on the EnOcean standard (ISO/IEC 14543 March 10).

In some embodiments, the NC uploads the information logged by the data logger (for example, as a CSV file) to the MC on a periodic basis, for example, every 24 hours. For example, the NC can transmit a CSV file to the MC via the File Transfer Protocol (FTP) or another suitable protocol over an Ethernet data link 316. The status information may be stored in a database or made accessible to applications over the outward-facing network.

In some embodiments, the NC includes functionality to analyze the information logged by the data logger. For example, an analytics module can be provided in the NC to receive and/or analyze the raw information logged by the data logger (e.g., in real time). In real time may include within at most 15 seconds (sec.), 30 sec., 45 sec., 1 minute (min), 2 min., 3 min. 4 min., 5 min, 10 min., 15 min. or 30 min from receipt of the logged information by the data logger, and/or from initiation of the operation (e.g., from receipt and/or from start of analysis). In some embodiments, the analytics module is programmed to make decisions based at least in part on the raw information from the data logger. In some embodiments, the analytics module communicates with the database to analyze the status information logged by the data logger after it is stored in the database. For example, the analytics module can compare raw values of electrical characteristics such as V_{Eff}, V_{Act} and I_{Act} with expected values or expected ranges of values and flag special conditions based at least in part on the comparison. For example, such flagged conditions can include power spikes indicating a failure such as a short, an error, or damage to an ECD. The analytics module may communicate such data to a tint determination module or to a power management module in the NC.

In some embodiments, the analytics module filters the raw data received from the data logger to more intelligently or efficiently store information in the database. For example, the analytics module can be programmed to pass only “interesting” information to a database manager for storage in the database. For example, interesting information can include anomalous values, values that otherwise deviate from expected values (such as based at least in part on empirical or historical values), or for specific periods when transitions are happening. Examples of data manipulation (e.g., filtering, parsing, temporarily storing, and efficiently storing long term in a database) can be found in International Patent Application Serial No. PCT/US15/29675 (Attorney Docket No. VIEWP049 X1WO) filed May 7, 2015, titled “CONTROL METHOD FOR TINTABLE WINDOWS,” that is hereby incorporated by reference in its entirety.

In some embodiments, a database manager module (or “database manager”) in the control system (e.g., in the NC) is configured to store information logged by the data logger to a database on a periodic basis, for example, at least every hour, every few hours, or every 24 hours. The database can be an external database such as the database described above. In some embodiments, the database can be internal to the controller (e.g., the NC). For example, the database can be implemented as a time-series database such as a Graphite database within the secondary memory of the controller (e.g., of the NC) or within another long term memory within the controller (e.g., the NC). For example, the database manager can be implemented as a Graphite Daemon executing as a background process, task, sub-task or application within a multi-tasking operating system of the controller (e.g., the NC). A time-series database can be advantageous over a relational database such as SQL because a time-series database is more efficient for data analyzed over time.

In some embodiments, the database can collectively refer to two or more databases, each of which can store some or all of the information obtained by some or all of the NCs in the network system. For example, it can be desirable to store copies of the information in multiple databases for redundancy purposes. The database can collectively refer to a multitude of databases, each of which is internal to a respective controller (e.g., NC), e.g., such as a Graphite or other times-series database. It can be beneficial to store copies of the information in multiple databases such that requests for information from applications including third party applications can be distributed among the databases and handled more efficiently. For example, the databases can be periodically or otherwise synchronized, e.g., to maintain consistency.

In some embodiments, the database manager filters data received from the analytics module to more intelligently and/or efficiently store information, e.g., in an internal and/or external database. For example, the database manager can be programmed to store (e.g., only) “interesting” information to a database. Interesting information can include anomalous values, values that otherwise deviate from expected values (such as based at least in part on empirical or historical values), and/or for specific periods when transitions are happening. More detailed examples of how data manipulation (e.g., how raw data can be filtered, parsed, temporarily stored, and efficiently stored long term in a database) can be found in International Patent Application Serial No. PCT/US15/29675 (Attorney Docket No. VIEWP049 X1WO) filed May 7, 2015, titled “CONTROL METHOD FOR TINTABLE WINDOWS,” that is hereby incorporated by reference herein in its entirety.

In some embodiments, a status determination module of a target is included in the controller (e.g., the NC, the MC, or the WC), e.g., for calculating, determining, selecting, or otherwise generating status values for the target. For example, a tint determination module can be included in the controller (e.g., the NC, the MC, or the WC) for calculating, determining, selecting, or otherwise generating tint values for the IGUs. For example, the status (e.g., tint) determination module can execute various algorithms, tasks, or subtasks to generate tint values based at least in part on a combination of parameters. The combination of parameters can include, for example, the status information collected and stored by the data logger. The combination of parameters also can include time or calendar information such as the time of day, day of year or time of season. The combination of parameters can include solar calendar information such as, for example, the direction of the sun relative to the target (e.g., IGUs). The combination of parameters can include one or more characteristics of the enclosure environment that comprise gaseous concentration (e.g., VOC, humidity, carbon dioxide, or oxygen), debris, gas type, gas flow velocity, gas flow direction, gas (e.g., atmosphere) temperature, noise level, or light level (e.g., brightness). The combination of parameters can include the outside parameters (e.g., temperature) external to the enclosure (e.g., building), the inside parameter (e.g., temperature) within the enclosure (e.g., a room adjoining the target IGUs), and/or the temperature within the interior volume of the IGUs. The combination of parameters can include information about the weather (for example, whether it is clear, sunny, overcast, cloudy, raining or snowing). Parameters such as the time of day, day of year, and/or direction of the sun, can be programmed into and tracked by the control system (e.g., that includes the NC). Parameters such as the outside temperature, inside temperature, and/or IGU temperature, can be obtained from sensors in, on or around the building or sensors integrated on or within the IGUs, for example. In some embodiments, various parameters are provided by, or determined based at least in part on, information provided by various applications including third party applications that can communicate with the controller(s) (e.g., NC) via an API. For example, the network controller application, or the operating system in which it runs, can be programmed to provide the API.

In some embodiments, the target status (e.g., tint) determination module determines status (e.g., tint) value(s) of the target based at least in part on user overrides, e.g., received via various mobile circuitry (e.g., device) applications, wall devices and/or other devices. In some embodiments, the status (e.g., tint) determination module determines status (e.g., tint) values based at least in part on command(s) or instruction(s) received by various applications, e.g., including third party applications and/or cloud-based applications. For example, such third party applications can include various monitoring services including thermostat services, alert services (e.g., fire detection), security services and/or other appliance automation services. Additional examples of monitoring services and systems can be found in International Patent Application Serial No. PCT/US15/19031 (Attorney Docket No. VIEWP061WO) filed Mar. 5, 2015, titled “MONITORING SITES CONTAINING SWITCHABLE OPTICAL DEVICES AND CONTROLLERS,” that is incorporated herein by reference in its entirety. Such applications can communicate with the status (e.g., tint) determination module and/or other modules within the controller(s) (e.g., NC) via one or more APIs. Some examples of APIs that the controller(s) (e.g., NC) can enable are described in International Patent Application Serial No. PCT/US15/64555 (Attorney Docket No. VIEWP073WO) filed Dec. 8, 2015, titled “MULTIPLE INTERFACING SYSTEMS AT A SITE,” that is incorporated herein by reference in its entirety.

In some embodiments, the analytics module compares values of V_{Eff}, V_{Act} and I_{Act} as well as sensor data obtained in real time and/or previously stored within the database with expected values or expected ranges of values and flag special conditions based at least in part on the comparison. For example, the analytics module can pass such flagged data, flagged conditions or related information to a power management module. For example, such flagged conditions can include power spikes indicating a short, an error, or damage to a smart window (e.g., an ECD). In some embodiments, the power management module modifies operations based at least in part on the flagged data or conditions. For example, the power management module can delay status (e.g., tint) commands of a target until power demand has dropped, stop commands to troubled controller(s) (e.g., local controller such as WC) (and put them in idle state), start staggering commands to controllers (e.g., lower hierarchy controllers such as WCs), manage peak power, and/or signal for help.

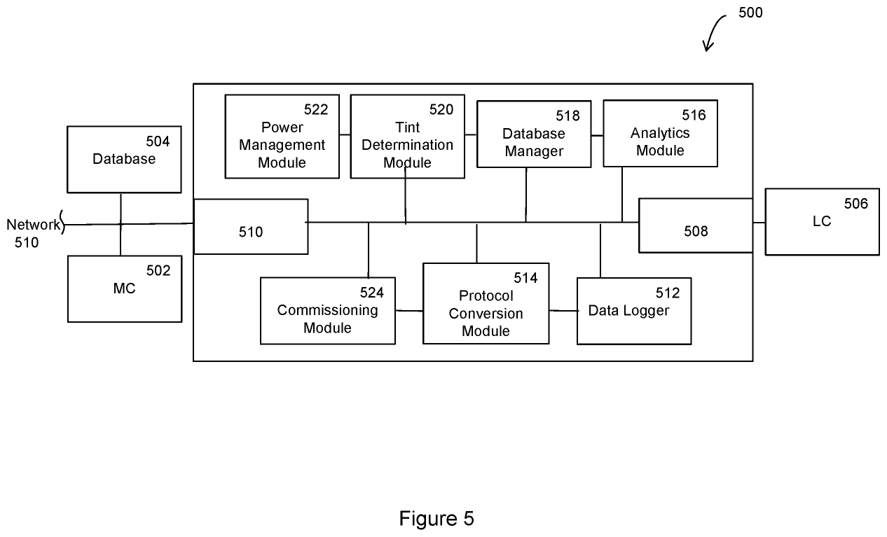

FIG. 5 shows an example network controller (NC) 500 including a plurality of modules. NC 500 is coupled to an MC 502 and a database 504 by an interface 510, and to a WC 506 by an interface 508. In the example, internal modules of NC 500 include data logger 512, protocol conversion module 514, analytics module 516, database manager 518, tint determination module 520, power management module 522, and commissioning module 524.

In some embodiments, a controller (e.g., WC) or other network device includes a sensor or sensor ensemble. For example, a plurality of sensors or a sensor ensemble may be organized into a sensor module. A sensor ensemble may comprise a circuit board, such as a printed circuit board, e.g., in which a number of sensors are adhered or affixed to the circuit board. Sensor(s) can be removed (e.g., reversibly removed) from a sensor module. For example, a sensor may be plugged into and/or unplugged out of, the circuit board. Sensor(s) may be individually activated and/or deactivated (e.g., using a switch). The circuit board may comprise a polymer. The circuit board may be transparent or non-transparent. The circuit board may comprise metal (e.g., elemental metal and/or metal alloy). The circuit board may comprise a conductor. The circuit board may comprise an insulator. The circuit board may comprise any geometric shape (e.g., rectangle or ellipse). The circuit board may be configured (e.g., may be of a shape) to allow the ensemble to be disposed in frame portion such as a mullion (e.g., of a window). The circuit board may be configured (e.g., may be of a shape) to allow the ensemble to be disposed in a frame (e.g., door frame and/or window frame). The frame may comprise one or more holes, e.g., to allow the sensor(s) to obtain (e.g., accurate) readings. The circuit board may be enclosed in a wrapping. The wrapping may comprise flexible or rigid portions. The wrapping may be flexible. The wrapping may be rigid (e.g., be composed of a hardened polymer, from glass, or from a metal (e.g., comprising elemental metal or metal alloy). The wrapping may comprise a composite material. The wrapping may comprise carbon fibers, glass fibers, and/or polymeric fibers. The wrapping may have one or more holes, e.g., to allow the sensor(s) to obtain (e.g., accurate) readings. The circuit board may include an electrical connectivity port (e.g., socket). The circuit board may be connected to a power source (e.g., to electricity). The power source may comprise renewable and/or non-renewable power source.

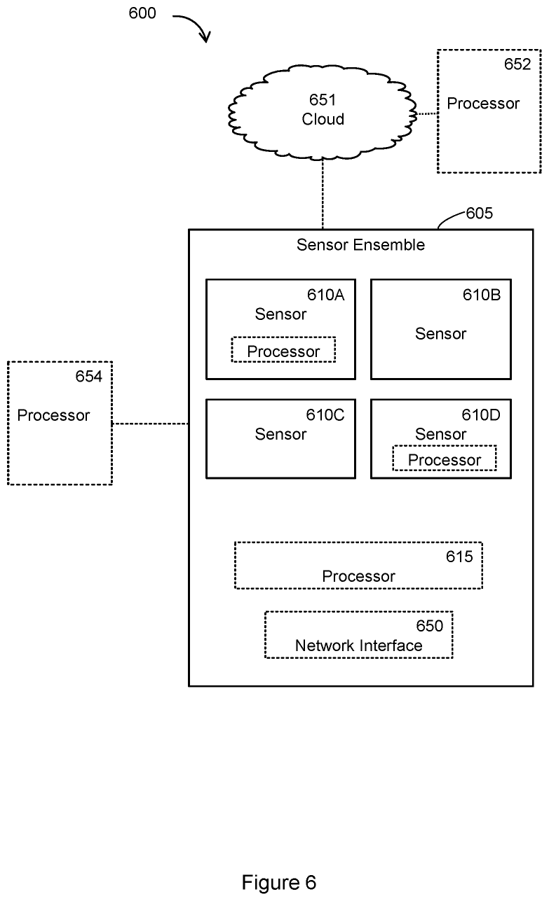

FIG. 6 shows diagram 600 having an example of an ensemble of sensors organized into a sensor module. Sensors 610A, 610B, 610C, and 610D are shown as included in sensor ensemble 605. An ensemble of sensors organized into a sensor module may include at least 1, 2, 4, 5, 8, 10, 20, 50, or 500 sensors. The sensor module may include a number of sensors in a range between any of the aforementioned values (e.g., from about 1 to about 1000, from about 1 to about 500, or from about 500 to about 1000). Sensors of a sensor module may comprise sensors configured and/or designed for sensing a parameter comprising: temperature, humidity, carbon dioxide, particulate matter (e.g., between 2.5 μm and 10 μm), total volatile organic compounds (e.g., via a change in a voltage potential brought about by surface adsorption of volatile organic compound), ambient light, audio noise level, pressure (e.g. gas, and/or liquid), acceleration, time, radar, lidar, radio signals (e.g., ultra-wideband radio signals), passive infrared, glass breakage, or movement detectors. The sensor ensemble (e.g., 605) may comprise non-sensor devices, such as buzzers and light emitting diodes. Examples of sensor ensembles and their uses can be found in U.S. patent application Ser. No. 16/447,169, filed Jun. 20, 2019, titled “SENSING AND COMMUNICATIONS UNIT FOR OPTICALLY SWITCHABLE WINDOW SYSTEMS” that is incorporated herein by reference in its entirety.

In some embodiments, an increase in the number and/or types of sensors may be used to increase a probability that one or more measured properties is accurate and/or that a particular event measured by one or more sensor has occurred. In some embodiments, sensors of sensor ensemble may cooperate with one another. In an example, a radar sensor of sensor ensemble may determine presence of a number of individuals in an enclosure. A processor (e.g., processor 615) may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, network interface (e.g., 650) may communicate with other sensor ensembles similar to sensor ensemble. The network interface may additionally communicate with a controller.

Individual sensors (e.g., sensor 610A, sensor 610D, etc.) of a sensor ensemble may comprise and/or utilize at least one dedicated processor. A sensor ensemble may utilize a remote processor (e.g., 654) utilizing a wireless and/or wired communications link. A sensor ensemble may utilize at least one processor (e.g., processor 652), which may represent a cloud-based processor coupled to a sensor ensemble via the cloud (e.g., 650). Processors (e.g., 652 and/or 654) may be located in the same building, in a different building, in a building owned by the same or different entity, a facility owned by the manufacturer of the window/controller/sensor ensemble, or at any other location. In various embodiments, as indicated by the dotted lines of FIG. 6, sensor ensemble 605 is not required to comprise a separate processor and network interface. These entities may be separate entities and may be operatively coupled to ensemble 605. The dotted lines in FIG. 6 designate optional features. In some embodiments, onboard processing and/or memory of one or more ensemble of sensors may be used to support other functions (e.g., via allocation of ensembles(s) memory and/or processing power to the network infrastructure of a building).

In some embodiments, sensor data is exchanged among various network devices and controllers. The sensor data may also be accessible to remote users (e.g., inside or outside the same building) for retrieval using personal electronic devices, for example. Applications executing on remote devices to access sensor data may also provide commands for controllable functions such as tint commands for a window controller. An example window controller(s) is described in International Patent Application Serial No. PCT/US16/58872, filed Oct. 26, 2016, titled “CONTROLLERS FOR OPTICALLY-SWITCHABLE DEVICES,” and in U.S. patent application Ser. No. 15/334,832, filed Oct. 26, 2016, titled CONTROLLERS FOR OPTICALLY-SWITCHABLE DEVICES, each of which is herein incorporate by reference in its entirety.

In some embodiments, the controller (e.g., NC) periodically requests status information from lower hierarchy controller(s) (e.g., from the WCs it controls). For example, the controller (e.g., NC) can communicate a status request to at least one (e.g., each) of the lower hierarchy controller(s) (e.g., from the WCs it controls) at a frequency of at least every few seconds, every few tens of seconds, every minute, every few minutes, or after any requested period of time. In some embodiments, at least one (e.g., each) status request is directed to a respective one of the lower hierarchy controllers (e.g., WCs) using the CAN ID or other identifier of the respective lower hierarchy controller(s) (e.g., WCs). In some embodiments, the controller (e.g., NC) proceeds sequentially through all of the lower hierarchy controllers (e.g., WCs) it controls during at least one (e.g., each) round of status acquisition. The controller (e.g., NC) can loop through at least two (e.g., all) of the lower hierarchy controllers (e.g., WCs) it controls such that a status request is sent to these lower hierarchy controllers (e.g., WCs) sequentially in the round of status acquisition. After a status request has been sent to a given lower hierarchy controller (e.g., WC), the upper hierarchy level controller (e.g., NC) may waits to receive the status information from one lower hierarchy controller (e.g., WC), e.g., before sending a status request to the next one of the lower hierarchy controller (e.g., WC) in the round of status acquisition.

In some embodiments, after status information has been received from all of the lower hierarchy controllers (e.g., WCs) that the upper hierarchy controller (e.g., NC) controls, the upper hierarchy controller (e.g., NC) performs a round of status change (e.g., tint) command distribution to the target (e.g., to the IGU). For example, in some implementations, at least one (e.g., each) round of status acquisition is followed by a round of tint command distribution, which is then followed by a next round of status acquisition and a next round of tint command distribution, and so on. In some embodiments, during a round of status (e.g., tint) command distribution to the controller of the target, the controller (e.g., NC) proceeds to send a tint command to the lower hierarchy controller (e.g., WC) that the higher hierarchy controller (e.g., NC) controls. In some embodiments, the hierarchy controller (e.g., NC) proceeds sequentially through all of the lower hierarchy controllers (e.g., WCs) it controls during the round of tint command distribution. In other words, the hither hierarchy (e.g., NC) controller loops through (e.g., all of) the lower hierarchy controllers (e.g., WCs) it controls such that a status (e.g., tint) command is sent to (e.g., each of) the lower hierarchy controllers (e.g., WCs) sequentially in the round of status (e.g., tint) command distribution to change the status of the target (e.g., change the tint state of the IGU).

In some embodiments, a status request includes one or more instructions indicating what status information is being requested from the respective lower hierarchy controller (e.g., local controller such as a WC). In some embodiments, responsive to the receipt of such a request, the respective lower hierarchy controllers (e.g., WC) responds by transmitting the requested status information to the higher hierarchy controller (e.g., NC) (e.g., via the communication lines in an upstream set of cables). In some other embodiments, each status request by default causes the lower hierarchy controllers (e.g., WC) to transmit a predefined set of information for the set of targets (e.g., IGUs, sensors, emitters, or media) it controls. The status information that the lower hierarchy controllers (e.g., WC) communicates to the upper hierarchy controller (e.g., NC) responsive to the status request, can include a (e.g., tint) status value(S) for the target (e.g., IGUs). For example, indicating whether the targets (e.g., IGUs) is undergoing a status change (e.g., tinting transition) or has finished a status change (e.g., tinting transition, or light intensity change). The tint status value S or another value can indicate a particular stage in a tinting transition (for example, a particular stage of a voltage control profile). In some embodiments, the status value S or another value indicates whether the lower hierarchy controller (e.g., WC) is in a sleep mode. The status information communicated in response to the status request also can include the status (e.g., tint) value (C) for the target (e.g., IGUs), for example, as set by the controller (e.g., MC or the NC). The response also can include a set point voltage set by the lower hierarchy controller (e.g., WC) based at least in part on the status (e.g., tint) value (e.g., the value of the effective applied V_{Eff}). In some embodiments, the response includes a near real-time actual voltage level V_{Act} measured, detected, or otherwise determined across the ECDs within the IGUs (for example, via the amplifier and the feedback circuit). In some embodiments, the response includes a near real-time actual current level I_{act} measured, detected, or otherwise determined through the ECDs within the IGUs (for example, via the amplifier and the feedback circuit). The response also can include various near real-time sensor data, for example, collected from photosensors or temperature sensors integrated on or within the IGUs.

The window controllers described herein also are suited for integration with or are within/part of a building management system (BMS). A BMS is a computer-based control system installed in a building that monitors and controls the building's mechanical and electrical equipment such as ventilation, lighting, power systems, elevators, fire systems, and security systems. A BMS may include hardware, including interconnections by communication channels to a computer or computers, and associated software for maintaining conditions in the building according to preferences set by the occupants and/or by the building manager. For example, a BMS may be implemented using a local area network, such as Ethernet. The software can be based on, for example, internet protocols and/or open standards. One example is software from Tridium, Inc. (of Richmond, Virginia). One communications protocol commonly used with a BMS is BACnet (building automation and control networks).

A BMS is most common in a large building, and typically functions at least to control the environment within the building. For example, a BMS may control temperature, carbon dioxide levels, and humidity within a building. Typically, there are many mechanical devices that are controlled by a BMS such as heaters, air conditioners, blowers, vents, and the like. To control the building environment, a BMS may turn on and off these various devices under defined conditions. A core function of a typical modern BMS is to maintain a comfortable environment for the building's occupants while minimizing heating and cooling costs/demand. Thus, a modern BMS is used not only to monitor and control, but also to optimize the synergy between various systems, for example, to conserve energy and lower building operation costs.

In some embodiments, a window controller is integrated with a BMS, where the window controller is configured to control one or more electrochromic windows or other tintable windows. In other embodiments, the window controller is within or part of the BMS and the BMS controls both the tintable windows and the functions of other systems of the building. In one example, the BMS may control the functions of all the building systems including the one or more zones of tintable windows in the building.

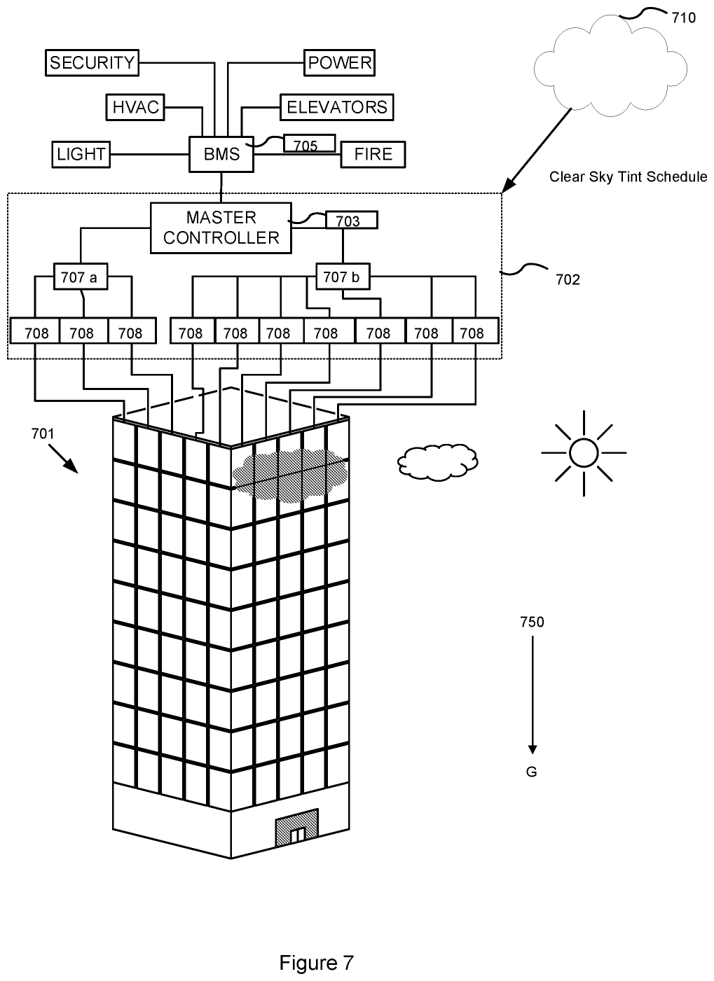

In some embodiments, each tintable window of the one or more zones includes at least one solid state and inorganic electrochromic device. In one embodiment, each of the tintable windows of the one or more zones is an electrochromic window having one or more solid state and inorganic electrochromic devices. In one embodiment, the one or more tintable windows include at least one all solid state and inorganic electrochromic device, but may include more than one electrochromic device, e.g. where each lite or pane of an IGU is tintable. In one embodiment, the electrochromic windows are multistate electrochromic windows, as described in U.S. patent application Ser. No. 12/851,514, filed Aug. 5, 2010, titled “MULTIPANE ELECTROCHROMIC WINDOWS.” FIG. 7 depicts a schematic diagram of an example of a building 701 and a BMS 705 that manages a number of building systems including security systems, heating/ventilation/air conditioning (HVAC), lighting of the building, power systems, elevators, fire systems, and the like. Security systems may include magnetic card access, turnstiles, solenoid driven door locks, surveillance cameras, burglar alarms, metal detectors, and the like. Fire systems may include fire alarms and fire suppression systems including a water plumbing control. Lighting systems may include interior lighting, exterior lighting, emergency warning lights, emergency exit signs, and emergency floor egress lighting. Power systems may include the main power, backup power generators, and uninterrupted power source (UPS) grids.

Also, the BMS 705 manages a window control system 702. The window control system 702 is a distributed network of window controllers including a master controller, 703, network controllers, 707a and 707b, and end or leaf controllers 708. End or leaf controllers 708 may be similar to window controller 104 described with respect to FIG. 1. For example, master controller 703 may be in proximity to the BMS 705, and each floor of building 701 may have one or more network controllers 707a and 707b, while each window of the building has its own end controller 708. In this example, each of controllers 708 controls a specific electrochromic window of building 701. Window control system 702 is in communication with a cloud network 710 to receive data. For example, the window control system 702 can receive schedule information from clear sky models maintained on cloud network 710. Although, master controller 703 is described in FIG. 7 as separate from the BMS 705, in another embodiment, the master controller 703 is part of or within the BMS 705. Each of controllers 708 can be in a separate location from the electrochromic window that it controls, or be integrated into the electrochromic window. For simplicity, only ten electrochromic windows of building 701 are depicted as controlled by master window controller 702. In a typical setting there may be a large number of electrochromic windows in a building controlled by window control system 702. Advantages and features of incorporating electrochromic window controllers as described herein with BMSs are described below in more detail and in relation to FIG. 7, where appropriate. Building 701 is depicted next to a gravitational vector 750 directed towards the gravitational center.

One aspect of the disclosed embodiments is a BMS including a multipurpose electrochromic window controller as described herein. By incorporating feedback from a electrochromic window controller, a BMS can provide, for example, enhanced: 1) environmental control, 2) energy savings, 3) security, 4) flexibility in control options, 5) improved reliability and usable life of other systems due to less reliance thereon and therefore less maintenance thereof, 6) information availability and diagnostics, 7) effective use of, and higher productivity from, staff, and various combinations of these, because the electrochromic windows can be automatically controlled. In some embodiments, a BMS may not be present or a BMS may be present but may not communicate with a master controller or communicate at a high level with a master controller. In certain embodiments, maintenance on the BMS would not interrupt control of the electrochromic windows.

In some cases, the systems of BMS 605 or an associated building network may run according to daily, monthly, quarterly, or yearly schedules. For example, the lighting control system, the window control system, the HVAC, and the security system may operate on a 24 hour schedule accounting for when people are in the building during the work day. At night, the building may enter an energy savings mode, and during the day, the systems may operate in a manner that minimizes the energy consumption of the building while providing for occupant comfort. As another example, the systems may shut down or enter an energy savings mode over a holiday period.

The BMS schedule may be combined with geographical information. Geographical information may include the latitude and longitude of the building. Geographical information also may include information about the direction that each side of the building faces. Using such information, different rooms on different sides of the building may be controlled in different manners. For example, for east facing rooms of the building in the winter, the window controller may instruct the windows to have no tint in the morning so that the room warms up due to sunlight shining in the room and the lighting control panel may instruct the lights to be dim because of the lighting from the sunlight. The west facing windows may be controllable by the occupants of the room in the morning because the tint of the windows on the west side may have no impact on energy savings. However, the modes of operation of the east facing windows and the west facing windows may switch in the evening (e.g., when the sun is setting, the west facing windows are not tinted to allow sunlight in for both heat and lighting).

Described below is an example of a building, for example, like building 701 in FIG. 7, including a building network or a BMS, tintable windows for the exterior windows of the building (i.e., windows separating the interior of the building from the exterior of the building), and a number of different sensors. Light from exterior windows of a building generally has an effect on the interior lighting in the building about 20 feet or about 30 feet from the windows. That is, space in a building that is more that about 20 feet or about 30 feet from an exterior window receives little light from the exterior window. Such spaces away from exterior windows in a building are lit by lighting systems of the building.

Further, the temperature within a building may be influenced by exterior light and/or the exterior temperature. For example, on a cold day and with the building being heated by a heating system, rooms closer to doors and/or windows will lose heat faster than the interior regions of the building and be cooler compared to the interior regions.

For exterior sensors, the building may include exterior sensors on the roof of the building. Alternatively, the building may include an exterior sensor associated with each exterior window or an exterior sensor on each side of the building. An exterior sensor on each side of the building could track the irradiance on a side of the building as the sun changes position throughout the day.

In some embodiments, the output signals received include a signal indicating energy or power consumption by a heating system, a cooling system, and/or lighting within the building. For example, the energy or power consumption of the heating system, the cooling system, and/or the lighting of the building may be monitored to provide the signal indicating energy or power consumption. Devices may be interfaced with or attached to the circuits and/or wiring of the building to enable this monitoring. Alternatively, the power systems in the building may be installed such that the power consumed by the heating system, a cooling system, and/or lighting for an individual room within the building or a group of rooms within the building can be monitored.

Tint instructions can be provided to change to tint of the tintable window to the determined level of tint. For example, referring to FIG. 7, this may include master controller 703 issuing commands to one or more network controllers 707a and 707b, which in turn issue commands to end controllers 708 that control each window of the building. End controllers 708 may apply voltage and/or current to the window to drive the change in tint pursuant to the instructions.

In some embodiments, a building including electrochromic windows and a BMS may be enrolled in or participate in a demand response program run by the utility or utilities providing power to the building. The program may be a program in which the energy consumption of the building is reduced when a peak load occurrence is expected. The utility may send out a warning signal prior to an expected peak load occurrence. For example, the warning may be sent on the day before, the morning of, or about one hour before the expected peak load occurrence. A peak load occurrence may be expected to occur on a hot summer day when cooling systems/air conditioners are drawing a large amount of power from the utility, for example. The warning signal may be received by the BMS of the building or by window controllers configured to control the electrochromic windows in the building. This warning signal can be an override mechanism that disengages window controllers from the system. The BMS can then instruct the window controller(s) to transition the appropriate electrochromic device in the electrochromic windows to a dark tint level aid in reducing the power draw of the cooling systems in the building at the time when the peak load is expected.

In some embodiments, tintable windows for the exterior windows of the building (i.e., windows separating the interior of the building from the exterior of the building), may be grouped into zones, with tintable windows in a zone being instructed in a similar manner. For example, groups of electrochromic windows on different floors of the building or different sides of the building may be in different zones. For example, on the first floor of the building, all of the east facing electrochromic windows may be in zone 1, all of the south facing electrochromic windows may be in zone 2, all of the west facing electrochromic windows may be in zone 3, and all of the north facing electrochromic windows may be in zone 4. As another example, all of the electrochromic windows on the first floor of the building may be in zone 1, all of the electrochromic windows on the second floor may be in zone 2, and all of the electrochromic windows on the third floor may be in zone 3. As yet another example, all of the east facing electrochromic windows may be in zone 1, all of the south facing electrochromic windows may be in zone 2, all of the west facing electrochromic windows may be in zone 3, and all of the north facing electrochromic windows may be in zone 4. As yet another example, east facing electrochromic windows on one floor could be divided into different zones. Any number of tintable windows on the same side and/or different sides and/or different floors of the building may be assigned to a zone. In embodiments where individual tintable windows have independently controllable zones, tinting zones may be created on a building façade using combinations of zones of individual windows, e.g. where individual windows may or may not have all of their zones tinted.

In some embodiments, electrochromic windows in a zone may be controlled by the same window controller or same set of window controllers. In some other embodiments, electrochromic windows in a zone may be controlled by different window controller(s).,

In some embodiments, electrochromic windows in a zone may be controlled by a window controller or controllers that receive an output signal from a transmissivity sensor. In some embodiments, the transmissivity sensor may be mounted proximate the windows in a zone. For example, the transmissivity sensor may be mounted in or on a frame containing an IGU (e.g., mounted in or on a mullion, the horizontal sash of a frame) included in the zone. In some other embodiments, electrochromic windows in a zone that includes the windows on a single side of the building may be controlled by a window controller or controllers that receive an output signal from a transmissivity sensor.

In some embodiments, a building manager, occupants of rooms in the second zone, or other person may manually instruct (using a tint or clear command or a command from a user console of a BMS, for example) the electrochromic windows in the second zone (i.e., the follower control zone) to enter a tint level such as a colored state (level) or a clear state. In some embodiments, when the tint level of the windows in the second zone is overridden with such a manual command, the electrochromic windows in the first zone (i.e., the master control zone) remain under control of an output received from a transmissivity sensor. The second zone may remain in a manual command mode for a period of time and then revert back to be under control of an output from the transmissivity sensor. For example, the second zone may stay in a manual mode for one hour after receiving an override command, and then may revert back to be under control of the output from the transmissivity sensor.

In some embodiments, a building manager, occupants of rooms in the first zone, or other person may manually instruct (using a tint command or a command from a user console of a BMS, for example) the windows in the first zone (i.e., the master control zone) to enter a tint level such as a colored state or a clear state. In some embodiments, when the tint level of the windows in the first zone is overridden with such a manual command, the electrochromic windows in the second zone (i.e., the follower control zone) remain under control outputs from the exterior sensor. The first zone may remain in a manual command mode for a period of time and then revert back to be under control of the output from the transmissivity sensor. For example, the first zone may stay in a manual mode for one hour after receiving an override command, and then may revert back to be under control of an output from the transmissivity sensor. In some other embodiments, the electrochromic windows in the second zone may remain in the tint level that they are in when the manual override for the first zone is received. The first zone may remain in a manual command mode for a period of time and then both the first zone and the second zone may revert back to be under control of an output from the transmissivity sensor.

Any of the methods described herein of control of a tintable window, regardless of whether the window controller is a standalone window controller or is interfaced with a building network, may be used control the tint of a tintable window.

In some embodiments, one or more models for a particular building site are generated. The model(s) may be used to determine tint levels for particular windows or zones, tinting schedules for particular windows or zones, and/or the like. The models may be based at least in part on weather information, sensor readings (e.g., obtained using one or more sensors, one or more sensors of a sensor ensemble, etc.), scheduling information, occupancy information, and/or the like. Such models are sometimes referred to herein as “prescriptive models,” which may predict target states of controllable devices based on objective factors or objective considerations. In some embodiments, the system architecture described herein does not require a window control system to actively generate models of the building. Instead, models specific to the building site may be generated and/or maintained (i) on a cloud network and/or (ii) on other network separate from the window control system. For example, neural network models (e.g., a dense neural network (DNN) and/or a long short-term memory (LSTM) network) are initialized, retrained, and/or the live models executed on the cloud network or other network separate from the window control system and the tint schedule information from these models is provided (e.g., deployed, or pushed) to a window control system 840.

Tint schedule information define rules that are derived from these models and that are pushed to the window control system. The window control system uses the tint schedule information derived from the predefined models, custom to the building in question, to make final tinting decisions implemented at the tintable windows. The 3D models are maintained on a cloud-based 3D modeling platform that can generate visualizations of the 3D model to allow users to manage input for setting up and customizing the building site and the corresponding final tint states applied to the tintable windows. Once the tint schedule information is loaded into the window control system, there is no need for modeling calculations to tie up computing power of the control system. Tint schedule information resulting from any changes to the models can be pushed to the window control system when needed. It would be understood that although the system architecture is generally described herein with respect to controlling tintable windows, other components and systems at the building could additionally or alternatively be controlled with this architecture.

In various implementations, system architecture includes cloud-based modules to setup and customize a 3D model of the building site. A cloud-based 3D model system initializes the 3D model of the building site using architectural model(s) as input, for example, an Autodesk ®Revit model or other industry standard building model may be used. A 3D model in its simplest form includes exterior surfaces of structures of the building including window openings and a stripped version of the interior of the building with only floors and walls. More complex models may include the exterior surfaces of objects surrounding the building as well as more detailed features of the interior and exterior of the building. The system architecture also includes a cloud-based clear sky module that assigns reflective or non-reflective properties to the exterior surfaces of the objects in the 3D model, defines interior three-dimensional occupancy regions, assigns IDs to windows, and groups windows into zones based on input from users. Time varying simulations of the resulting clear sky 3D model (i.e. the 3D model with configuration data having the assigned attributes) can be used to determine the direction of sunlight at the different positions of the sun under clear sky conditions and taking into account shadows and reflections from the objects at the building site, sunlight entering spaces of the building, and the intersection of 3D projections of sunlight with three-dimensional occupancy regions in the building. The clear sky module uses this information to determine whether certain conditions exist for particular occupancy regions (i.e. from the perspective of the occupant) such as, for example, a glare condition, direct and indirect reflection condition, and passive heat condition. The clear sky module determines a clear sky tint state for each zone at each time interval based on the existence of particular conditions at that time, tint states assigned to the conditions, and the priority of different conditions if multiple conditions exist. The tint schedule information, typically for a year, is pushed to, e.g. a master controller of, the window control system at the building. The window control system determines a weather-based tint state for each zone at each time interval based on sensor data such as measurements from infrared sensors and/or photosensors. The window control system then determines the minimum of the weather-based tint state and the clear sky tint state to set the final tint state and send tint instructions to implement the final tint state at the zones of the tintable windows. Thus, in some embodiments, the window control system does not model the building or 3D parameters around and inside the building, that is done offline and therefore computing power of the window control system can be used for other tasks, such as applying tint states based on the model(s) and/or other input(s) received by the window control system.

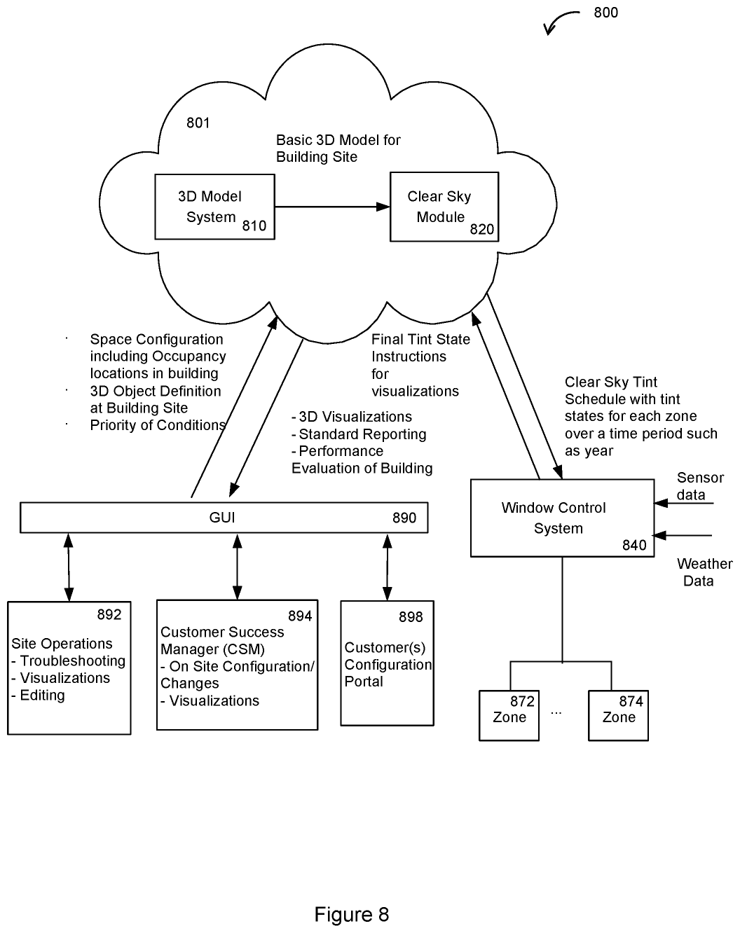

FIG. 8 is a schematic illustration depicting the general architecture 800 of systems and users involved in initializing and customizing models maintained in a cloud network 801 and controlling the tintable windows of a building based on output such as rules from the models, according to various implementations. The system architecture 800 includes a cloud-based 3D model system 810 in communication with a cloud-based clear sky module 820, where the combination of 810 and 820 is referred to Module A. In one embodiment, Module A provides inputs to a window control system 840. The 3D model system 810 can initialize and/or revise a 3D model of a building site and communicate the data for the 3D model to the clear sky module 820. The 3D model initialized by the 3D model system includes the exterior surfaces of the surrounding structures and other objects at the building site and the building stripped of all but walls, floors, and exterior surfaces. The cloud-based clear sky module 820 can assign attributes to the 3D model to generate clear sky 3D models such as, e.g., one or more of a glare/shadow model, a reflection model, and a passive heat model. The cloud-based systems are in communication with each other and with other applications via the cloud network using application program interfaces (APIs). Both the cloud-based 3D model system 810 and the clear sky module 820 include logic as described in more detail herein. It would be understood that the logic of these cloud-based modules as well as other modules described herein and others can be stored in computer readable medium (e.g. memory) of a server of the cloud network and that one or more processors on the server in the cloud network are in communication with the computer readable medium to execute instructions to perform the functions of the logic. In one embodiment, window control system 840 also receives inputs from a Module B, which is described further herein. In another embodiment, window control system 840 receives inputs from Modules A, C1 and D1.

The clear sky module 820 can use the 3D model of a building site to generate simulations over time for different positions of the sun under clear sky conditions to determine glare, shadows and reflections from one or more objects at and around the building site. For example, the clear sky module 820 can generate a clear sky glare/shadow model and a reflection model and using a ray tracing engine can determine the direct sunlight through the window openings of a building based on shadows and reflections under clear sky conditions. The clear sky module 820 uses shadow and reflection data to determine the existence of glare, reflection, and passive heat conditions at occupancy regions (i.e. likely locations of occupants) of the building. The cloud-based clear sky module 820 determines a yearly schedule (or other time period) of tint states for each of the zones of the building based on these conditions. The cloud-based clear sky module 820 typically pushes the tint schedule information to the window control system 840.

The window control system 840 includes a network of window controllers. The window control system 840 is in communication with the zones of tintable windows in the building, depicted in FIG. 8 as series of zones from a 1^{st} zone 872 to an n^{th} zone 874. The window control system 840 determines final tint states and sends tint instructions to control the tint states of the tintable windows. The final tint states are determined based on the yearly schedule information, sensor data, and/or weather feed data. As described with respect to the illustrated system architecture 800, the window control system 840 does not generate models or otherwise waste computing power on modeling. The models, which are specific to the building site, are created, customized, and stored in the cloud network 801. The predefined tint schedule information is pushed to the window control system initially, and then again only if updates to the 3D model are needed (for example changes to the building layout, new objects in the surrounding area, or the like).

The system architecture 800 also includes a graphical user interface (GUI) 890 for communicating with customers and other users to provide application services, reports, and visualizations of the 3D model and to receive input for setting up and customizing the 3D model. Visualizations of the 3D model can be provided to users and received from users through the GUI. The illustrated users include site operations 892 that are involved in troubleshooting at the site and have the capability to review visualizations and edit the 3D model. The users also include a Customer Success Manager (CSM) 894 with the capability of reviewing visualizations and on-site configuration changes to the 3D model. The users also include a customer(s) configuration portal 898 in communication with various customers. Through the customer(s) configuration portal 898, the customers can review various visualizations of data mapped to the 3D model and provide input to change the configuration at the building site. Some examples of input from the users include space configurations such as occupancy areas, 3D object definition at the building site, tint states for particular conditions, and priority of conditions. Some examples of output provided to users include visualizations of data on the 3D model, standard reporting, and performance evaluation of the building. Certain users are depicted for illustrative purposes. It would be understood that other or additional users could be included.

Although many examples of the system architecture are described herein with the 3D Model system, clear sky module, and neural network models residing on the cloud network, in another implementation, one or more these modules and models do not necessarily need reside on the cloud network. For example, the 3D Model system, the clear sky module and or other modules or models described herein may reside on a standalone computer or other computing device that is separate from and in communication with the window control system. As another example, the neural network models described herein may reside on a window controller such as a master window controller or a network window controller.

In certain embodiments, the computational resources for training and executing the various models (e.g., a DNN and LSTM model) and modules of the system architecture described herein include: (1) local resources of the window control system, (2) remote sources separate from the window control system, or (3) shared resources. In the first case, the computational resources for training and executing the various models and modules reside on the master controller or one or more window controllers of a distributed network of window controllers. In the second case, the computational resources for training and executing the various models and modules reside on remote resources separate from the window control system. For example, the computational resources may reside on a server of an external third-party network or on a server of a leasable cloud-based resource such as might be available over the cloud network 801 in FIG. 8. As another example, the computational resources may reside on a server of a standalone computing device at the site separate from and in communication with the window control system. In the third case, the computational resources for training and executing the various models and modules reside on shared resources (both local and remote). For example, the remote resource such as a leasable cloud-based resource available over the cloud network 801 in FIG. 8 perform daily retraining operations of a DNN model and/or a LSTM model at night and the local resources such as a master window controller or a group of window controllers execute the live models during the day when tint decisions need to be made.

The system architecture described herein includes a window control system that includes a network of window controllers controlling the tint levels of the one or more zones of tintable windows at the building. Some examples of controllers that may be included in the window control system 840 of the system architecture are described with respect to FIG. 1. Other examples of window controllers are described in U.S. patent application Ser. No. 15/334,835, filed Oct. 26, 2016, titled “CONTROLLERS FOR OPTICALLY-SWITCHABLE DEVICES,” which is hereby incorporated by reference in its entirety.

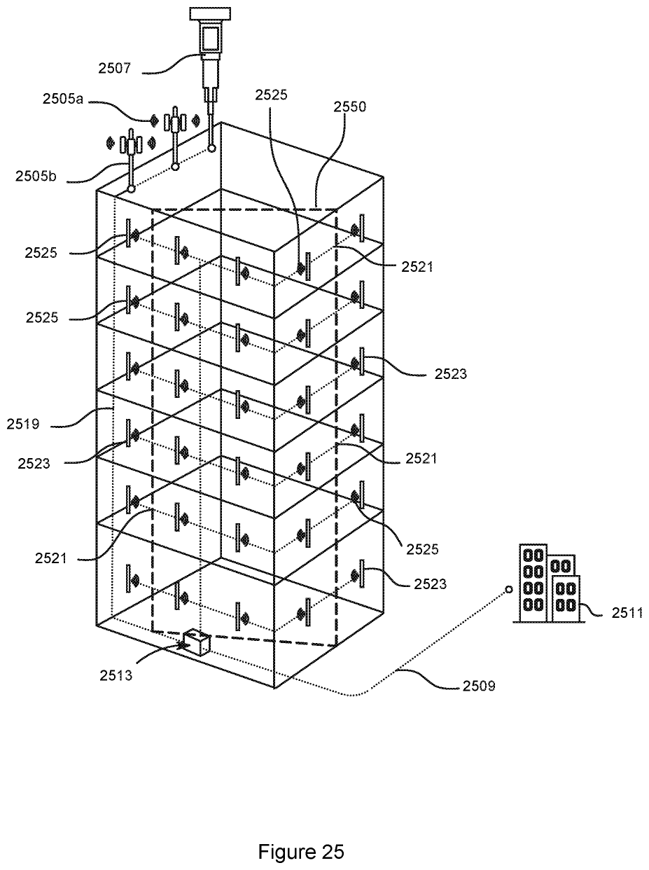

Window control system 840 includes control logic for making tinting decisions and sending tint instructions to change tint levels of the tintable windows. In certain embodiments, the control logic includes a Module A having a cloud-based 3D model system 810 and a cloud-based clear sky module 820, and a Module B described further below, where Module B receives signals from a Module C with one or more photosensor values and/or from a Module D with one or more infrared sensor values. Module C may include one or more photosensors that take photosensor readings or may receive signals with the raw photosensor readings from one or more photosensors, e.g., residing in a multi-sensor device such as a sky sensor. Module D may include one or more infrared sensors and/or an ambient temperature sensor(s) that take temperature readings or may receive signals with the raw temperature measurements from one or more infrared sensors, e.g., residing in a multi-sensor device such as a sky sensor (e.g., FIG. 25, 2507).

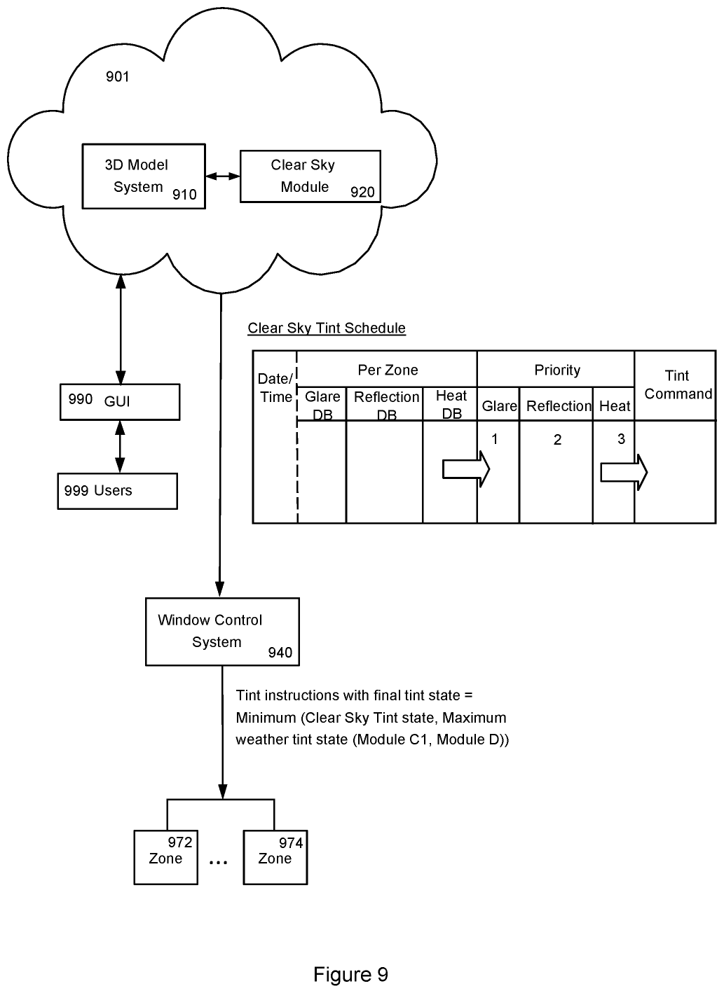

FIG. 9 is an illustrated example of the flow of data communicated between some of the systems of the system architecture 800 shown in FIG. 8. As shown, cloud network 901 (including 910 and 920) provides its information to the window control system 940. Window control system 940 controls zones 972 and 974. In one implementation, the control logic of the window control system 940 also receives one or more inputs from Module B and sets the final tint state for each zone based on outputs received from Module A and/or Module B. other implementations, the control logic of the window control system 940 also receives one or more inputs from Module C1 and Module D1 and sets the final tint state for each zone based on outputs received from Module A, Module C1, and Module D1. Cloud network 901 receives inputs from a GUI 990, which receives inputs from users 999.

In some embodiments, states of one or more devices of a facility are altered from one or more respective present states. In some embodiments, a device may include one or more environmental conditions system components (e.g., an HVAC component, a lighting system component, etc.), one or more security system components (e.g., an audible alarm component, a visible alarm component, a lock system, etc.), a health system component, an electrical system component, a communication system component (e.g., one or more media displays, one or more speakers, etc.), and/or a personnel convection component (e.g., one or more elevator systems), and/or one or more tintable windows. In some embodiments, a present state of a device may be determined based at least in part on (i) (e.g., explicit) user configuration settings, (ii) scheduling information, and/or (iii) a machine learning model directed to prescriptive (a) modeling and/or (b) control, of the one or more devices. The prescriptive modeling may be based at least in part on (I) weather information, (II) sensor data, (III) scheduling information, (IV) energy consumption information, or (V) any combination thereof. Examples of prescriptive modeling include Modules A, B, C, and/or D. In some embodiments, an altered state of a device in a facility may be a state that is different than a determined state. The determination of the state may be based at least in part on one or more (a) prescriptive models and/or (b) (e.g., explicit) user configuration settings. In some embodiments, an altered state of a device may be an override of a present state of a device. For example, a control system may prescribe tint level one to a tintable window, and a user prefers tint level two for that tintable window. The user may override the tint level decision of the control system for that window (of tint one), and prescribe or suggest a tint level two for that window.

In some embodiments, a state of a device of a facility is altered based at least in part on one or more machine learning models that consider user input indicative of preferences regarding the state of the device. In some embodiments, the one or more machine learning models may be referred to herein as one or more behavioral models. A behavioral model may work in connection with a prescriptive model and/or may override a prescriptive model. In some embodiments, a behavioral model may learn user preferences for a state of a device based at least in part on: time of day, weather conditions, and/or interior environmental conditions (e.g., lighting level, temperature, humidity, etc.). In some embodiments, a behavioral model may predict (at a future time) user preferences regarding a state of a device for a particular user based at least in part on user input (e.g., user feedback) from the user and/or from other user(s). The other user(s) may be in the same facility as the user and/or at other facilities. In some embodiments, the other facilities are identified as being similar with respect to at least one facility characteristic, which facility is for which the state of the device may be altered. The at least one facility characteristic may include building type and/or room-type. The at least one facility characteristic regarding the room type may include considering (i) whether a room the device is associated with is a shared space or a single-occupancy room, and/or (II) an intended use for the room the device is associated with. The at least one facility characteristic regarding the building type may be with respect to: building shape, building dimensions, building height, building usage, geographical location, and/or geographical facing direction of a facade of the building. In some embodiments, user(s) similar to the user may be identified. The similar user(s) may be similar with respect to at least one user characteristic. The at least one user characteristic may include (i) user role within an organization, (ii) user demographic information, and/or (iii) implicitly learned user preferences. The user preference may include a preference for being warmer or colder (e.g., temperature preference), a preference for lighter or darker rooms (e.g., lux level preference), a preference for more or less glare control, (iv) a preference of a color palette, (v) a preference of a gas (e.g., humidity) level, (vi) a preference towards noise level, (vii) a preference of a noise (e.g., music) type, and/or (viii) a preference towards machine setting (e.g., printer setting, beverage dispenser setting, computer setting, and/or screen setting). The machine may comprise a service machine, a personal machine (e.g., personal computer), or a production (e.g., factory) machine.

In some embodiments, a machine learning model (e.g., a behavioral model) determines an action based at least in part on user input that indicates a preference of a state of a device in a facility. The action may include a different state that the device is to be (a) altered to and/or (b) conditioned to. In some embodiments, the action may include a recommendation and/or suggestion to transition the device to a different state. In some embodiments, a recommendation and/or a suggestion may be presented (A) to a user who provided user input and/or (B) to a different user (e.g., facilities operations manager and/or other administrator). A user input regarding a preference of a state of a device may be associated with a set of conditions. The set of conditions may include timing information (e.g., indicative of a time the user input was received), weather information, and/or sensor data (e.g., from one or more photosensors, from one or more temperature sensors, from one or more occupancy sensors, from one or more motion sensors, from one or more humidity sensors, from one or more gas flow sensors, from one or more VOC sensor, or the like). The sensor data may be received from sensors of a device ensemble enclosed in a housing.

In some embodiments, an action is identified by a machine learning model (e.g., a behavioral model) at least in part by identifying a rule-based pattern (e.g., a heuristic). The rule based pattern may be associated with a set of conditions that matches the set of conditions under which the user input regarding a present state of a device was received. For example, a rule-based pattern may be: <{Conditions}; Device1=State X>, where {Conditions} indicates the set of conditions, and “State X” indicates an action (e.g., a target state of Device1) to be taken with respect to Device1. Examples of target states may include a tint state of a tintable window, an air flow state of an air vent of an HVAC system, a light level of a lighting system component, or the like. One example of a rule-based pattern is: <{Photosensor value=X; Time of day=“morning;” window direction=“east;”}; Window1=″Tint Level 4″>. In some embodiments, a rule-based pattern is identified with a set of conditions matching and/or similar with respect to the set of conditions under which user input was received. Similarity of sets of conditions may be determined based at least in part on a threshold number of conditions within the set of conditions being within a distance (e.g., a Euclidean distance) or range of each other.

In some embodiments, a rule-based pattern for a particular set of conditions is determined based at least in part on user input from one or more users. A rule-based pattern may be established based at least in part on receiving more than a threshold. The threshold may be defined by a number (e.g., more than one, more than five, more than ten, more than fifteen, more than fifty, more than one hundred, etc.) of pieces of user input under the particular set of conditions that indicate a same or similar target state of a device of a facility. The threshold may be a function. The user input may be received to indicate preferences of devices that are different from each other by at least one device characteristic. The user input may be received to indicate preferences of devices that are similar to each other by at least one device characteristic. For example, the devices may be of the same type (e.g., the devices are tintable windows, the devices are tintable windows having particular properties or characteristics, the devices are a particular HVAC component, the devices are a particular communication system component, or the like). The devices may differ in their location (e.g., location in the facility or location in different facilities). In some embodiments, user input may be obtained from users associated with the same facility and/or users associated with different facilities.

In some embodiments, whether a state of a device is altered due to user input indicating a user preference regarding a present state of the device, is based at least in part on a permission scheme for the user. For example, in an instance in which the user input indicates a user preference to override a present state of a device to a different state, and in which the permission scheme indicates that the user may alter the state of the device, the device may be transitioned to the user-requested state. For example, in an instance in which the user input indicates a user preference to override a present state of a device to a different state, and in which the permission scheme indicates that the user is not permitted to alter the state of the device, the user preference may not be acted on and the device may not be transitioned to the user-requested state. In some embodiments, user input is logged (e.g., in a database) and/or otherwise considered by a machine learning model depending on the permission scheme concerning the user. For example, in instances in which the user input is not acted on, the user input may not be logged and/or otherwise considered by the machine learning model. For example, in instances in which the user input is acted on, the user input may be logged and/or otherwise considered by the machine learning model. In some embodiments, user input is logged (e.g., in a database) and/or otherwise considered by a machine learning model regardless of the permission scheme concerning the user. For example, in instances in which the user input is not acted on, the user input may still be logged and/or otherwise considered by the machine learning model.

In some embodiments, a behavioral model is trained based at least in part on user feedback. The user feedback may indicate user-preferred states of controllable devices of a facility under particular sets of conditions. The behavioral model may be used to predict the user-preferred states of the controllable devices by learning from the user feedback. The user feedback may include override commands to override a present state of a controllable device, direct feedback that indicates a requested state of a controllable device, and/or indirect feedback that indicates a directional change of a controllable device or a directional change of an environment in which the controllable device is disposed. An example of an override is a request to change a tint state of one or more tintable windows from a present tint state to a different tint state. An example of direct feedback is a request to change a tint state of one or more tintable windows to a particular tint level (e.g., “Level 4,” “Level 3,” etc.). Direct feedback may be actionable or non-actionable. For example, in an instance in which a user does not have permission to change a present state of a controllable device, the feedback is not actionable. An example of indirect feedback is “the room is too bright,” “the room is too hot,” etc. Indirect feedback may actionable or non-actionable. For example, in an instance in which a user does have permission to change a present state of a controllable device, the feedback is actionable.

In some embodiments, in instances in which indirect feedback is actionable, a target controllable device and/or a target state of the target controllable device, may be identified based at least in part on the indirect feedback. In one example, in an instance in which the indirect feedback is that a room is too hot, (I) a target controllable device of one or more tintable windows disposed in the room may be identified, and the target state of the one or more tintable windows may be identified as a tint level darker than a present tint level, and/or (II) a target controllable device of an HVAC system component disposed in the room may be identified, and the target state of the HVAC system component may be identified as a having a lower temperature threshold setting than the present temperature threshold setting.

In some embodiments, a behavioral model is trained based at least in part on user feedback by constructing training samples based on (e.g., historic) user feedback and providing the training samples to the behavioral model. Training samples may be constructed (e.g., separately or cumulatively) for actionable feedback and/or for non-actionable feedback. The behavioral model may be trained based on user feedback from users of one facility and/or from users of various facilities. The various facilities may have at least one facility characteristic in common (e.g., located in the same local (e.g., same state, county, or country), are single family homes, are multi-family homes, are skyscrapers, are office building, and/or server the same purpose).

In some embodiments, a behavioral model is trained at times of low-occupancy of a facility (e.g., overnight, at holiday, and/or at a facility closure time). In some embodiments, a behavioral model may be trained in response to (I) an event such as a calendared event, and/or (II) meeting or exceeding a threshold number of received user feedback. The calendar event may comprise: a change to a new month, a change to a new season, a change to a new year, a change of a quarter, or the like. The feedback may include a direct user feedback such as overrides and/or an indirect user feedback.

In some embodiments, a projected tint state is determined by one or more models. In some embodiments the (e.g., proposed or acted upon) projection is overridden by user input(s) indicative of user preference(s). In some embodiments, user input(s) that cause override(s) of tint state(s) can be included as training sample(s) for a behavioral model(s) predicting user preference(s). In some embodiments, the behavioral model(s) can predict tint state overrides based at least in part on user input(s) and/or user feedback(s) (e.g., user input indicative of override(s) of tint states from one or more users, user feedback regarding a state pf a device such as tint state of a timetable window, lighting conditions, temperature, gas concentration, or the like. In some embodiments, logic (e.g., as implemented by a control system) can utilize weather information, facility information (e.g., a facility layout, a 3D model of a facility, or the like) in connection with a behavioral model predicting user preferences.

In some embodiments, behavioral model determines actions and/or recommendations of actions to be taken. An action may include an override of a tint state determined based on weather models, facility (e.g., building) models, tint schedules, or the like. An override of a tint state may be a one-time override that is applied at a present time or an automatic override that is applied in response to detection of a particular set of conditions. A recommendation of an action may include a recommendation to implement a particular override of a tint state. A recommendation may be presented to a user who has direct control of a window. A recommendation may be presented to a facility (e.g., building) operations manager, e.g., who has direct control of a window of a user.

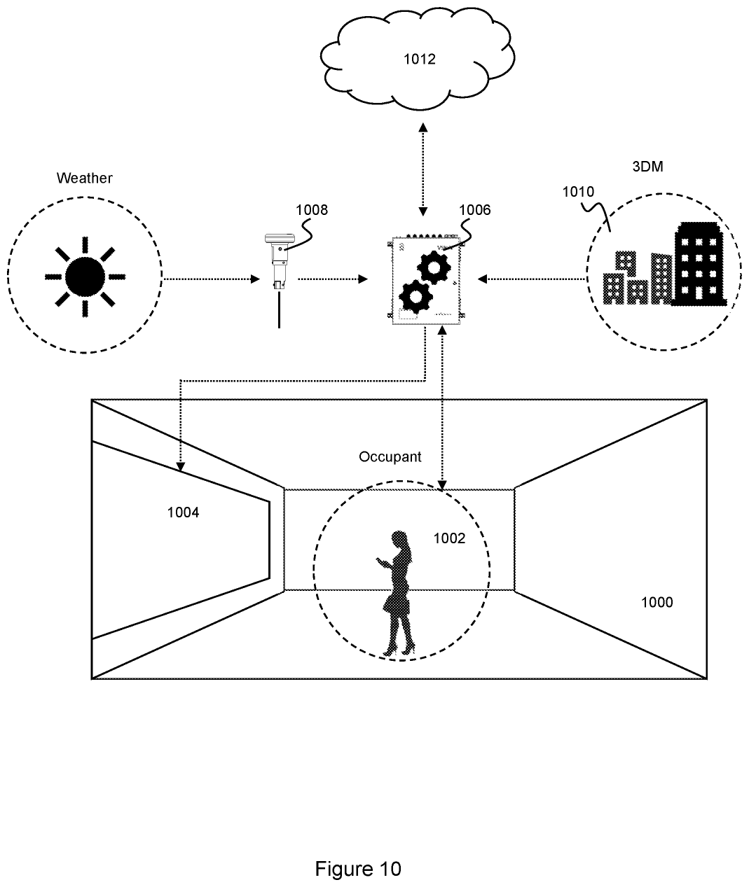

FIG. 10 shows a schematic representation example of interaction between a control system, a behavioral model, and a tintable window in accordance with some embodiments. FIG. 10 shows a room 1000. An occupant 1002 is located in room 1000. Room 1000 includes a tintable window 1004. Tint states of tintable window 1004 are controlled by a control system 1006. Control system 1006 receives inputs from one or more sensors, such as from multi-sensor device 1008. The one or more sensors may include one or more photosensors, one or more infrared sensors, one or more temperature sensors, one or more gas (e.g., humidity and/or CO₂) sensors, one or more air flow sensors, or the like. In some embodiments, multi-sensor device 1008 is positioned external to a building that includes room 1000, for example, to collect sensor data indicative of weather conditions outside and/or external to the building. In some embodiments, multi-sensor device 1008 is positioned internal to the building, for example, to collect sensor data indicative of environmental conditions inside and/or internal to the building. Control system 1006 receives inputs from a building model 1010. In some embodiments, building model 1010 includes a glare model associated with tintable window 1004, a reflection model associated with tintable window 1004, and/or the like. User feedback from occupant 1002 is used to train a behavioral model 1012. The behavioral model may reside in a processor located in the facility or outside of the facility (e.g., in the cloud). The user feedback may be received via an application executing on a user device, such as a user device of the occupant 1002 such as a cellphone, a laptop, or a tablet. Behavioral model 1012 determines actions based at least in part on the user feedback from occupant 1002. The actions may include overrides of device (e.g., tint) states determined by control system 1006. As another example, the actions may include suggestions and/or recommendations of overrides of device (e.g., tint) states determined by control system 1006. In some embodiments, outputs of behavioral model 1012 are provided to control system 1006. The outputs of behavioral model 1012 may be used by control system 1006 to modify or update the device (e.g., tint) states determined by control system 1006, for example, to better align with preferences of users, such as the preferences of occupant 1002.

In some embodiments, a behavioral model is implemented in connection with a prescriptive model that determines states for controllable devices of a facility. A prescriptive model (or model set) may determine target tint states for tintable windows. The prescriptive model (or model set) may transmit indications of these target tint states to associated controllers (e.g., network controllers and/or window controllers) to cause the target tint states to be achieved. A prescriptive model (or model set) may determine target lighting states for lighting system components of the facility. The prescriptive model (or model set) may transmit indications of these target lighting states to relevant controllers to cause the target lighting states to be achieved. The prescriptive model may be based at least in part on (e.g., raw or processed) sensor values (e.g., values from physical sensors), predicted sensor values (e.g., predicted values for virtual sensors), a facility model, weather information, occupancy information (e.g., occupancy scheme of the facility), and/or scheduling information. In one example, predicted sensor values are used to calculate predicted values associated with virtual sensors, e.g., virtual sensors positioned at locations at which no physical sensor is present. In some embodiments, tint states determined by the prescriptive model are influenced and/or modified by user input. For example, the user input may include user scheduling information that indicates a tint schedule at particular times of day, days of the week, times of the year (e.g., months, seasons, or the like), during particular occupancy levels (e.g., when a room is occupied, or when a room is unoccupied). As another example, the user input may include direct and/or indirect feedback. Direct feedback may include a particular requested target state of a controllable device, such as a particular tint state of a tintable window (e.g., “Tint Level 4,” or the like), a particular lighting level of a lighting device, or the like. Indirect feedback may include a requested directional change of a state of a controllable device, such as that a tintable window is to be made darker or lighter, that a lighting device is to be made brighter or less bright, etc. The direct feedback and/or the indirect feedback may be used to train a behavioral model. The behavioral model can be used to generate predicted user preferences for controllable devices. The predicted user preferences may be provided as actions, such as a recommendation to implement an override of a device state determined based on a prescriptive model, or automatically implementing an override in accordance with the predicted user preferences. The behavioral model may be used to override states determined based at least in part on a prescriptive model and/or scheduling information.

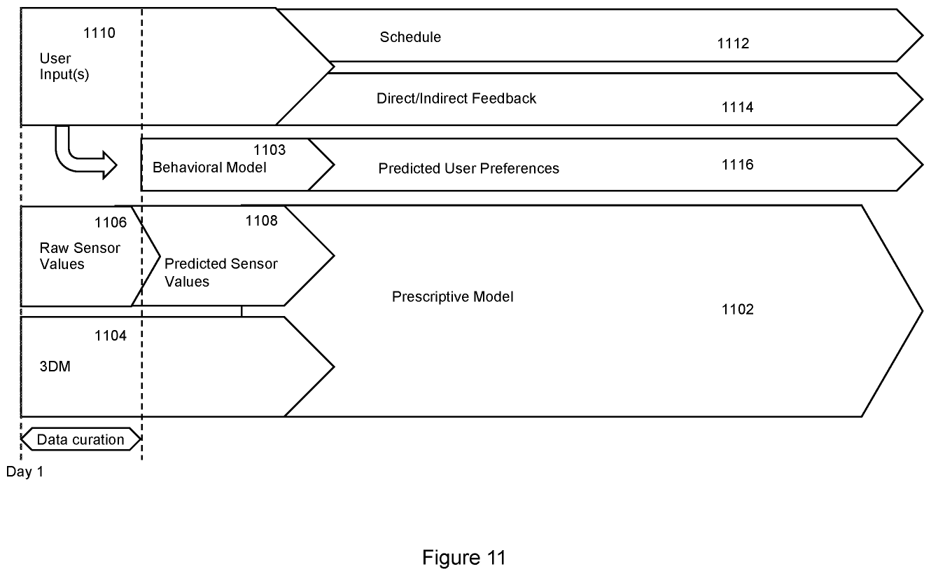

FIG. 11 is a diagram representing an example of interaction between a prescriptive model 1102, a behavioral model 1103, and user input(s) 1110. As illustrated, prescriptive model 1102 is based at least in part on a 3D facility (e.g., building) model (denoted in FIG. 11 as “3DM”), raw sensor values 1106, and predicted sensor values 1108. In some embodiments, predicted sensor values 1108 correspond to predicted values of virtual sensors. Virtual sensors may be at positions where no physical sensor exists, such as between two physical sensors, adjacent to a physical sensor, or the like. User input(s) 1110 may include schedule information 1112 and/or direct and/or indirect feedback 1114. In some embodiments, user input(s) 1110 are obtained via a user interface, such as a user interface that allows a user to enter schedule-based rules, a user interface that allows a user to provide direct feedback (e.g., an override request to alter a tint state determined based at least in part on prescriptive model 1102, an override request to alter a state of a (e.g., lighting) device determined based at least in part on prescriptive model 1102), and/or a user interface that allows a user to provide feedback regarding a present (e.g., tint) state of the device. In some embodiments, such a user interface is presented via an application, such as an application executing on a user device of a user, a user device mounted on a wall associated with the facility (e.g., building). As illustrated, user input(s) 1110 are used to train behavioral model 1103. Behavioral model 1103 may obtain user input data for a period of time over which user input data is curated prior to generating predicted user preferences 1116. The predicted user preferences 1116 may include recommendations to implement particular tint state overrides relative to what is determined by prescriptive model 1102 and/or schedule information 1112.

In some embodiments, a first behavioral model is trained for a facility (e.g., a building). In some embodiments, a second behavioral model is trained based at least in part (i) on the first behavioral model and/or (ii) on user feedback from other facilities. The second behavioral model may incorporate user feedback from multiple facilities similar to the facility and/or facility(ies) associated with the first behavioral model. In some embodiments, the facilities may be similar in at least one facility characteristics (e.g., as disclosed herein. The at least one facility characteristics may comprise: (I) a geographic location (e.g., latitude, longitude, country, city, state, or the like), (II) a type of building or facility and/or client vertical (e.g., commercial, residential, offices, industrial, or the like), or (III) an architectural characteristic(s) (e.g., number of floors, geographic direction the building or facility faces, window type and/or window size, or the like). By allowing a behavioral model associated with a particular facility to be trained based at least in part on user feedback associated with other (e.g., similar) facilities, a more robust behavioral model can be trained. The more robust behavioral model may account for expressed preferences of occupants of the building. The more robust behavioral model may account for preferences of occupants of similar facilities.

In some embodiments, a first behavioral model for a facility is stored and/or trained on an on-premises device (e.g., a server) associated with the facility. The first behavioral model may be stored and/or trained on a remote device (e.g., a server, a cloud device, etc.) remote from the facility. The first behavioral model may communicate data (e.g., transmit data to and/or receive data) from a second behavioral model that incorporates data from a plurality of facilities. For example, the first behavioral model may transmit a subset of user feedback data to the second behavioral model. For example, the second behavioral model may transmit parameters associated with trained weights for incorporation into the first behavioral model, e.g., thereby allowing the first behavioral model to benefit from the larger training set used by the second behavioral model. In some embodiments, the second training model is stored on a remote device (e.g., a server, a cloud-device, etc.). The remote device may be the same or different than a remote device associated with the first behavioral model.

In some embodiments, a behavioral model provides actionable information. The actionable information may be provided to an occupant of a facility, to a facility operations manager, to an entity that develops prescriptive models for device (e.g., smart window) control, or the like. In one example, a first behavioral model associated with a facility may provide information to (i) an occupant of a facility, (ii) a building operations manager, and/or (iii) a customer services manager. The information provided may be indicative of user feedback of occupants of the facility. The actionable information may aggregate user feedback across occupants of the facility, or portions of the facility (e.g., various zones of the facility). In some embodiments, the actionable information may specify a particular enclosure (e.g., room) of the facility, a particular region (e.g., floor) of the facility. An example of actionable information is “72% of occupants of Conference Room 1 prefer a darker tint level in the afternoon.” In some embodiments, actionable information may be presented to a such that an override of tint states (e.g., determined based at least in part on scheduling information and/or a prescriptive model), is implemented. For example, actionable information may be presented in connection with a user prompt that, when selected, causes a particular override to occur. In one example, actionable information of “72% of occupants of Conference Room 1 prefer a dark tint level in the afternoon” may be presented with a user prompt of “Would you like to implement an override from Tint Level 3 to Tint Level 4 at 2 p.m.?” In another example, a second behavioral model that incorporates user feedback from multiple buildings and/or facilities may provide information to a building operations manager and/or a customer services manager that indicates preferences of occupants of particular types of buildings (e.g., occupants of shared workplaces, occupants of conference rooms with floor-to-ceiling windows, or the like), occupants at particular times and/or geographic locations (e.g., occupants in northern hemisphere buildings in the summer, occupants of east-facing rooms in the morning, or the like), and/or any suitable combination. The actionable information may aggregate user feedback from users of buildings or facilities determined to be similar. An example of actionable information is “78% of users in similar buildings prefer a darker tint level in the morning.” Preferences and/or settings (e.g., scheduling information, a default state of a device, etc.) may be updated based on a response to the user prompt and/or based on a response to the actionable information. Preferences and/or settings may be updated in connection with a single controllable device and/or a group of related controllable devices (e.g., a group of tintable windows in a particular zone or region of a building, a group of lighting devices in a particular zone or region of a building, etc.).

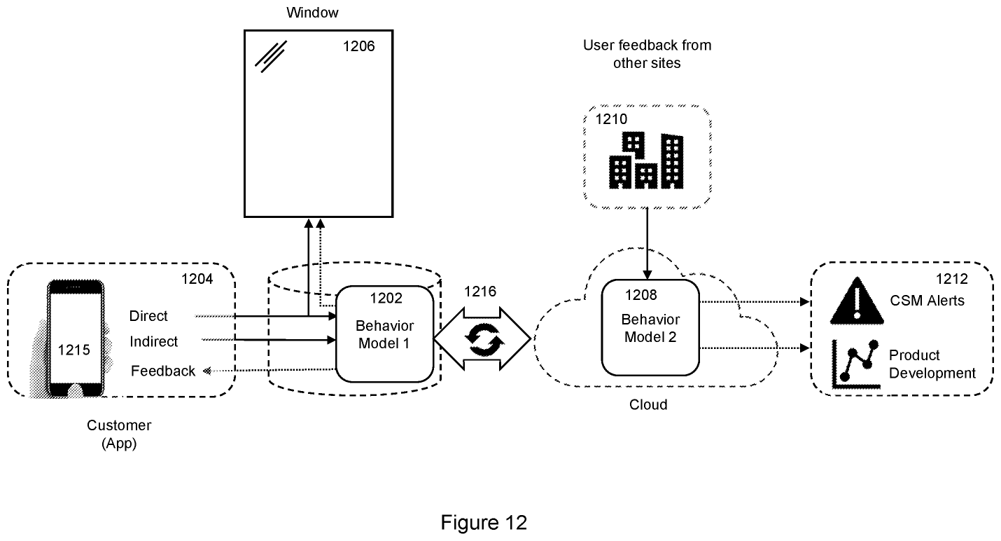

FIG. 12 shows a schematic example representation of interaction between behavioral models in accordance with some embodiments. As illustrated, a first behavioral model 1202 associated with a facility receives user feedback 1204. The user feedback may be relevant to a present device state of a device such that in this example a tint setting of a tintable window 1206. The user feedback 1204 may be direct feedback and/or indirect feedback. The direct feedback may correspond to explicit user overrides of tint settings. The indirect feedback may be indicating that a particular setting is, or is not, aligned with user preferences, such as that a tint setting is too light or too dark. In some embodiments, the user feedback 1204 is obtained via an application, such as an application that executes on a user device that in this example is mobile phone 1215. First behavioral model 1202 is trained based at least in part on user feedback 1204, which may include user feedback from one user or multiple (e.g., at least about five, ten, twenty, one hundred, one thousand, or ten thousand) users. First behavioral model 1202 is operatively (e.g., communicatively) coupled with a second behavioral model 1208 in communication pathway 1216. First behavioral model 1202 and second behavioral model 1208 can exchange data, and/or parameters (e.g., weights) associated with each behavioral model. Second behavioral model 1208 is trained based at least in part on user feedback 1210 from other facilities. The other facilities may be similar to the building and/or facility associated with first behavioral model 1204 based on any suitable criteria, combination of criteria and/or characteristic(s) (e.g., as disclosed herein). Second behavioral model 1208 communicates actionable information 1212 (e.g., recommendations for overridden tint states), for example, to facility manager, customer service managers, entities associated with training prescriptive models and/or behavioral models, or any other authorized personnel. In some embodiments, first behavioral model 1202 is trained based at least in part on information from second behavioral model 1208. For example, first behavioral model 1202 may be trained using transfer learning techniques to incorporate learned parameters from second behavioral model 1208.

In some embodiments, user feedback is obtained from explicitly provided user preferences related to a present tint setting of a tintable window. In some embodiments, the user feedback is a direct feedback. In some embodiments, direct feedback may be an indication of an override to a particular tint level. In some embodiments, the user feedback is an indirect feedback. Indirect feedback may be an indication of a user preference relative to a present tint setting (e.g., a user preference for a little darker than the present tint setting, a user preference for much darker than the present tint setting, a user preference for a little lighter than the present tint setting, a user preference for much lighter than the present tint setting, or the like). In some embodiments, feedback may be obtained regardless of whether a user has permission to implement an override. For example, in some embodiments, feedback may be obtained in instances in which a user may be permitted to implement an override but in which a user may not be familiar with tint levels. In some embodiments, feedback may be obtained in instances in which a user does not have permission to implement an override. In some embodiments, feedback may be converted to a target state of the controllable device based at least in part on a result of altering a present state of the controllable device in a direction indicated in the feedback. The feedback may be direct or indirect feedback.

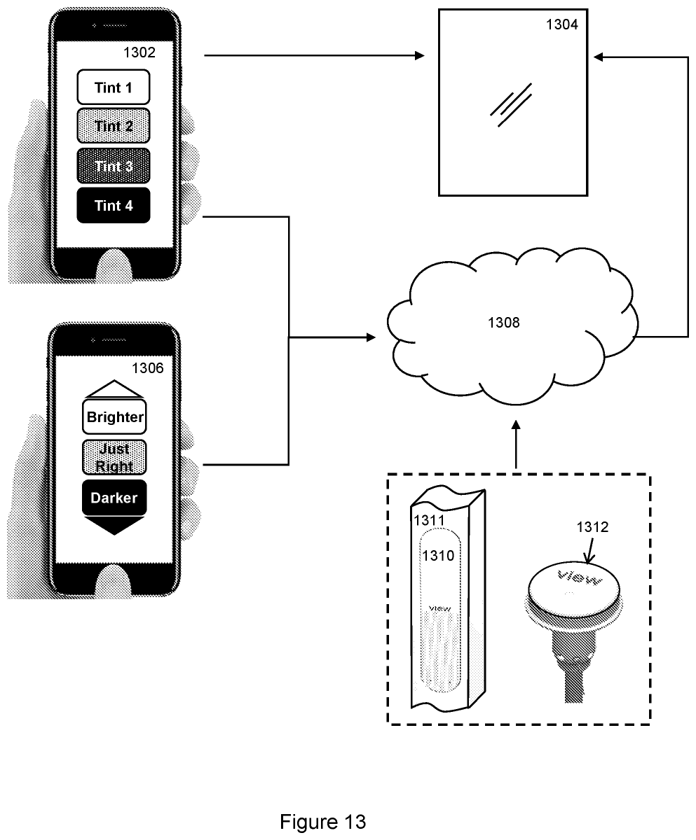

FIG. 13 represents an example of obtained user feedback usage, in accordance with some embodiments. User interface 1302 is used to obtain direct feedback indicating a specific tint level to which a tint state of a tintable window 1304 is to be overridden. As illustrated, user interface 1302 includes multiple selectable inputs, each corresponding to a different tint level. The specific tint level can be selected by a user from the available tint levels, that in the example of FIG. 13 constitute four tint levels listed from lightest to darkest tint: tint 1, tint 2, tint 3, and tint 4. In some embodiments, selection of a particular selectable input (e.g., “tint 4”) may cause tintable window 1304 to transition to the tint state corresponding to the selected input of user interface 1302. User interface 1306 is used to obtain indirect feedback regarding the tint state of tintable window 1304. As illustrated, user interface 1306 includes selectable inputs each corresponding to a level of relative satisfaction of the user with the present tint state of tintable window 1304. For example, user interface 1306 includes selectable inputs corresponding to “brighter” (e.g., indicating a user preference for tinting the window to a relatively brighter tint as compared with the current tint presented by window 1304), “darker” (e.g., indicating a user preference for tinting the window to a relatively darker tint as compared with the current tint presented by window 1304), and “just right” (e.g., indicating that the present tint state of window 1304 is acceptable to the user). In instances in which a user of user interface 1306 has permission to effect an override of the tint state of tintable window 1304, selection of a selectable input of user interface 1306 causes the present tint state to be overridden based on the input selected. In some embodiments, a corresponding tint level is calculated prior to effecting the override. For example, in an instance in which a present tint level is 3, and in which “darker” is selected in user interface 1306, a new darker tint level (e.g., tint level 4) is determined, and an override to darker tint level (e.g., tint level 4) is affected. In instances in which a user of user interface does not have permission to effect an override of the tint state of tintable window 1304, no action is performed based on input received via user interface 1306. In instances in which a user of user interface 1302 has permission to effect an override of the tint state of tintable window 1304, selection of a selectable input of user interface 1302 causes the present tint state to be overridden based on the input selected. In some embodiments, a corresponding tint level is calculated prior to effecting the override. For example, in an instance in which a present tint level is 3, and in which tint 2 is selected in user interface 1302, a new tint level of tint 2 is determined, and an override to tint level 2 is affected. In instances in which a user of user interface does not have permission to effect an override of the tint state of tintable window 1304, no action is performed based on input received via user interface 1302. The tintable window may be adjusted to discrete tint level (e.g., four tint levels), or to continuous tint levels. The discrete tint levels may be at least 2, 3, 4, 5, 8, 10, 15, or 20 discrete tint levels.

In some embodiments, user a user (such as 1302 or 1306) is provided to an occupant of a building based at least in part on permissions associated with the occupant. For example, in an instance in which the occupant is not permitted to override a tint state of the device (e.g., state of tintable window 1304), the user interface may be provided, and data obtained from user interface may be used to train a behavioral model without implementing an action based on the data obtained from the user interface. In one example, user interface (e.g., 1306) may be provided to occupants of a shared work area (e.g., a co-working space or conference room) to allow the occupants to provide feedback on tint levels without any particular feedback altering the tint levels in the shared work area. As another example, in an instance in which the occupant is permitted to override a tint state of a tintable window 1304, and in which the occupant is familiar with meanings of various tint levels, user interface 1302 may be provided to the occupant to allow the occupant to have direct control over tintable window 1304. The occupant may be able to select between (i) a relative user interface (e.g., 1306) and (ii) a discrete user interface (e.g., 1302).

FIG. 13 shows an example in which data obtained via the user interface (e.g., 1302 and/or 1306) is provided to a behavioral model 1308. The behavioral can be processed locally in the facility in which the device to be adjusted is disposed, or external to the facility (e.g., in the cloud)). Behavioral model 1308 may obtain data from one or more users, e.g., at least one, two, five, ten, twenty, one hundred, one thousand, or ten thousand users. In some embodiments, behavioral model 1308 obtains data from one or more sensors 1310, such as from one or more device ensembles such as a multi-sensor device. Examples for multi-sensor devices is a sky sensor 1312. Examples for a device ensemble enclosed in a housing is 1310 disposed in framing portion 1311.

In some embodiments, data is obtained to train a behavioral model based on user responses to recommendations provided by the behavioral model. For example, in some embodiments, a recommendation to effect an override of a controllable device is provided to an occupant of an enclosure (e.g., a room), and data is obtained based at least in part on a user response to the recommendation. In some embodiments, the recommendation may be based at least in part on overrides effected by other occupants, for example, in similar enclosures (e.g., rooms) or facilities (e.g., buildings), at similar times of day, under similar conditions, or the like. In one example, a recommendation may be based at least in part on a determination that a current set of conditions associated with a controllable device matches a rule identified by the behavioral model for the set of conditions. In one example, a recommendation is “67% of occupants have preferred a darker tint state under similar conditions, would you like to implement that now?” In another example, a recommendation is “74% of occupants have preferred a brighter light from the overhead light under similar conditions, would you like to implement that now?” In some embodiments, a response to the recommendation may be used as additional training data for the behavioral model.

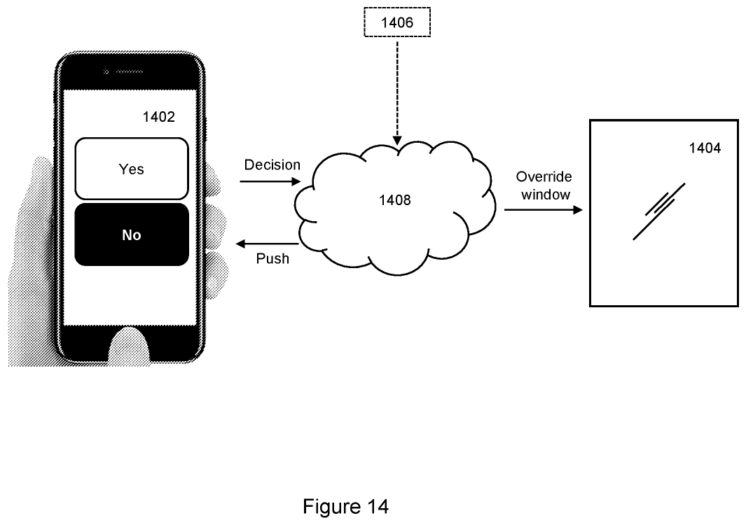

FIG. 14 shows an example of a user interface that can be used for obtaining responses to recommendations in accordance with some embodiments. As illustrated, a behavioral model 1408 causes a recommendation to be presented via a user interface 1402. User interface 1402 may include a recommendation such as “67% of occupants have preferred a darker tint state under similar conditions, would you like to do so now?” A response to the recommendation is obtained via user interface 1402. In some embodiments, the response is used to override a present tint state of a tintable window 1404. In some embodiments, behavioral model 1408 receives sensor data from one or more sensors (e.g., from a device ensemble such as a multi-sensor device). The behavioral model 1408 may optionally obtain input data 1406 from one or more other facilities, such as facility(ies) determined to be similar in at least one facility characteristic to a facility associated with tintable window 1404. In some embodiments, the data obtained by behavioral model 1408 is data indicative of override actions by occupants of the multiple other buildings and/or facilities. In some embodiments, the data is clustered based at least in part on building and/or facility characteristics. Inputs 1406 may be provided as (e.g., real-time and/or historic) sensor data, (e.g., clustered) override data, (e.g., clustered) input data from other users, predictions, or any combination thereof. The data may be raw or processed. The user response is provided to behavioral model 1408 as additional training data. The example delineated in FIG. 14 uses a controllable device that is tintable window 1404, however, the same example may be applicable to any other controllable device having various controllable states.

In some embodiments, one or more user interfaces are presented and provide information to a user regarding an environment of the user. For example, a user interface may be presented and indicate (i) a present tint status of one or more windows in the environment of the user, (ii) a next scheduled action, or (iii) an explanation of an in-progress action. The environment of the user may be in an enclosure comprising (a) a room the user is presently located in, (b) a room associated with the user's office, or (c) a train car in which the user is disposed. The next scheduled action may comprise a next scheduled tint transition, or any other next scheduled change of controllable state of a controllable device. The explanation of an in-progress action may comprise a description of the action that is occurring, the action that is scheduled to occur, a reason for the action, and/or a scheduling of the action. In one example, a user interface may present a graphical representation (e.g., a map such as a simplified map) of the user's environment. The graphical representation may include indications of one or more windows within the user's enclosure environment and/or indications of other controllable devices within the user's environment (e.g., positions of lighting devices, air flow vents, etc.). The indications of the one or more devices (e.g., tintable windows) may include indications of current and/or future controllable (e.g., tint) states. The indicators may comprise a representation of a particular device may act in a manner that indicates a current controllable state of the device, a representation of a particular controllable device may be highlighted to indicate that the controllable device is soon to begin a transition to a future state. For example, the indicators may comprise a representation of a particular window may be shaded in a manner that indicates a current tint state, a representation of a particular window may be highlighted to indicate that the window is soon to begin a transition to a future state, or the like. The user interface may present an explanation of an in-progress action. For example, that the window is darkening to control glare, that the window is lightening to allow for warming from the sun, that the window is darkening to reduce a need for air conditioning, or the like. An indication of an in-progress action may be presented in connection with an estimation of a remaining time to complete the in-progress action (e.g., 8 minutes remaining, 10 minutes remaining, 12 minutes remaining, or the like). A user interface may present an indication of a next scheduled action associated with the controllable device. The indication of the next scheduled action may be presented in connection with other relevant information, such as (i) a time of the scheduled action, and/or (ii) a reason for the scheduled action. For example, the reason for the scheduled action may be that the window is lightening to maximize daylight, that the window is darkening to reduce a need for air conditioning, or the like. An indication of a scheduled action may be presented in connection with an indication of a user who scheduled the action. For example, that the user viewing the user interface scheduled the action, that the action was scheduled by a facility operations manager and/or other facilities manager, or the like.

In some embodiments, a user interface that presents information relating to health information of the user with respect to the user's environment is presented. In one example, a user interface may be presented which indicates a total daylight exposure of the user (e.g., due to tinting of one or more windows in the environment). A user interface may be presented which indicates a circadian stimulus (e.g., as a percentage value) associated with the environment. For example, due to tinting of the one or more windows and/or based at least in part on sun exposure times. A user interface may be presented which indicates information based at least in part on one or more sensors positioned within the environment of the user. For example, one or more airflow sensors, one or more VOC sensors that indicate an air quality associated with the environment, and/or the like. A user interface may be presented which indicates one or more recommendations to modify the environment. Examples of such recommendations may include (a) a recommendation to modify a tint schedule associated with one or more windows, and/or (b) a recommendation to go for a walk at a particular time (e.g., to get fresh air). The tint schedule may be modified to improve (i) a daylight exposure amount, and/or (ii) a circadian stimulus amount.

In some embodiments, a user interface presents weather information. Examples of weather information may include current and/or predicted (1) temperature(s) (e.g., a high temperature, a low temperature, or the like), (2) precipitation, (3) cloud cover, (4) solar intensity, (5) humidity levels, and/or (6) any other weather related information. In some embodiments, weather information may be obtained from one or more third-party weather services, based at least in part on data from one or more sensors, based at least in part on an output of one or more machine learning models, or any combination thereof. In some embodiments, the one or more sensors may be disposed (e.g., mounted) external to a facility the user is in. In some embodiments, the one or more sensors may be disposed (e.g., mounted) internally to a facility the user is in.

In some embodiments, a user interface presents an impact of sun conditions on sunlight exposure with respect to one or more windows. The user interface may indicate (e.g., based at least in part on a geographical facing direction of a window) a time range during which the sun is predicted to impinge on the window. The time range may be determined based at least in part on a current time of year and/or day of the year. A user interface may indicate, at a particular time of day and/or time of year, a sun penetration depth with respect to a particular window (e.g., 8 feet, 10 feet, or the like). A user interface may include one or more user interface controls that allow a user to enter and/or provide a particular time of day such that the user interface is updated to show the impact of the sun conditions at the user-entered time of day. Examples of such user interface controls include sliders, drop-down menus, or the like.

In some embodiments, a user interface that provides information relating to an environment of a user is presented via an application. The application may execute on a user device, such as a mobile device of the user (e.g., a mobile phone, a tablet computer, a laptop computer, or the like), or any other device of the user configured to operate the application (also abbreviated herein as “app”). The application may execute on a shared user device, such as a user device mounted to or otherwise attached to a wall of a building, a user device associated with a shared space (e.g., a conference room, a garden area, etc.), or the like. An app may receive information (e.g., ongoing and/or future window tint transitions, heath information associated with a user, weather information, information related to an impact of sun conditions with respect to one or more windows, etc.) from a control system associated with a facility, from a remote server, from a remote cloud service, and/or any other suitable device. In instances in which a user interface presents information based at least in part on a location of a user within a facility, the location of the user may be determined based at least in part on geolocation technology(ies) (e.g., using UWB tags, using RF and/or WiFi sensing, or the like) that identify a location of the user and/or identify one or more controllable devices within proximity to the identified location of the user.

In some embodiment, the app presents to the user forecasted (e.g., simulated) setting of the controllable device. The setting may be controllable. The simulation may utilize any artificial intelligence methodology (e.g., as disclose herein, such as incorporated in a learning module). The forecasted setting may be a setting that would be (e.g., automatically) chosen for the device by the control system. The forecasted setting may reflect the default settings of the control system. For example, the app may present a forecasted tint of the tintable window, forecasted temperature for the HVAC system, a forecasted media presented by the media device, a forecasted lighting for the lighting system, a forecasted smell expelled by the smell conditioning system, a forecasted music to be played by the sound system, a forecasted humidity forecasted to be adjusted by the humidity control system, or any combination thereof. The forecasted setting may be a setting that would be in the facility without an intervention of the control system (i.e., if the facility is left without intervention of any controlled action). The forecasted setting may comprise an environmental setting of the facility. The forecasted setting may comprise a setting of a device in the facility. A suer may be able to select which type of forecast the user is interested in viewing (e.g., using the app). For example, the app may present a choice between forecasted environmental setting with intervention of the control system, or without intervention of the control setting. The user may be able to approve intervention of the control system, set another target value for a device setting controlled by the control system (e.g., while overriding the control system's automatic decisions), or disable adjusting the device using the control system. The control system may or may not act on the action of the user, depending on the user's permission grade and/or schedule.

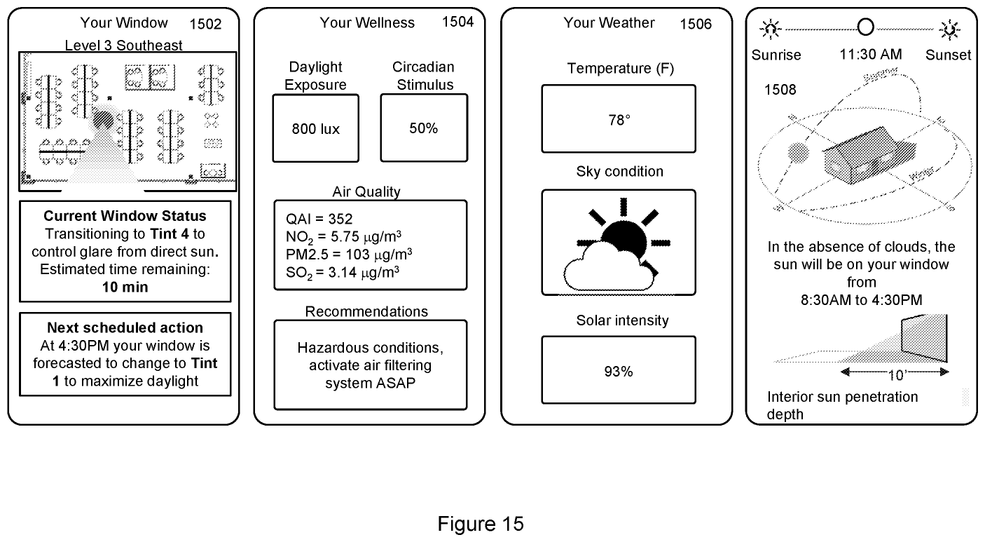

FIG. 15 shows examples of user interfaces that present information to a user by an app. User interface 1502 indicates window tint state information, such as current tint states of one or more windows in an environment of a user, an indication of an in-progress tint transition, and/or an indication of a next scheduled action. User interface 1504 indicates heath information associated with a user with respect to the environment of the user, such as an amount of daylight exposure, a circadian stimulus amount, and information associated with air quality (e.g., Quality of Air Index (QAI), nitrogen dioxide, particulate matter having an average FLS of 2.5 micrometers, and sulfur dioxide levels (e.g., in micrograms per cubic meter)). User interface 1504 also incorporates recommendation for the user. For example, in the hazardous conditions depicted in the air quality rubric of user interface 1504, the user is advised of the hazardous conditions and is recommended to activate the air filtering system as soon as possible (ASAP). User interface 1506 indicates weather information, such as a present temperature, a present sky condition, and a present solar intensity. User interface 1508 presents information indicative of an impact of sun conditions with respect to one or more windows in the environment of a user.

In some embodiments, one or more user interfaces are presented to obtain user preferences. For example, a user interface may be presented that includes one or more user interface controls for obtaining user preferences regarding an amount of daylight, an amount of glare control, an amount of heat control, a degree to which a window control system is reactive, a preferred sun penetration depth, or any combination thereof. the user preferences may be used to set target tint levels at different times of day and/or with respect to different sunlight conditions. The degree to which a window control system is reactive can include how quickly the window control system causes tintable windows under control of the (window) control system to transition in response to predictions of one or more machine learning models. For example, a user preference indicating that a relatively higher degree of glare and heat control may cause windows in the environment of the user to be tinted to relatively darker levels, as compared to an instance in which the user preferences indicate that a relatively lower degree of glare and heat control is preferred. In another example, a user preference indicating a preference for relatively higher reactivity may cause one or more windows to begin tint transitions more quickly, as compared to an instance in which a user preference indicates a preference for a relatively lower degree of reactivity. As another example, a user interface may be presented that includes one or more user interface controls for setting thresholds of one or more parameters. Window tint of one or more windows within an environment of the user may be controlled such that values of the one or more parameters are within a range specified by the thresholds. Examples of parameters include (i) preferred light intensity (e.g., in lux), and/or (ii) preferred temperature range. Information indicating preferences (e.g., obtained using a user interface) may be communicated to a controller system for use in control of various devices within the environment. The control system may comprise a master controller, a remote server, a cloud-based device that stores user preferences, or the like.

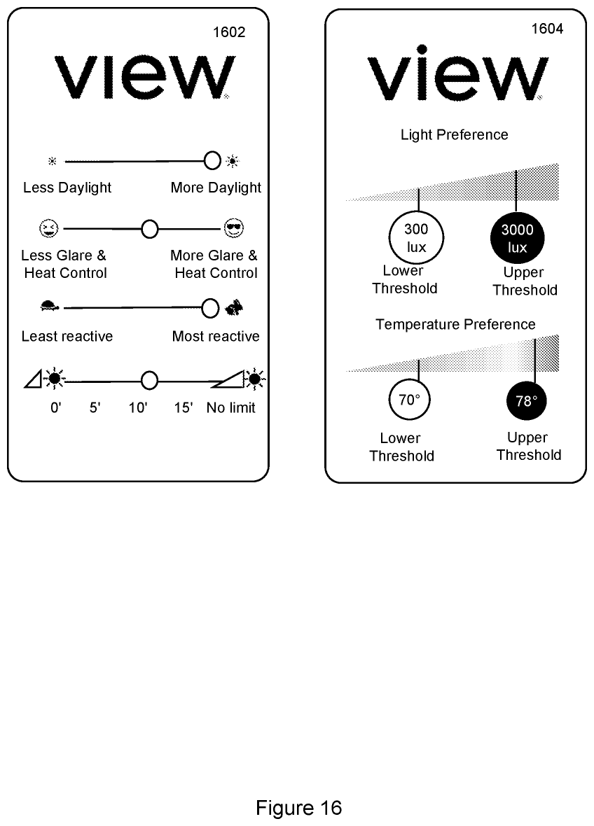

FIG. 16 shows examples of user interfaces for obtaining user preferences regarding parameters associated with at least one controllable device that is at least one tintable window. User interface 1602 is utilized for obtaining user preferences which include a preferred degree of daylight, a preferred degree of glare and/or heat control, a preferred reactiveness of one or more tintable windows, and/or a preferred sun penetration depth. User interface 1604 is utilized for obtaining user preferences that indicate desired ranges of light and/or temperature.

In some embodiments, use of one or more user interfaces (e.g., to provide feedback) is incentivized. For example, in response to providing input via one or more user interfaces, a user who provides the user input may receive credits and/or rewards. Providing input via one or more user interfaces may include: indicating feedback regarding a current state of at least a portion of a facility, and/or to indicate feedback regarding current states of one or more devices associated with the facility. Credits and/or rewards may be provided based at least in part on an amount of user input provided via the one or more user interfaces exceeding a threshold. For example, when user feedback has been provided more than a predetermined number of times (e.g., acting as a predetermined threshold). various types of user feedback may be weighted differently. For example, a first type of user feedback may be counted as associated with X credit, and a second type of user feedback may be counted as associated with Y credit. Amounts of credits and/or rewards may be aggregated across various users, such as users of an organization and/or users at various organizations and/or facilities. The aggregation may be for the purpose of generating a leaderboard such that the multiple users can compete with each other. Credits and/or rewards may be associated with a user account. One or more user interfaces may be presented in connection with the user account such that use of the one or more user interfaces (e.g., to provide user feedback) to achieve credits and/or rewards is associated with the user account. A user account for providing user feedback may be associated with a user profile of a user within an organization.

In some embodiments, user input (e.g., user feedback) is received in connection with a state of a device of a facility. The device may comprise one or more: tintable windows, HVAC components (e.g., air flow vents, heating components, cooling components, or the like), lighting system components, safety system components, elevator system components, entertainment system devices (e.g., media display, speakers, etc.), or the like. the user input is used to predict a state of the device at a future time. The state of the device at the future time may be predicted based at least in part on a machine learning model that considers the user input. The machine learning model may be and/or include one or more machine learning models and/or other computational models, which generate predictive outputs (e.g., a predicted state of a device) based at least in part on input (a). the input may include user input, scheduling information, weather information, sensor input, outputs of other model(s), and/or any combination thereof. The machine learning model may include a behavioral model that predicts user preferences based at least in part on user input from one or more users. The state of the device at the future time may be suggested and/or recommended, e.g., as a suggested override of the state of the device to the predicted state at the future time. For example, the state of the device may be suggested to the user who provided the user input. For example, the state of the device may be suggested to the user (e.g., as an override recommendation) in response to determining that the user has permission to control states of the device. The state of the device may be suggested to a user other than the user who provided the user input (e.g., a facilities manager). The state of the device may be suggested to the other user in response to determining the user who provided the user input does not have permission to control states of the device and/or does not have permission to control states of the device at a present time. The device may be conditioned to the predicted state at the future time (e.g., without requesting further user input).

In some embodiments, user input received in connection with a state of a device of a facility is direct feedback, which may or may not be actionable (e.g., by a control system associated with control of the device). The direct feedback may be a request to alter the state of the device to a different state. Direct feedback may include a request to override a present state of the device to a different state, such as overriding a present tint level of one or more tintable windows to a different tint level, overriding a present air flow status of one or more air vents to a different air flow status (e.g., to change air flow direction, to change an amount of air flow, etc.), overriding a present light level of one or more lighting components to a different light level, or the like. In some embodiments, user input received in connection with a state of a device of a facility is indirect feedback that indicates a user preference. The indirect feedback may or may not be actionable. For example, the indirect feedback may not be actionable because the user who provided the user input does not have permission to effect changes to the state of the device. Examples of indirect feedback include user preferences regarding an environment of the facility and/or the portion of the facility the user is located in, such as “too hot,” “too cold,” “too bright,” or the like.

In some embodiments, a state of a device is altered automatically (e.g., without user input). In some embodiments, the state of the device is altered with, or without, consideration of user preferences. For example, a state of a device may be altered automatically and/or without consideration of user preferences in response to detecting an emergency condition. In one example, one or more tintable windows may be transitioned to a clear state in response to detecting an emergency condition. As another example, a state of a device may be altered automatically and/or without respect to user preferences in response to detection of one or more power conditions (e.g., a condition of a heating and/or cooling system, overall power usage of the facility, or the like). In one example, one or more tintable windows may be tinted to a darker state in response to determining that one or more aid conditioners of a facility are operating above a threshold operation level and/or in response to detecting the overall power usage of the facility is above a threshold level.

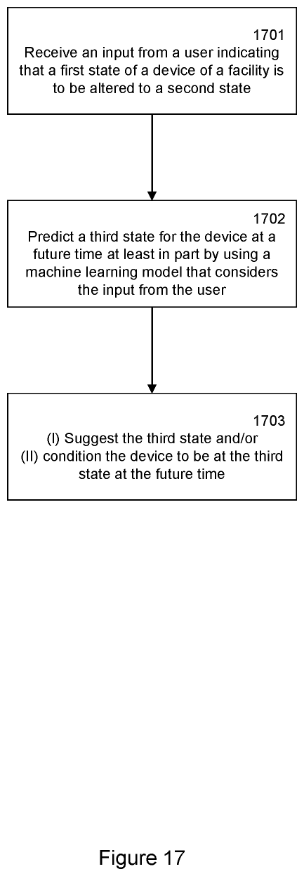

FIG. 17 shows an example flowchart of a method for predicting a state of a device at a future time and performing an action based at least in part on the predicted state of the device. At block 1701, input from a user indicating that a first state of a device of a facility is to be altered to a second state is received. Examples of types of devices include tintable windows, HVAC components, lighting system components, safety system components, elevator system components, communication system devices, entertainment system devices, and/or any other controllable device. The input can be a direct request to change the state of the device from the first state to the second state. The input can be a user preference and/or feedback regarding the first state of the device and/or a preference to alter the first state to the second state. At block 1702, a third state for the device at a future time is predicted based at least in part by using a machine learning model that considers the input from the user. The future time may be one or more future times (e.g., tomorrow at 9 a.m., every weekday at 9 a.m., every weekend between 7 p.m. and midnight, etc.). In some embodiments, considering the input from the user comprises providing the input to a machine learning model (e.g., a behavioral model) that generates the predicted third state of the device at the future time. The machine learning model may consider user input from multiple users, who may be associated with the same facility and/or different one or more facilities. The machine learning model may predict the third state of the device at the future time by identifying a rule-based pattern that matches the input. At block 1703, (I) the third state is suggested and/or (II) the device is conditioned to be at the third state at the future time. In some embodiments, the third state is suggested as a recommendation. A recommendation may be provided to the user who provided the input and/or to another user (e.g., a facilities manager or other administrator). A suggestion may include a suggestion to override the state of the device to the predicted state at the future time and/or at various future times. The suggestion may be presented via a user interface. In some embodiments, the device is conditioned to be in the third state (e.g., automatically and/or without further user input). In some embodiments, the device is conditioned to be in the third state by transmitting instructions to the device to transition to the third state and/or by transmitting instructions to one or more controllers that directly and/or indirectly cause the device to transition to the third state.

In some embodiments, user input received from a user indicative of a preference associated with a present state of a device under a set of conditions is stored in a database. In some embodiments, data stored in the database is used (e.g., by one or more machine learning models, such as a behavioral model) to identify one or more actions associated with the device and the set of conditions. The set of conditions may be based at least in part on user information associated with the user who provided the user input (e.g., an identifier of the user, a role of the user in an organization, etc.), sensor data at the time the user input was provided, timing information associated with a time the user input was provided, geographic information associated with a facility the device is disposed in, building type information associated with the facility the device is disposed in, and/or room type associated with a room the device is associated with. An example set of conditions is: <user=userid; time=morning; photosensor value=X>. Another example set of conditions is: <room=single-occupancy office; building type=office; time=morning>. Any combination of conditions may be used. conditions may be specified as being within a range, such as “low,” “medium,” and/or “high,” “morning,” or the like. In some embodiments, one or more actions are identified and/or associated with the device and the set of conditions. For example, an action may include a target state of the device under the set of conditions. In one example, a target state may include a target tint state of a tintable window, a target air flow level of an air vent, a target light level of a lighting system component, and/or a target state of any other controllable device. In some embodiments, the one or more actions are identified based at least in part on identifying a rule-based pattern for similar devices and/or similar sets of conditions for data stored in the database. The similar devices may be devices of the same type as the device for which the user preference was received. Rule-based patterns may be identified based at least in part on user preferences received from multiple users. The multiple users may be at the same facility and/or at different facilities. The device types may comprise: tintable windows, HVAC components, lighting system components, entertainment system components, or the like (e.g., any device type disclosed herein).

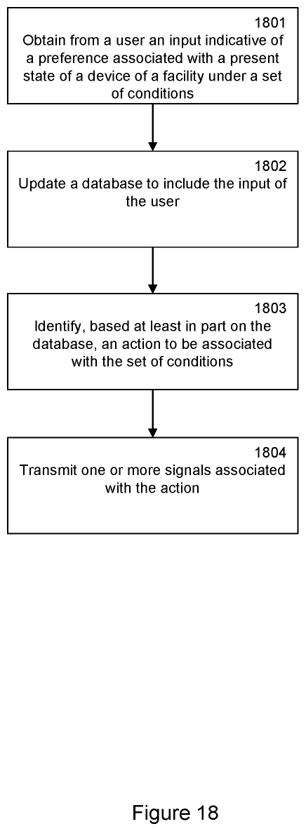

FIG. 18 shows an example flowchart of a method for utilizing user input stored in a database. At block 1801, input is obtained from a user, the input being indicative of a preference associated with a present controllable state of a controllable device of a facility, under a set of conditions. The set of conditions may be based at least in part on user information associated with the user who provided the user input, sensor data at the time the user input was provided, timing information associated with a time the user input was provided, geographic information associated with a facility the device is disposed in, building type information associated with the facility the device is disposed in, and/or room type associated with a room the device is associated with. The user information associated with the user who provided the user input may include (i) an identifier of the user, (ii) a role of the user in an organization, and/or (iii) a (e.g., prescribed) location of the user in the facility. At block 1802, a database is updated to include the input of the user. The database may be updated with an identifier of the device, an identifier of a facility associated with the device, information about the user who provided the input (e.g., a user identifier, a role of the user within an organization, etc.), timing information (e.g., a time the user input was provided), building type information associated with the facility, geographic information associated with the facility, and/or sensor data associated with the set of conditions. At block 1803, an action to be associated with the set of conditions is identified based at least in part on the database. For example, the action may be identified based at least in part on data from one or more users that is stored in the database. The action may be identified by one or more machine learning models, such as a behavioral model that utilizes data stored in the database from one or more users. The action may be identified by identifying a rule-based pattern that matches the set of conditions. The action may include a different state of the device, such as a state the user may prefer under the set of conditions. The action may include a recommendation (e.g., to the user who provided the user and/or a different user) to override the present state of the device to a different state of device, such as a state the user may prefer under the set of conditions. At block 1804, one or more signals associated with the action are transmitted. The one or more signals may cause the device to transition to a different state other than the present state (e.g., to a different state the user may prefer). The one or more signals may cause a suggestion to be presented to a user (e.g., the user who provided the user input and/or a user other than the user who provided the user input) to transition the device to a different state other than the present state (e.g., to a different state the user may prefer).

In some embodiments, a state of a device in a facility is altered based at least in part on user input from a user with respect to permissions associated with the user as indicated in a permission scheme. For example, the user input may be indicative of a preference associated with a state of the device. In one example, the user input may be a request to alter (e.g., override) the state of the device to a different state. In one example, the user input may be an indirect user preference related to the device, such as a preference related to a current environment of the portion of the facility the user is in. Examples of indirect user preferences include “too hot,” “too bright,” “too cold,” or the like.

In some embodiments, whether a user has permission to effect a change to the state of the device is governed by a permission scheme. The permission scheme may be based at least in part on: (A) an organization hierarchy (e.g., a role of a user within an employment hierarchy of the organization); (B) (i) a room-type and/or (ii) building-type associated (a) with the device and/or (b) with the facility (e.g., whether the room associated with the device is a shared space or a single-occupancy room, (C) whether the building-type is an office building, (D) commercial space, industrial space, etc., or the like); (E) a geographic location of the user relative to the device (e.g., whether the user is at the facility at the time the user input is received, whether the user is proximate to the device at the time the user input is received, etc.); (F) safety considerations (e.g., whether allowing the user to alter the state of the device would trigger a safety hazard); (G) jurisdictional considerations (e.g., whether allowing the user to alter the state of the device would violate any rules and/or regulations); and/or (H) energy-savings considerations (e.g., whether allowing the user to alter the state of the device would violate energy-savings goals or thresholds associated with the facility). The permission scheme may vary over time. For example, a user may have permission to alter the state of the device at a first time and/or under a first set of conditions (e.g., on weekends, between the hours of 9 a.m. and 5 p.m., when the user is the only occupant of the room, etc.), and may not have permission to alter the state of the device at a second time and/or under a second set of conditions (e.g., on weekdays, between the hours of 6 p.m. and 8 a.m., when there are other occupants in the room, during particular calendar months, etc.). The permission scheme may specify different permissions for different types of devices. For example, devices associated with security of the facility (e.g., media devices that access external and/or remote computers, external facing doors and/or windows, etc.) may have different permissions than devices not associated with security of the facility. In one example, a user having a role of network administrator or system administrator may be permitted to alter a state of a device having security implications, whereas a user having a different role may not be permitted to alter the state of a device having security implications. The permission scheme may include a voting consideration (e.g., voting scheme). For example, the user may have permission to alter the state of the device responsive to a majority of other occupants of the room to concur with the preference of the user. Voting by multiple users may be conducted via an application associated with control of the device.

In some embodiments, a user input indicative of a preference associated with a state of a device of a facility is considered in connection with a permission scheme to determine whether the state of the device is to be altered. For example, a positive determination or a negative determination is made based at least in part on the permission scheme and/or the user input, where a positive determination indicates that the state of the device is to be altered, and/or where a negative determination indicates that the state of the device is not to be altered. In some embodiments, a positive determination is made in response to determining that (i) the user input indicates that the state of the device is to be altered (e.g., because the present state of the device is not in accordance with the user's preferences) and (ii) the user has permission to alter the state of the device based at least in part on the permission scheme. A negative determination is made in response to determining that (I) the user input indicates that the state of the device is not to be altered (e.g., because the present state of the device is in accordance with the user's preferences) or (II) the user does not have permission to alter the state of the device based at least in part on the permission scheme.

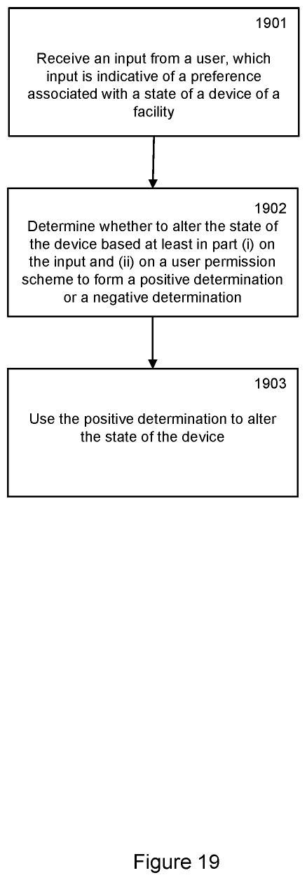

FIG. 19 is an example flowchart of a method for altering states of devices based at least in part on user input and/or a permission scheme. At block 1901, an input is received from the user, which input is indicative of a preference associated with a state of a device of a facility. The input may indicate that the user prefers that the state of the device be altered to a different state. The input may indicate that the user is satisfied with the present state of the device. At block 1902, a determination of whether to alter the state of the device is made based at least in part on (i) the input and (ii) on a user permission scheme to form a positive determination or a negative determination. A positive determination indicates that the state of the device is to be altered. A positive determination may be made based on (i) the input indicating that the user prefers the state of the device to be altered, and (ii) the permission scheme indicating that the user has permission to cause the state of the device to be altered. A negative determination indicates that the state of the device is not to be altered. A negative determination may be made based on (i) the input indicating that the user does not want to alter the state of the device, or (ii) the permission scheme indicates that the user does not have permission to alter the state of the device. At block 1903, the positive determination is used to alter the state of the device. For example, instructions may be transmitted to one or more controllers that directly and/or indirectly control the device to cause the device to transition to a different state other than the present state. The different state may correspond to a state requested in the input from the user. The different state may be identified, for example, by one or more machine learning models. The one or more machine learning models may consider the input received from the user.

In some embodiments, a behavioral model is used to identify one or more actions based at least in part on a received override command to override a present state of a controllable device (e.g., a present tint state of one or more tintable windows, a present light level of one or more lighting devices, etc.). For example, a determination of whether the override matches a rule-based pattern identified by the behavioral model can be made. For example, in an instance in which the override is to override a current state to a different state of a device, a determination of whether the override to transition to the different state matches a rule-based pattern identified by the behavioral model is made. By way of example, in an instance in which the override is to override a current tint state (e.g., Level 3) to a dark tint state (e.g., Level 4), a determination of whether the override to transition to a darker tint state matches a rule-based pattern identified by the behavioral model is made. The rule-based pattern may indicate, for example, that the tint state is to be transitioned to a darker tint state and/or to a particular tint state (e.g., Level 4) under certain conditions, such as sensor values being within a particular range and/or exceeding a threshold, a solar incidence angle being within a particular range and/or exceeding a threshold, a sun penetration depth being within a particular range and/or exceeding a threshold, and/or a time of day being within a particular range. Rule-based patterns and/or override data may be stored in a database (e.g., an override database), and the determination of whether the override matches a rule-based pattern may be made by querying the database.

In some embodiments, the one or more actions identified by the behavioral model include conditioning a controllable device to be in a state associated with a rule-based pattern that matches the override. For example, in an instance in which the controllable device includes one or more tintable windows, the one or more actions may include actuating a particular tint state override associated with a rule-based pattern that matches an override and/or providing a recommendation to implement a tint state override associated with the rule-based pattern that matches the direct override. For example, in an instance in which the rule-based pattern indicates that a tint state is to be overridden to a darker tint state (e.g., one tint level darker than a present level, two tint levels darker than a present level, etc.) and/or is to be overridden to a particular darker tint state, the one or more actions can include automatically transitioning to the darker tint state and/or presenting a recommendation to transition to the darker tint state. A recommendation may include an explanation for the recommendation to transition to the target state for the controllable device indicated the rule-based pattern. For example, the recommendation may include an indication of a percentage of other occupants that have preferred the target state under similar conditions, a number of times the user has requested the same override under similar conditions, or the like. The similar conditions may include weather conditions, values of one or more sensors being within a particular range and/or exceeding particular thresholds, and/or overrides being received at a similar time of day.

In some embodiments, a user response to an action identified by the behavioral model is obtained. For example, in an instance in which the action includes automatically overriding a state of a device to a state associated with an identified rule-based pattern, the user response may include whether the user makes further adjustments to the controllable state of the device (e.g., reverting back to the original state, requesting additional state changes along a same direction of the override, or the like). As another example, in an instance in which the action includes presenting a recommendation to override the current state to an overridden state, the recommendation may include a selectable user input confirming that the state is to be transitioned to (e.g., “would you like to override the current tint state of the tintable window to Level 4?”; “would you like to turn off the overhead light?”; etc.), and the user response can include the user response obtained via the selectable input. The behavioral model can be updated based at least in part on the user response to the action. For example, the user response to the action can be used to construct an additional training sample for use in further training of the behavioral model. As another example, the user response can be added to a database that stores data indicative of user feedback under various conditions and/or that stores rule-based patterns identified by the behavioral model. In one example, in an instance in which the user response confirms the action, the database can be updated to strengthen an association of the set of conditions with the action. In another example, in an instance in which the user response indicates disagreement with the action, the database can be updated to weaken an association of the set of conditions with the action. For example, weakening the association may cause the action to be performed with a lower probability. A user response that indicates disagreement with the action may cause a manual review of the rule-based pattern associated with the action to be initiated. A user response that indicates disagreement with the action may cause a temporary inhibition of invocation of the rule-based pattern.

While some of the examples provided herein are towards a controllable device that is a tintable window, and controllable states that are tint states associated with the tintable window; any other controllable device having controllable states can be substituted appropriately herein.

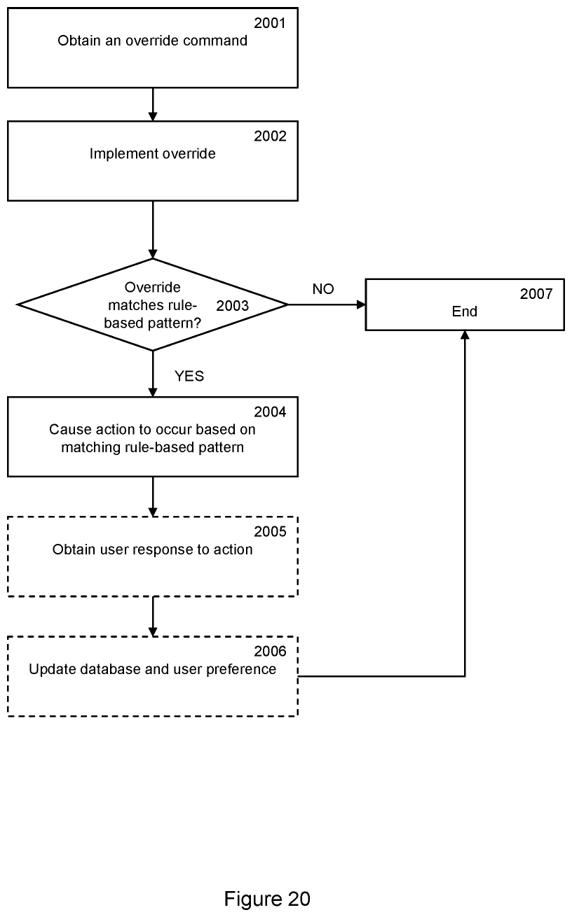

FIG. 20 shows an example flow diagram for identifying an action based at least in part on an override. At block 2001, an override command is obtained. The override may be obtained with respect to a particular controllable device and/or a group of controllable devices. The grouping may be according to a zone, device functionality, and/or device types. In one example, the override relates to a particular tintable window and/or for a zone or group of tintable windows. In another example, the override relates to a particular lighting device or group of lighting devices. The override may indicate a direction in which a present state is to be overridden, a degree to which the present state is to be overridden, and/or a specific override state. In some embodiments, the override command is obtained via an application. In some embodiments, the application is executing on a user device, such as a mobile device of a user who provided the override command, a user device associated with a room or region of a building and/or facility. At block 2002, the override is implemented. For example, the tint state of a tintable window and/or the zone of tintable windows is transitioned to a tint state corresponding to the override command. As another example, the lighting level of one or more lighting devices is changed in accordance with the override command. In some embodiments, the override is implemented according to a permission scheme. For example, the override is implemented in response to determining that the override is permitted. Whether the override is permitted may be determined based at least in part on a permission scheme. At block 2003, a determination of whether the override matches a rule-based pattern is made. The determination may be made by querying a database (e.g., a database associated with a behavioral model) with one or more parameters associated with the override. In an instance in which the override is associated with a tint state of one or more tintable windows, the one or more parameters may include a direction of the tint override (e.g., darker, lighter, or the like) and/or a tint level associated with the tint override, information about the tintable window and/or the zone of tintable windows (e.g., a tintable window identifier, a zone identifier, a geographical facing direction of the tintable window and/or the zone of tintable windows, size information associated with the tintable window and/or the tintable windows in the zone, or the like), and/or information indicating environmental conditions at a time associated with the override (e.g., sensor values associated with one or more sensors, a solar incident angle, a sun penetration depth, a time of day, a time of year, weather information, or the like). In an instance in which a rule-based pattern is identified, the rule-based pattern may be associated with a particular action (e.g., a particular override that is to be implemented, a recommendation for a particular override that is to be provided, or the like). At block 2003, if it is determined that the override does not match a rule-based pattern (“no” at 2003), the process ends at block 2007. If it is determined that the override matches a rule-based pattern (“yes” at 2003), the action associated with the matching rule-based pattern is implemented at block 2004. For example, in an instance in which the action corresponds to actuating an automatic override under the set of conditions associated with the rule-based pattern (and/or associated with the direct override command), a control system may be updated to indicate that automatic overrides to the overridden state are to be performed in response to the set of conditions being detected. As another example, in an instance in which the action corresponds to providing a recommendation to implement an override, the recommendation may be provided. At optional block 2005, a user response to the action may be obtained. For example, the user response may be a response to a provided recommendation (e.g., a user response agreeing with the provided recommendation or a user response disagreeing with the provided recommendation). As another example, the user response may include further adjustments to the state of the device. At optional block 2006, database and/or user preferences may be updated. For example, a database that includes override data may be updated based at least in part on the user response. As another example, an additional training sample may be constructed to provide further training of the behavioral model. In some embodiments, user preferences may be adjusted, for example, to indicate updated preferences for states of controllable devices based at least in part on the set of conditions at the time the direct override command was received. The process ends at block 2007.

In some embodiments, a behavioral model is used to determine actions based at least in part on indirect feedback. The indirect feedback may include user preferences regarding tint state of one or more tintable windows where a user who provides the indirect feedback is not permitted to alter the tint state of the one or more tintable windows. The indirect feedback may be that a current tint state is too light, too dark, etc. The indirect feedback may include user preferences relating to temperature which may be impacted by tint state. The indirect feedback may be that a current room temperature is too hot, too cold, etc. The actions may include providing a recommendation to a building operations manager and/or facilities manager to override states of one or more controllable devices in accordance with the indirect feedback. The recommendation may be to transition one or more tintable windows to a darker tint state based at least in part on indirect feedback indicating that the current tint state is too light, and/or that a current room temperature is too hot. The recommendation may be to transition one or more tintable windows to a lighter tint state based at least in part on indirect feedback indicating that the current tint state is too dark, and/or that a current room temperature is too cold. The actions may include causing an automatic override of the state of the controllable device (e.g., without manual input).

In some embodiments, the one or more actions are identified based at least in part on a determination that parameters associated with received indirect feedback match parameters associated with a rule-based pattern identified by the behavioral model. The one or more actions may be identified based at least in part on a determination that the direction of a tint change of one or more tintable windows indicated by (i) the indirect feedback and/or (ii) a set of conditions at a time the indirect feedback was received match corresponding parameters of a rule-based pattern. The rule-based pattern may indicate a particular tint state override is to be implemented in response to detection of a particular set of conditions. In an instance in which the indirect feedback matches the particular tint state override and the particular set of conditions, the actions may occur. The actions may comprise (i) providing a recommendation to a building operations manager to implement the particular tint state override, (ii) automatically implementing the particular tint state override, or (iii) the like.

In some examples, a recommendation provided to a building operations manager and/or a facilities manager includes various information. The recommendation may include an indication of a percentage of building occupants that have provided similar indirect feedback on which the recommendation is provided. The recommendation may include an impact of effecting a particular state override on other building systems, such as an estimated change in energy savings. The recommendation may include an option for the building operations manager to cause a one-time override to be implemented. The recommendation may include an option for the building operations manager to cause an automatic override to be implemented in response to detection of a set of conditions associated with the recommendation. For example, a set of conditions associated with the rule-based pattern the recommendation is based at least in part on. An example of a recommendation is “57% of occupants of Conference Room 1 prefer a darker tint state in the afternoons; would you like to implement an override of the tint state to Tint State 4 at 1 p.m.?” Another example of a recommendation is “63% of occupants of Conference Room 1 prefer a warmer temperature; would you like to lighten the windows in the morning to allow for warming by sunlight?” Another example of a recommendation is “Lightening the windows in the morning in Conference Room 1 would reduce energy consumed from lighting devices in Conference Room 1 by 50%; would you like to implement this change?”

In some embodiments, a user response in response to the actions identified by the behavioral model (I) are used to update a database utilized by the behavioral model and/or (II) are used to perform additional training of the behavioral model. The user response may include a response to a recommendation, such as (i) whether a one-time override is to be implemented, (ii) whether a general override is to be implemented in response to detection of a set of conditions is to be implemented, (iii) whether no override is to be implemented, and/or (iv) the like. In an instance in which the user response confirms the action(s), an association between a set of conditions and the target device state indicated in a rule-based pattern may be strengthened such that the rule-based pattern is identified as a match with higher likelihood in response to detecting the set of conditions has occurred. Examples of an instance in which the user response confirms the action(s) may include (a) in an instance in which a one-time override is confirmed in the user response, (b) in an instance in which a general override is confirmed in the user response, or (c) the like. In an instance in which the user response disagrees with the action(s), an association between a set of conditions and a target device state indicated in a rule-based pattern may be weakened, such that the rule-based pattern is identified as a match with lower likelihood in response to detecting that the set of conditions has occurred.

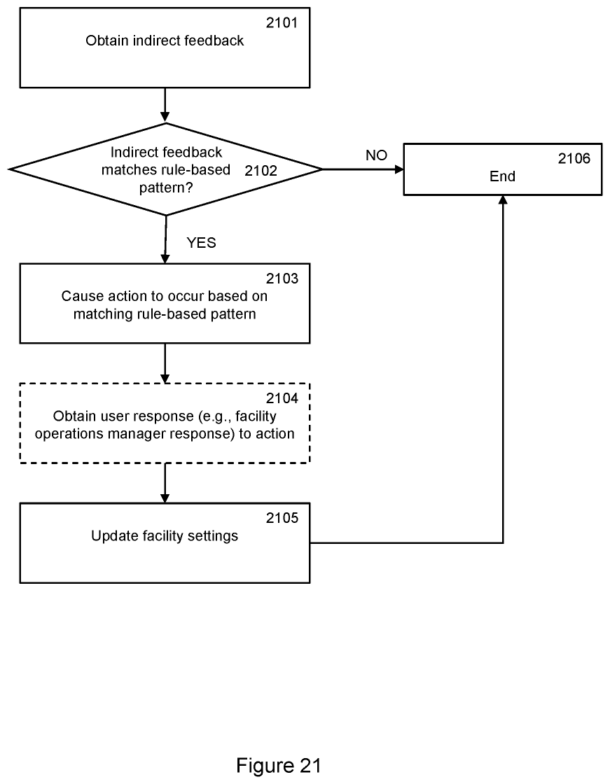

FIG. 21 shows an example of a flow diagram for identifying one or more actions in response to receiving indirect feedback. At block 2101, indirect feedback is obtained. The indirect feedback may be with respect to one or more controllable devices, the indirect feedback includes user preferences which may not be implemented and/or may not be actionable, for example, due to a user who provided the indirect feedback not being permitted to effect a change to the one or more controllable devices. At block 2102, a determination of whether the indirect feedback matches a rule-based pattern is made. The determination may be made based at least in part on whether parameters associated with the indirect feedback match parameters associated with the rule-based pattern. If, at block 2102, no matching rule-based pattern is identified, the process ends at block 2106. The indirect feedback may be stored, for example, in a database (e.g., a sentiment database that stores received indirect feedback). If, at block 2102, a matching rule-based pattern is identified, an action associated with the matching rule-based pattern is implemented at block 2103. The action may include automatically conditioning the controllable device to a target state specified in the rule-based pattern, providing a recommendation to a building operations manager to implement condition the controllable device to the target state specified in the rule-based pattern as a one-time override, and/or providing a recommendation to a building operations manager to implement a general override to the target state specified in the rule-based pattern. At optional block 2104, one or more user responses to the action(s) may be obtained. The action(s) may include a user response to a recommendation provided (e.g., a user response to the recommendation from the building operations manager that received the recommendation). At block 2105, facility settings are updated. The facility (e.g., building) settings may be updated based at least in part on a user response to a recommendation. In one example, in an instance in which a user response to a recommendation to implement a general override to a particular target state in response to detection of particular conditions is that the general override is to be implemented, the building settings can be updated accordingly. For example, scheduling information can be updated based at least in part on the user response. The settings of the facility (e.g., devices of the facility) may be usable by a control system to implement the general override in response to detection of the set of conditions. The process then ends at block 2106.

In some embodiments, a behavioral model that relates to a plurality of facilities is trained based at least in part on user feedback data from the facilities. A facility may comprise one or more buildings. At least one first facility of a first set of facilities that the behavioral model is used to identify actions for, is different from at least one second facility of a second set of facilities from which the user feedback data is obtained. The user feedback data may be override data, direct feedback, and/or indirect feedback, which feedback is associated with controllable state(s) of controllable device(s) in the first set of facilities. An item of user feedback is associated with information. The information may include time information, geographic information, facility information, and/or user information related to the user who provided the user feedback. The user related information may comprise a role of the user within an organization, or the like. The time information may comprise a time the user feedback was provided, a date the user feedback was provided, a time of year the user feedback was provided, or the like. The geographic information may comprise: geographic coordinates such as GPS coordinates of the facility for which the user feedback applies, a geographic location such as a city and/or state of the facility for which the user feedback applies, a geographic-facing direction of one or more devices (e.g., tintable windows) for which the user feedback applies, or the like. The facility information may comprise: facility type, a floor of the one or more controllable devices to which the user feedback applies, a type of room to which the user feedback applies, or the like.

In some embodiments, a behavioral model that applies to multiple buildings and/or facilities is trained by clustering user feedback based at least in part on similarity of parameters associated with the user feedback. The user feedback may be clustered (e.g., grouped) based at least in part on (i) time information, (ii) geographic information, (ii) facility information, user information, (iv) weather information, and/or (v) sensor information. The weather information may comprise temperature, degree of cloud cover, degree of precipitation, or the like. The sensor information may include data and/or measurements from one or more sensors. The user feedback may be clustered such that user feedback associated with office buildings located within a particular latitude and/or longitude range are clustered together. The user feedback may be clustered such that user feedback associated with shared workspaces with east-facing windows are clustered together. The user feedback may be clustered such that user feedback associated with large commercial spaces received between particular times of day are clustered together. The user feedback may be clustered such that user feedback associated with single-use office rooms obtained during sunny conditions are clustered together. The user feedback may be clustered based at least in part on user preferences regarding environmental conditions. The user feedback may be clustered such that user feedback from users who prefer environments within a particular temperature range are clustered together. The user feedback may be clustered such that user feedback from users who prefer environments with a particular level of glare control are clustered together. The user feedback may be clustered such that user feedback from users who prefer environments with a particular brightness level are clustered together. Any suitable combination of parameters and/or any number of parameters may be used to cluster the user feedback. In some embodiments, the same machine learning model is trained for at least two of the clusters (e.g., for each cluster) of user feedback. In some embodiments, a different machine learning model is trained for at least two of the clusters (e.g., for each cluster) of user feedback. A first machine learning model may be used to predict actions (e.g., override tint states, override lighting levels, override air conditioning levels, etc.) to be taken for a first clustering of parameters, and a second machine learning model may be used to predict actions to be taken for a second clustering of parameters. The machine learning model may have any suitable type of architecture, such as a deep neural network, a convolutional neural network, a fully convolutional neural network, a regression, or the like (e.g., using any artificial intelligence methodology disclosed herein).

In some embodiments, parameters and/or rule-based patterns identified by a behavioral model related to multiple facilities are provided to a behavioral model that relates to a single facility. The parameters and/or rule-based patterns may be incorporated into the behavioral model related to the single facility. The behavioral model related to the single facility may use transfer learning to incorporate the parameters and/or rule-based patterns identified by a behavioral model that relates to multiple facilities (e.g., a plurality of facilities).

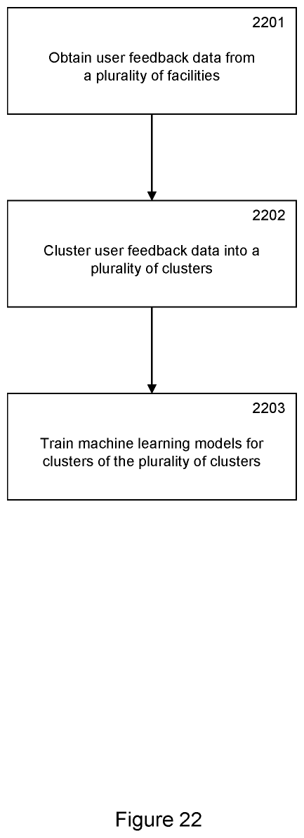

FIG. 22 shows an example of a flow diagram for training a behavioral model for multiple buildings and/or facilities. At block 2201, user feedback data from a plurality of buildings and/or facilities is obtained. The user feedback data may be obtained from a database that receives user feedback from the plurality of buildings and/or facilities. The user feedback may include override commands, direct feedback, and/or indirect feedback. The user feedback may include user feedback that has been acted upon and/or user feedback that has not been acted upon. At block 2202, the user feedback data is clustered into a plurality of clusters. The user feedback data is clustered based at least in part on similarity of parameters associated with the user feedback data. The parameters may include time information, geographic information, building and/or facility information, user information, weather information (e.g., temperature, degree of cloud cover, degree of precipitation, etc.), and/or sensor information (e.g., data and/or measurements from one or more sensors). Clustering may be performed by a clustering algorithm, such as K-nearest neighbors, K-means, or the like. At block 2203, machine learning models are trained for clusters of the plurality of clusters. Each machine learning model may predict, for a set of conditions associated with user feedback, a tint override state. The machine learning model may be applicable to user feedback associated with parameters corresponding to the cluster.

In some embodiments, an application executing on a user device communicates with one or more control system components. The application may be communicatively coupled to the one or more control system components via a network. The network may be a network of a facility. The application may be used to effect changes to one or more controllable devices, provide user feedback on states of one or more controllable devices, receive recommendations to change states of one or more controllable devices, and/or the like. Instructions for executing the application may be stored locally on a user device that executes the application and/or on a remote device (e.g., a server, a cloud service, etc.).

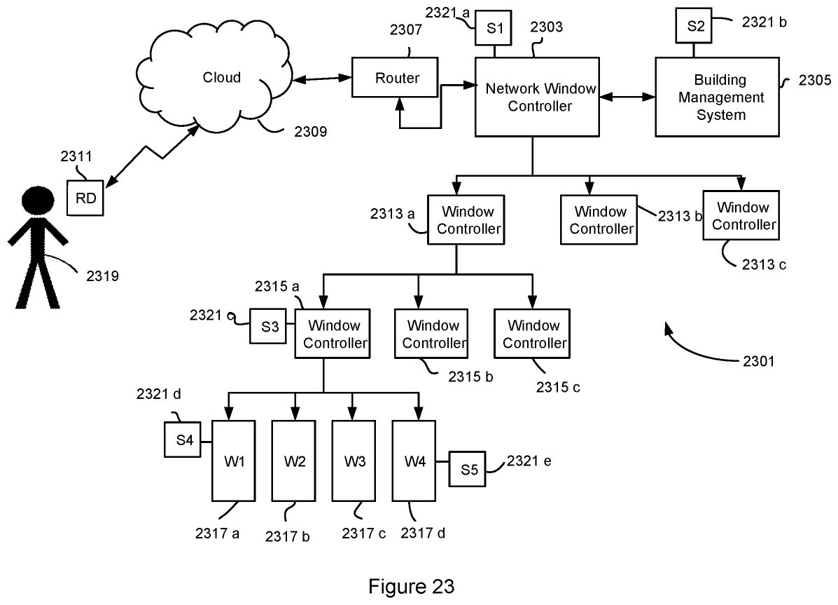

FIG. 23 schematically represents communication between an application executing on a user device and control system components. As illustrated, a network 2301 interacts with a user device 2311 to give a user 2319 control over the optical state of one or more switchable windows or other controllable devices under the control of network 2301. An application facilitates the interaction between user 2319 and network 2301. Instructions for executing the software application may be stored on the user device 2311, or a network window controller 2303, or elsewhere (e.g., a server, a cloud-based device, etc.). The application may run on (or be executed on) various devices including the user device 2311, the network window controller 2303, and the facility management system 2305, and/or other hardware, including shared hardware such as hardware employed locally in the facility, or external to the facility such as at least partially in the cloud.

In some embodiments, diverse types of interfaces are employed for providing user control of interactive targets (e.g., systems, devices, and/or media). The interactive targets can be controlled, e.g., using control interface(s). The control interface may be local and/or remote. The control interface may be communicated through the network. The control system may be communicatively coupled to the network, to which the target(s) are communicatively coupled. An example of a control interface comprises manipulating a digital twin (e.g., representative model) of a facility. For example, one or more interactive devices (e.g., optically switchable windows, sensors, emitters, and/or media displays) may be controlled using a mobile circuitry. The mobile circuitry may comprise a gaming-type controller (e.g., a pointing device) or a virtual reality (VR) user interface. When an additional new device is installed in the facility (e.g. in a room thereof) and is coupled to the network, the new target (e.g., device) may be detected (e.g., and included into the digital twin). The detection of the new target and/or inclusion of the new target into the digital twin may be done automatically and/or manually. For example, the detection of the new target and/or inclusion of the new target into the digital twin may be without requiring (e.g., any) manual intervention.

In some embodiments, a digital twin comprises a digital model of the facility. The digital twin is comprised of a virtual three dimensional (3D) model of the facility. The facility may include static and/or dynamic elements. For example, the static elements may include representations of a structural feature of the facility and the dynamic elements may include representations of an interactive device with a controllable feature. The 3D model may include visual elements. The visual elements may represent facility fixture(s). The fixture may comprise a wall, a floor, wall, door, shelf, a structural (e.g., walk-in) closet, a fixed lamp, electrical panel, elevator shaft, or a window. The fixtures may be affixed to the structure. The visual elements may represent non-fixture(s). The non-fixtures may comprise a person, a chair, a movable lamp, a table, a sofa, a movable closet or a media projection. The visual elements may represent facility features comprising a floor, wall, door, window, furniture, appliance, people, and/or interactive target(s)). The digital twin may be similar to virtual worlds used in computer gaming and simulations, representing the environment of the real facility. Creation of a 3D model may include the analysis of a Building Information Modeling (BIM) model (e.g., an Autodesk Revit file having *.RVT format), e.g., to derive a representation of (e.g., basic) fixed structures and movable items such as doors, windows, and elevators. The 3D mode may comprise architectural details related to the design of the facility, such as a 3D model, elevation details, floor plans, and/or project settings related to the facility. The 3D model may comprise annotation (e.g., with two dimensional (2D) drafting element(s)). The 3D model may facilitate access to information from a model database of the facility. The 3D model may be utilized for planning and/or tracking various stages in the lifecycle of the facility (e.g., facility concept, construction, maintenance and/or demolition). The 3D model may be updated during the lifecycle of the facility. The update may be periodically, intermittently, on occurrence of an event (e.g., relating to the structural status of the facility), in real time, on availability of manpower, and/or at a whim. The digital twin may comprise the 3D model, and may be updated in relation to (e.g., when) the 3D model of the facility is updated. The digital twin may be linked to the 3D model (e.g., and thus linked to its updates). In real time may include within at most 15 seconds (sec.), 30 sec., 45 sec., 1 minute (min), 2 min., 3 min. 4 min., 5 min, 10 min., 15 min. or 30 min, from the occurrence of a change in the enclosure (e.g., a change initiated by the user).

In some embodiments, the digital twin (e.g., 3D model of the facility) is defined at least in part by using one or more sensors (e.g., optical, acoustic, pressure, gas velocity, and/or distance measuring sensor(s)), to determine the layout of the real facility. Usage of sensor data can be used exclusively to model the environment of the enclosure. Usage of sensor data can be used in conjunction with a 3D model of the facility (e.g., (BIM model) to model the environment of the enclosure. The BIM model of the facility may be obtained before, during, and/or after the facility has been constructed. The BIM model of the facility can be updated (e.g., manually and/or using the sensor data) during operation of the facility (e.g., in real time). In real time may include, during occurrence of a change of, or in, the facility. In real time may include within at most 2 h, 4 h, 6 h, 8 h, 12 h, 24 h, 36 h, 48 h, 60 h, or 72h from the occurrence of a change of, or in, the facility.

In some embodiments, dynamic elements in the digital twin include target (e.g., device) settings. The target setting may comprise (e.g., existing and/or predetermined): tint values, temperature settings, and/or light switch settings. The target settings may comprise available actions in media displays. The available actions may comprise menu items or hotspots in displayed content. The digital twin may include virtual representation of the target and/or of movable objects (e.g., chairs or doors), and/or occupants (actual images from a camera or from stored avatars). In some embodiments, the dynamic elements can be targets (e.g., devices) that are newly plugged into the network, and/or disappear from the network (e.g., due to a malfunction or relocation). The digital twin can reside in any circuitry (e.g., processor) operatively coupled to the network. The circuitry in which the digital circuitry resides may be in the facility, outside of the facility, and/or in the cloud. In some embodiments, a two-way link is maintained between the digital twin and a real circuitry. The real circuitry may be part of the control system. The real circuitry may be included in the master controller, network controller, floor controller, local controller, or in any other node in a processing system (e.g., in the facility or outside of the facility). For example, the two-way link can be used by the real circuitry to inform the digital twin of changes in the dynamic and/or static elements so that the 3D representation of the enclosure can be updated, e.g., in real time. In real time may include, during occurrence of a change of, or in, the enclosure. In real time may include within at most 15 seconds (sec.), 30 sec., 45 sec., 1 minute (min), 2 min., 3 min. 4 min., 5 min, 10 min., 15 min. or 30 min, from the occurrence of a change in, the enclosure. The two-way link may be used by the digital twin to inform the real circuitry of manipulative (e.g., control) actions entered by a user on a mobile circuitry. The mobile circuitry can be a remote controller (e.g., comprising a handheld pointer, manual input buttons, or touchscreen).

In some embodiments, one or more mobile circuitry devices of a user are aligned with (e.g., linked to) the virtual 3D “digital twin” model of the facility (or any portion thereof), e.g., via WiFi or other network connections. The mobile circuitry may comprise a remote (e.g., mobile) control interface. The mobile circuitry may include a pointer, gaming controller, and/or virtual reality (VR) controller. For example, the mobile circuitry may have no interaction with the physical facility, e.g., other than forwarding network communications via the aligned communication channel to and/or from the digital twin. The user interaction may not be direct and/or physical with any device being controlled in the enclosure. The user interaction of the user with the target may be indirect. The interaction of the user with the target may be devoid of tactile touch, optical ray projection, and/or vocal sound. The control actions taken by the user to control the target may be based at least in part on a relative position of the digital circuitry manipulated by a user, relative to the modeled space in the digital twin (e.g., virtual movement within the modeled enclosure). The control actions taken by the user to control the target may be not based on (e.g. and are oblivious to) the spatial relationship between the user and the digital twin. For example, a user may use a remote control pointing device, and point to a presentation portion. The presentation may be displayed on a TOLED display construct disposed in the line of sight between a user and a window (e.g., smart window). The coupling between the mobile circuitry and the target may be time based and/or may be action based. For example, the user may use the point the remote controller to the presentation, and by this couple with the presentation. The coupling may initiate on pointing in a duration that exceeds a duration threshold. The coupling may initiate by clicking the remote controller while pointing. The user may then point to a position that triggers a dropdown menu in the presentation. The dropdown menu may be visible (i) when the pointing may exceed a time threshold (ii) when the user presses button(s) on the remote controller (e.g., action based), and/or (iii) when the user performs a gesture (e.g., as disclosed herein). The user may then choose from the menu. The choice may be initiated (i) when the pointing may exceed a time threshold (ii) when the user presses button(s) on the remote controller (e.g., action based), and/or (iii) when the user performs a gesture (e.g., as disclosed herein). The actions of the user done in conjunction with the mobile circuitry (e.g., remote controller) may be communicated to the network, and thereby to the digital twin that is in turn communicated to the target. And thus, the user may indirectly communicate with the target through the digital twin. The mobile circuitry (e.g., remote controller) may be located with respect to the enclosure at one time, at time intervals, and/or continuously. Once a relative location of the mobile circuitry (e.g., remote controller) with the enclosure is determined, the user may use the remote controller anywhere (e.g., inside the enclosure, or outside of the enclosure). Outside of the enclosure may comprise in the facility or outside of the facility. For example, a conference room may establish its relative location with a remote controller. Thereafter, a user may use the relatively located remote controller to manipulate a light intensity of a light bulb disposed in the conference room while in the conference room, or while outside of the conference room (e.g., from home).

In some embodiments, the mobile circuitry (e.g., remote controller) can control a (e.g., any) interactive and/or controllable target (e.g., device) in the facility or any portion thereof, as long as (i) the target and (ii) the mobile circuitry (e.g., remote controller) are communicatively coupled to the digital twin (e.g., using the network). For example, the facility may comprise interactive targets comprising one or more sensors, emitters, tintable windows, or media displays, which devices are coupled to a communication network. In some embodiments, the user interacts with the digital twin from within the facility or from an (e.g., arbitrary) location outside the facility. For example, a remote controller device can comprise a virtual reality (VR) device, e.g., having a headset (e.g., a binocular display) and/or a handheld controller (e.g., motion sensor with or without input buttons). The mobile circuitry may comprise an Oculus Virtual Reality Player Controller (OVRPlayerController). In some embodiments, a remote control interface may be used which provides (i) visual representation to the user of the digital twin for navigation in the virtual facility, and/or (ii) user input actions for movement within the 3D model. The user input actions may include (1) pointing to an intended interactive target to be controller (e.g., to alter status of the target), (2) gestures, and/or (3) button presses, to indicate a selection action to be taken with the mobile circuitry (e.g., remote controller). The remote controller may be used to manipulate an interactive target by pointing towards them (e.g., for coupling), gesturing in other directions, and/or pressing one or more buttons operatively coupled to the mobile circuitry (e.g., buttons disposed on an envelope of the mobile circuitry). Interfacing between the mobile circuitry and the digital twin may not be carried out through a screen depicting the digital twin. Interfacing between the user and the digital twin may not be carried out through a screen showing the digital twin. Interfacing between the mobile circuitry and the digital model may not require (e.g., any) optical sensor as facilitator). Some embodiments employ a different mode of input from augmented reality applications that operate through interaction with a screen (e.g., by using an optical sensor such as a camera).

In some embodiments, a mobile circuitry (e.g., handheld controller) without any display or screen is used, which display or screen may depict a digital representation of the enclosure and/or the target. For example, instead of virtual navigation within the enclosure by the user, the actual location of the user can be determined in order to establish the location of the user in the digital twin, e.g., to use as a reference in connection with a pointing action by the user. For example, the mobile circuitry (e.g., handheld controller) may include geographic tracking capability (e.g., GPS, UWB, BLE, and/or dead-reckoning) so that location coordinates of the mobile circuitry can be transmitted to the digital twin using any suitable network connection established by the user between the mobile circuitry and the digital twin. For example, a network connection may at least partly include the transport links used by a hierarchical controller network within a facility. The network connection may be separate from the controller network of the facility (e.g., using a wireless network such as a cellular network).

In some embodiments, a user may couple to a requested target. The coupling may comprise a gesture using the mobile circuitry. The coupling may comprise an electronic trigger in the mobile circuitry. The coupling may comprise a movement, pointing, clicking gesture, or any combination thereof. For example, the coupling may initiate at least in part by pointing to the target for a period of time above a threshold (e.g., that is predetermined). For example, the coupling may initiate at least in part by clicking a button (e.g., a target selection button) on a remote controller that includes the mobile circuitry. For example, the coupling may initiate at least in part by moving the mobile circuitry towards a direction of the target. For example, the coupling may initiate at least in part by pointing a frontal portion of the mobile circuitry in a direction of the target (e.g., for a time above a first threshold) and clicking a button (e.g., for a time above a second threshold). The first and second thresholds can be (e.g., substantially) the same or different.

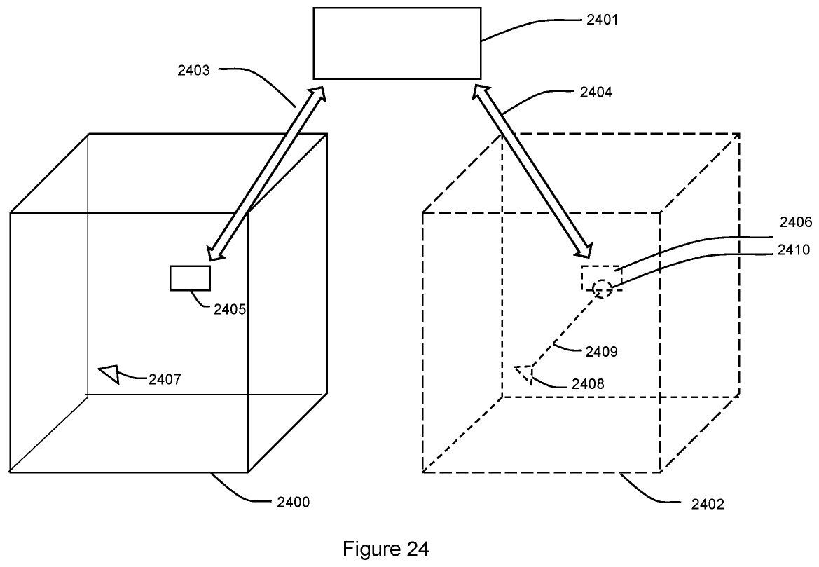

FIG. 24 shows an example embodiment of a control system in which a real, physical enclosure (e.g., room) 2400 includes a controller network for managing interactive network devices under control of a processor 2401 (e.g., a master controller). The structure and contents of building 2400 are represented in a 3-D model digital twin 2402 as part of a modeling and/or simulation system executed in a computing asset. The computing asset may be co-located with or remote from enclosure 2400 and processor (e.g., master controller) 2401. A network link 2403 in enclosure 2400 connects processor 2401 with a plurality of network nodes including an interactive target 2405. Interactive target 2405 is represented as a virtual object 2406 within digital twin 2402. A network link 2404 connects processor 2401 with digital twin 2402.

In the example of FIG. 24, a user located in enclosure 2400 carries a handheld control 2407 having a pointing capability (e.g., to couple with the target 2405). The location of handheld control 2407 may be tracked, for example, via a network link with digital twin 2402 (not shown). The link may include some transport media contained within network 2403. Handheld controller 2407 is represented as a virtual handheld controller 2408 within digital twin 2402. Based at least in part on the tracked location and pointing capability of handheld controller 2407, when the user initiates a pointing event (e.g., aiming at a particular target and pressing an action button on the handheld controller) it is transmitted to digital twin 2402. Accordingly, digital twin 2402 interacts with the target (e.g., represented as a digital ray 2409 from the tracked location within digital twin 2402). Digital ray 2409 intersects with virtual device 2406 at a point of intersection 2410. A resulting interpretation of actions made by the user in the digital twin 2402 is reported by digital twin 2402 to processor 2401 via network link 2404. In response, processor 2401 relays a control message to interactive device 2405 to initiate a commanded action in in accordance with a gesture (or other input action) made by the user.

In some embodiments, a user is locatable in the enclosure (e.g., facility such as a building). The user can be located using one or more sensors. The user may carry a tag. The tag may include radio frequency identification (e.g., RFID) technology (e.g., transceiver), Bluetooth technology, and/or Global Positional System (GPS) technology. The radio frequency may comprise ultrawide band radio frequency. The tag may be sensed by one or more sensors disposed in the enclosure. The sensor(s) may be disposed in a device ensemble. The device ensemble may comprise a sensor or an emitter. The sensor(s) may be operatively (e.g., communicatively) coupled to the network. The network may have low latency communication, e.g., within the enclosure. The radio waves (e.g., emitted and/or sensed by the tag) may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHZ, 10 MHZ, 15 MHZ, 20 MHz, or 25 MHz. The radio waves may be at a high frequency of at most about 5 MHZ, 8 MHZ, 10 MHZ, 15 MHZ, 20 MHZ, 25 MHZ, or 30 MHz. The radio waves may be at any frequency between the aforementioned frequency ranges (e.g., from about 3 MHz to about 30 MHZ). The radio waves may be at a very high frequency of at least about 30 Megahertz (MHz), 50 MHZ, 80 MHZ, 100 MHZ, 150 MHZ, 200 MHZ, or 250 MHz. The radio waves may be at a very high frequency of at most about 50 MHZ, 80 MHZ, 100 MHZ, 150 MHz, 200 MHZ, 250 MHz, or 300 MHz. The radio waves may be at any frequency between the aforementioned frequency ranges (e.g., from about 30 MHz to about 300 MHZ). The radio waves may be at an ultra-high frequency of at least about 300 kilohertz (MHz), 500 MHZ, 800 MHz, 1000 MHZ, 1500 MHZ, 2000 MHz, or 2500 MHz. The radio waves may be at an ultra-high frequency of at most about 500 MHZ, 800 MHZ, 1000 MHZ, 1500 MHZ, 2000 MHZ, 2500 MHZ, or 3000 MHz. The radio waves may be at any frequency between the aforementioned frequency ranges (e.g., from about 300 MHz to about 3000 MHZ). The radio waves may be at a super high frequency of at least about 3 gigahertz (GHz), 5 GHz, 8 GHZ, 10 GHZ, 15 GHZ, 20 GHZ, or 25 GHz. The radio waves may be at a super high frequency of at most about 5 GHZ, 8 GHZ, 10 GHZ, 15 GHZ, 20 GHZ, 25 GHZ, or 30 GHz. The radio waves may be at any frequency between the aforementioned frequency ranges (e.g., from about 3 GHz to about 30 GHZ).

In some embodiments, the identification tag of the occupant comprises a location device. The location device (also referred to herein as “locating device”) may compromise a radio emitter and/or receiver (e.g., a wide band, or ultra-wide band radio emitter and/or receiver). The locating device may include a Global Positioning System (GPS) device. The locating device may include a Bluetooth device. The locating device may include a radio wave transmitter and/or receiver. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHZ, 8 MHZ, 10 MHZ, 15 MHZ, 20 MHZ, or 25 MHz. The radio waves may be at a high frequency of at most about 5 MHZ, 8 MHZ, 10 MHZ, 15 MHZ, 20 MHZ, 25 MHZ, or 30 MHz. The radio waves may be at any frequency between the aforementioned frequency ranges (e.g., from about 3 MHz to about 30 MHZ). The radio waves may be at a very high frequency of at least about 30 Megahertz (MHz), 50 MHZ, 80 MHZ, 100 MHz, 150 MHZ, 200 MHZ, or 250 MHz. The radio waves may be at a very high frequency of at most about 50 MHZ, 80 MHZ, 100 MHZ, 150 MHZ, 200 MHZ, 250 MHz, or 300 MHz. The radio waves may be at any frequency between the aforementioned frequency ranges (e.g., from about 30 MHz to about 300 MHz). The radio waves may be at an ultra-high frequency of at least about 300 kilohertz (MHz), 500 MHZ, 800 MHz, 1000 MHz, 1500 MHZ, 2000 MHz, or 2500 MHz. The radio waves may be at an ultra-high frequency of at most about 500 MHz, 800 MHZ, 1000 MHZ, 1500 MHZ, 2000 MHz, 2500 MHZ, or 3000 MHz. The radio waves may be at any frequency between the aforementioned frequency ranges (e.g., from about 300 MHz to about 3000 MHZ). The radio waves may be at a super high frequency of at least about 3 gigahertz (GHz), 5 GHZ, 8 GHz, 10 GHZ, 15 GHz, 20 GHZ, or 25 GHz. The radio waves may be at a super high frequency of at most about 5 GHZ, 8 GHZ, 10 GHZ, 15 GHZ, 20 GHz, 25 GHZ, or 30 GHz. The radio waves may be at any frequency between the aforementioned frequency ranges (e.g., from about 3 GHZ to about 30 GHZ).

In some embodiments, the locating device facilitates location within an error range. The error range of the locating device may be at most about 5 meters (m), 4m, 3m, 2m, 1m, 0.5m, 0.4m, 0.3m, 0.2m, 0.1m, or 0.05m. The error range of the locating device may be any value between the aforementioned values (e.g., from about 5m to about 0.05m, from about 5m to about 1m, from about 1m to about 0.3m, and from about 0.3m to about 0.05m). The error range may represent the accuracy of the locating device.

In some embodiments, target apparatus(es) (e.g., service device(s)) can be discovered within a range from a user (e.g., using the network and the control system). In some embodiments, target apparatus(es) (e.g., service device(s)) can be discovered within a range from a target apparatus. The user range and the apparatus range can intersect. The range can be referred to herein as a “discovery range,” for example, a service apparatus discovery range. A target apparatus can be discovered by a user when the target apparatus discovery range intersects with the user discovery range. For example, a target apparatus can be discovered by a user when the user is in the target apparatus discovery range. The discovery can be using the network. The discovery can be displayed in a mobile circuitry (e.g., cellular phone) of the user. The range can be specific to a target apparatus, target apparatus type, or a set of target apparatus types. For example, a first range can be for manufacturing machines, a second range can be for media displays, and a third range can be for food service machines. The range can be specific to an enclosure, or to a portion of the enclosure. For example, a first discovery range can be for a lobby, a second discovery range can be for a cafeteria, and a third discovery range can be for an office or for a group of offices. The range can be fixed or adjustable (e.g., by a user, a manager, a facility owner, and/or a lessor). A first target apparatus type may have a different discovery range from a second target apparatus type. For example, a larger control range can be assigned for light switches, and shorter for beverage service devices. The larger control range can be of at most about 1 meter (m), 2 m, 3 m, or 5 m. The shorter control range can be of at most about 0.2 m, 0.3 m, 0.4 m, 0.5 m, 0.6 m, 0.7 m, 0.8 m, or 0.9 m. A user may detect (e.g., visually and/or using a list) devices within relevant use range of the user. Visually may comprise using icons, drawings, and/or a digital twin of the enclosure (e.g., as disclosed herein). Usage of discovery ranges may facilitate focusing (e.g., shortening) a list of target apparatuses relevant for the user to control, e.g., and prevent the user from having to select from a long list of (e.g., largely irrelevant) target apparatuses (e.g., service devices). Controlling the range can be using a position of the user (e.g., using a geolocation device such as one comprising UWB technology), and target apparatus paring (e.g., Wi-Fi pairing) to the network. The range of discovery be unconstrained by a rage dictated by direct device-user paring technology (e.g., Bluetooth pairing range). For example, when the user is located far from the target apparatus, the user may be able to couple with the target apparatus even if the device is out of the direct device-user paring technology range (e.g., user range). The third party target apparatus selected by the user may or may not incorporate a technology for direct device-user pairing technology.

In some embodiments, pulse-based ultra-wideband (UWB) technology (e.g., ECMA-368, or ECMA-369) is a wireless technology for transmitting large amounts of data at low power (e.g., less than about 1 millivolt (mW), 0.75 mW, 0.5 mW, or 0.25 mW) over short distances (e.g., of at most about 300 feet (′), 250′, 230′, 200′, or 150′). A UWB signal can occupy at least about 750 MHz, 500 MHZ, or 250 MHz of bandwidth spectrum, and/or at least about 30%, 20%, or 10% of its center frequency. The UWB signal can be transmitted by one or more pulses. A component broadcasts digital signal pulses may be timed (e.g., precisely) on a carrier signal across a number of frequency channels at the same time. Information may be transmitted, e.g., by modulating the timing and/or positioning of the signal (e.g., the pulses). Signal information may be transmitted by encoding the polarity of the signal (e.g., pulse), its amplitude and/or by using orthogonal signals (e.g., pulses). The UWB signal may be a low power information transfer protocol. The UWB technology may be utilized for (e.g., indoor) location applications. The broad range of the UWB spectrum comprises low frequencies having long wavelengths, which allows UWB signals to penetrate a variety of materials, including various building fixtures (e.g., walls). The wide range of frequencies, e.g., including the low penetrating frequencies, may decrease the chance of multipath propagation errors (without wishing to be bound to theory, as some wavelengths may have a line-of-sight trajectory). UWB communication signals (e.g., pulses) may be short (e.g., of at most about 70 cm, 60 cm, or 50 cm for a pulse that is about 600 MHz, 500 MHz, or 400 MHz wide; or of at most about 20 cm, 23 cm, 25 cm, or 30 cm for a pulse that is has a bandwidth of about 1 GHZ, 1.2 GHz, 1.3 GHZ, or 1.5 GHZ). The short communication signals (e.g., pulses) may reduce the chance that reflecting signals (e.g., pulses) will overlap with the original signal (e.g., pulse).

In some embodiments, an identification (ID) tag of a user can include a micro-chip. The micro-chip can be a micro-location chip. The micro-chip can incorporate auto-location technology (referred to herein also as “micro-location chip”). The micro-chip may incorporate technology for automatically reporting high-resolution and/or high accuracy location information. The auto-location technology can comprise GPS, Bluetooth, or radio-wave technology. The auto-location technology can comprise electromagnetic wave (e.g., radio wave) emission and/or detection. The radio-wave technology may be any RF technology disclosed herein (e.g., high frequency, ultra-high frequency, super high frequency. The radio-wave technology may comprise UWB technology. The micro-chip may facilitate determination of its location within an accuracy of at most about 25 centimeters, 20 cm, 15 cm, 10 cm, or 5 cm. In various embodiments, the control system, sensors, and/or antennas are configured to communicate with the micro-location chip.

In some embodiments, the ID tag may comprise the micro-location chip. The micro-location chip may be configured to broadcast one or more signals. The signals may be omnidirectional signals. One or more component operatively coupled to the network may (e.g., each) comprise the micro-location chip. The micro-location chips (e.g., that are disposed in stationary and/or known locations) may serve as anchors. By analyzing the time taken for a broadcast signal to reach the anchors within the transmittable distance of the ID-tag, the location of the ID tag may be determined. One or more processors (e.g., of the control system) may perform an analysis of the location related signals. For example, the relative distance between the micro-chip and one or more anchors and/or other micro-chip(s) (e.g., within the transmission range limits) may be determined. The relative distance, know location, and/or anchor information may be aggregated. At least one of the anchors may be disposed in a floor, ceiling, wall, and/or mullion of a building. There may be at least 1, 2, 3, 4, 5, 8, or 10 anchors disposed in the enclosure (e.g., in the room, in the building, and/or in the facility). At least two of the anchors may have at least of (e.g., substantially) the same X coordinate, Y coordinate, and Z coordinate (of a Cartesian coordinate system).

In some embodiments, a window control system enables locating and/or tracking one or more devices (e.g., comprising auto-location technology such as the micro location chip) and/or at least one user carrying such device. The relative location between two or more such devices can be determined from information relating to received transmissions, e.g., at one or more antennas and/or sensors. The location of the device may comprise geo-positioning and/or geolocation. The location of the device may an analysis of electromagnetic signals emitted from the device and/or the micro-location chip. Information that can be used to determine location includes, e.g., the received signal strength, the time of arrival, the signal frequency, and/or the angle of arrival. When determining a location of the one or more components from these metrics, a localization (e.g., using trilateration such as triangulation) module may be implemented. The localization module may comprise a calculation and/or algorithm. The auto-location may comprise geolocation and/or geo-positioning. Examples of location methods may be found in International Patent Application Serial No. PCT/US17/31106, filed May 4, 2017, titled “WINDOW ANTENNAS,” which is incorporated herein by reference in its entirety.

In some embodiments, the position of the user may be located using one or more positional sensors. The positional sensor(s) may be disposed in the enclosure (e.g., facility, building, or room). The positional sensor may be part of a sensor ensemble or separated from a sensor ensemble (e.g., standalone positional sensor). The positional sensor may be operatively (e.g., communicatively) coupled to a network. The network may be a network of the facility (e.g., of the building). The network may be configured to transmit communication and power. The network may be any network disclosed herein. The network may extend to a room, a floor, several rooms, several floors, the building, or several buildings of the facility. The network may operatively (e.g., to facilitate power and/or communication) couple to a control system (e.g., as disclosed herein), to sensor(s), emitter(s), antenna, router(s), power supply, building management system (and/or its components). The network may be coupled to personal computers of users (e.g., occupants) associated with the facility (e.g., employees and/or tenants). At least part of the network may be installed as the initial network of the facility, and/or disposed in an envelope structure of the facility. The users may or may not be present in the facility. The personal computers of the users may be disposed remote from the facility. The network may be operatively coupled to other devices in the facility that perform operations for, or associated with, the facility (e.g., production machinery, communication machinery, and/or service machinery). The production machinery may include computers, factory related machinery, and/or any other machinery configured to produce product(s) (e.g., printers and/or dispensers). The service machinery may include food and/or beverage related machinery, hygiene related machinery (e.g., mask dispenser, and/or disinfectant dispensers). The communication machinery may include media projectors, media display, touch screens, speakers, and/or lighting (e.g., entry, exit, and/or security lighting).

In some embodiments, a position of a user within an enclosure (e.g., facility comprising building, room, or the like) is used in connection with user feedback regarding one or more devices associated with the enclosure. The one or more devices may be identified based at least in part on the position of the user. The one or more devices may be identified as one or more devices proximate to a detected and/or identified position of the user within the enclosure. By way of example, in an instance in which user feedback is received regarding a current temperature within an enclosure, a current light level within the enclosure, etc.; one or more controllable devices (e.g., one or more tintable windows, one or more HVAC components, or the like) may be identified that, when controlled (e.g., when a state of the one or more controllable devices is changed), modify an atmosphere and/or state of the enclosure in accordance with the received user feedback. Changes to states of the one or more controllable devices identified based at least in part on an identified and/or detected position of the user may be determined based at least in part on one or more machine learning models. The machine learning models may be prescriptive models and/or behavioral models. The behavioral models may include models that learn user preferences based on direct and/or indirect user feedback. The prescriptive models may include models that utilize: sensor data, scheduling information, weather information, explicit user preferences, and/or any suitable combination thereof.

In some embodiments, at least one device ensemble includes at least one processor and/or memory. The processor may perform computing tasks (e.g., including machine learning and/or artificial intelligence related tasks). In this manner the network can allow low latency (e.g., as disclosed herein) and faster response time for applications and/or commands. In some embodiments, the network and circuitry coupled thereto may form a distributed computing environment (e.g., comprising CPU, memory, and storage) for application and/or service hosting to store and/or process content close to the user's mobile circuitry (e.g., cellular device, pad, or laptop).

In some embodiments, the network is coupled to device ensemble(s). The device ensemble may perform (e.g., in real time) sensing and/or tracking of occupants in an enclosure in which the device ensemble is disposed (e.g., in situ), e.g., (i) to enable seamless connectivity of the user's mobile circuitry to the network and/or adjustment of network coupled machinery to requirements and/or preferences of the user, (ii) to identify the user (e.g., using facial recognition, speech recognition, and/or identification tag), and/or (iii) to cater the environment of the enclosure according to any preferences of the user. For example, when a meeting organizer enters into an allocated meeting room, the organizer may be recognized by one or more sensors (e.g., using facial recognition and/or ID tag), presentation of the organizer may appear on screens of the meeting room and/or of screens of processors of the invitees. The screen may be controlled (e.g., remotely by the organizer or invitees, e.g., as disclosed herein). The invitees can be in the meeting room, or remote. The organizer can connect to an assistant via the network. The assistant can be real or virtual (e.g., digital office assistant). The organizer can place one or more requests to the assistant, which requests may be satisfied by the assistant. The requests may require communication and/or control using the network. For example, the request may be retrieval of a file and/or file manipulation (e.g., during the meeting). The request may be altering a function controlled by the control system (e.g., dim the lights, cool the room environment, sound an alarm, shut doors of the facility, and/or halt operation of a factory machinery). The assistant (e.g., digital assistant) may take notes during the meeting (e.g., using speech recognition), schedule meetings, and/or update files. The assistant may analyze (e.g., read) emails and/or replies to them. An occupant may interact with the assistant in a contactless (e.g., remote) manner, e.g., using gesture and/or voice interactions (e.g., as disclosed herein).

FIG. 25 shows an example of a building with device ensembles (e.g., assemblies, also referred to herein as “digital architectural elements”). As points of connection, the building can include multiple rooftop donor antennas 2505, 2505b as well as a sky sensor 2507 for sending electromagnetic radiation (e.g., infrared, ultraviolet, radio frequency, and/or visible light). These wireless signals may allow a building services network to wirelessly interface with one or more communications service provider systems. The building has a control panel 2513 for connecting to a provider's central office 2511 via a physical line 2509 (e.g., an optical fiber such as a single mode optical fiber). The control panel 2513 may include hardware and/or software configured to provide functions of, for example, a signal source carrier head end, a fiber distribution headend, and/or a (e.g., bi-directional) amplifier or repeater. The rooftop donor antennas 2505a and 2505b can allow building occupants and/or devices to access a wireless system communications service of a (e.g., 3^{rd} party) provider. The antenna and/or controller(s) may provide access to the same service provider system, a different service provider system, or some variation such as two interface elements providing access to a system of a first service provider, and a different interface element providing access to a system of a second service provider.

As shown in the example of FIG. 25, a vertical data plane may include a (e.g., high capacity, or high-speed) data carrying line 2519 such as (e.g., single mode) optical fiber or UTP copper lines (of sufficient gauge). In some embodiments, at least one control panel could be provided on at least part of the floors of the building (e.g., on each floor). In some embodiments, one (e.g., high capacity) communication line can directly connect a control panel in the top floor with (e.g., main) control panel 2513 in the bottom floor (or in the basement floor). Note that in the example shown in FIG. 25, control panel 2517 directly connects to rooftop antennas 2505a, 2505b and/or sky sensor 2507, while control panel 2513 directly connects to the (e.g., 3^{rd} party) service provider central office 2511.

FIG. 25 shows an example of a horizontal data plane that may include one or more of the control panels and data carrying wiring (e.g., lines), which include trunk lines 2521. In certain embodiments, the trunk lines comprise (e.g., are made from) coaxial cable. The trunk lines may comprise any wiring disclosed herein. The control panels may be configured to provide data on the trunk lines 2521 via a data communication protocol (such as MoCA and/or d.hn). The data communication protocol may comprise (i) a next generation home networking protocol (abbreviated herein as “G.hn” protocol), (ii) communications technology that transmits digital information over power lines that traditionally used to (e.g., only) deliver electrical power, or (iii) hardware devices designed for communication and transfer of data (e.g., Ethernet, USB and Wi-Fi) through electrical wiring of a building. The data transfer protocols may facilitate data transmission rates of at least about 1 Gigabits per second (Gbit/s), 2 Gbit/s, 3 Gbit/s, 4 Gbit/s, or 5 Gbit/s. The data transfer protocol may operate over telephone wiring, coaxial cables, power lines, and/or (e.g., plastic) optical fibers. The data transfer protocol may be facilitated using a chip (e.g., comprising a semiconductor device). At least one (e.g., each) horizontal data plane may provide high speed network access to one or more device ensembles such as 2523 (e.g., a set of one or more devices in a housing comprising an assembly of devices) and/or antennas (e.g., 2525), some or all of which are optionally integrated with device ensembles. The antennas (and associated radios, not shown) may be configured to provide wireless access by any of various protocols, including, e.g., cellular (e.g., one or more frequency bands at or proximate 28 GHZ), Wi-Fi (e.g., one or more frequency bands at 2.4, 5, and 60 GHZ), CBRS, and the like. Drop lines may connect device ensembles (e.g., 2523) to trunk lines (e.g., 2521). In some embodiments, a horizontal data plane is deployed on a floor of a building. The devices in the device ensemble may comprise a sensor, emitter, or antenna. The device ensemble may comprise circuitry. The devices in the device ensemble may be operatively coupled to the circuitry. The circuitry may comprise a processor. The circuitry may be operatively coupled to memory and/or communication hub (e.g., ethernet and/or cellular communication). One or more donor antennas (e.g., 2505a, 2505b) may connect to the control panel (e.g., 2513) via high speed lines (e.g., single mode optical fiber or copper). In the depicted example of FIG. 25, the control panel 2513 is located in a lower floor of the building. The connection to the donor antenna(s) may be via one or more vRAN radios and wiring (e.g., coaxial cable).

In the example shown in FIG. 25, the communications service provider central office 2511 connects to ground floor control panel 2513 via a high speed line 2509 (e.g., an optical fiber serving as part of a backhaul). This entry point of the service provider to the building is sometimes referred to as a Main Point of Entry (MPOE), and it may be configured to permit the building to distribute both voice and data traffic.

In some cases, a small cell system is made available to a building, at least in part, via one or more antennas. Examples of antennas, sky sensor, and control systems can be found in U.S. patent application Ser. No. 15/287,646, filed Oct. 6, 2016, titled “MULTI-SENSOR DEVICE AND SYSTEM WITH A LIGHT DIFFUSING ELEMENT AROUND A PERIPHERY OF A RING OF PHOTOSENSORS AND AN INFRARED SENSOR,” which is incorporated herein by reference in its entirety.

In some embodiments, the target apparatus is operatively coupled to the network. The network may be operatively (e.g., communicatively) coupled to one or more controllers. The network may be operatively (e.g., communicatively) coupled to one or more processors. Coupling of the target apparatus to the network may allow contactless communication of a user with the target apparatus using a mobile circuitry of the user (e.g., through a software application installed on the mobile circuitry). In this manner, a user need not directly communicatively couple and decouple from the service device (e.g., using Bluetooth technology). By coupling the target apparatus to the network to which the user is communicatively coupled (e.g., through the mobile circuitry of the user), a user may be communicatively couple to a plurality of target apparatuses simultaneously (e.g., concurrently). The user may control at least two of the plurality of target apparatuses sequentially. The user may control at least two of the plurality of target apparatuses simultaneously (e.g., concurrently). For example, a user may have two applications of two different target apparatuses open (e.g., and running) on his mobile circuitry, e.g., available for control (e.g., manipulation).

In some example, the discovery of target apparatus by a user is not restricted by a range. The discovery of target apparatus by a user can be restricted by at least one security protocol (e.g., dangerous manufacturing machinery may be available only to permitted manufacturing personnel). The security protocol can have one or more security levels. The discovery of target apparatus by a user can be restricted by apparatuses in a room, floor, building, or facility in which the user is located. The user may override at least one (e.g., any) range restriction and select the target apparatus from all available target apparatuses.

In some embodiments, the target apparatus is communicatively coupled to the network. The target device may utilize a network authentication protocol. The network authentication protocol may open one or more ports for network access. The port(s) may be opened when an organization and/or a facility authenticates (e.g., through network authentication) an identity of a target apparatus that attempts to operatively couple (and/or physically couples) to the network. Operative coupling may comprise communicatively coupling. The organization and/or facility may authorize (e.g., using the network) access of the target apparatus to the network. The access may or may not be restricted. The restriction may comprise one or more security levels. The identity of the target apparatus can be determined based on the credentials and/or certificate. The credentials and/or certificate may be confirmed by the network (e.g., by a server operatively coupled to the network). The authentication protocol may or may not be specific for physical communication (e.g., Ethernet communication) in a local area network (LAN), e.g., that utilizes packets. The standard may be maintained by the Institute of Electrical and Electronics Engineers (IEEE). The standard may specify the physical media (e.g., target apparatus) and/or the working characteristics of the network (e.g., Ethernet). The networking standard may support virtual LANs (VLANs) on a local area (e.g., Ethernet) network. The standard may support power over local area network (e.g., Ethernet). The network may provide communication over power line (e.g., coaxial cable). The power may be direct current (DC) power. The power may be at least about 12 Watts (W), 15 W, 25W, 30W, 40W, 48W, 50W, or 100W. The standard may facilitate mesh networking. The standard may facilitate a local area network (LAN) technology and/or wide area network (WAN) applications. The standard may facilitate physical connections between target apparatuses and/or infrastructure devices (hubs, switches, routers) by various types of cables (e.g., coaxial, twisted wires, copper cables, and/or fiber cables). Examples of network authentication protocols can be 802.1 X, or KERBEROS. The network authentication protocol may comprise secret-key cryptography. The network can support (e.g., communication) protocols comprising 802.3, 802.3af (PoE), 802.3at (PoE+), 802.1Q, or 802.11s. The network may support a communication protocol for Building Automation and Control (BAC) networks (e.g., BACnet). The protocol may define service(s) used to communicate between building devices. The protocol services may include device and object discovery (e.g., Who-Is, I-Am, Who-Has, and/or I-Have). The protocol services may include Read-Property and Write-Property (e.g., for data sharing). The network protocol may define object types (e.g., that are acted upon by the services). The protocol may define one or more data links/physical layers (e.g., ARCNET, Ethernet, BACnet/IP, BACnet/IPv6, BACnet/MSTP, Point-To-Point over RS-232, Master-Slave/Token-Passing over RS-485, ZigBee, and/or LonTalk). The protocol may be dedicated to devices (e.g., Internet of Things (IoT) devices and/or machine to machine (M2M) communication). The protocol may be a messaging protocol. The protocol may be a publish-subscribe protocol. The protocol may be configured for messaging transport. The protocol may be configured for remote devices. The protocol may be configured for devices having a small code footprint and/or minimal network bandwidth. The small code footprint may be configured to be handled by microcontrollers. The protocol may have a plurality of quality of service levels including (i) at most once, (ii) at least once, and/or (iii) exactly once. The plurality of quality of service levels may increase reliability of the message delivery in the network (e.g., to its target). The protocol may facilitate messaging (i) between device to cloud and/or (ii) between cloud to device. The messaging protocol is configured for broadcasting messages to groups of targets such as target apparatuses (e.g., devices), sensors, and/or emitters. The protocol may comply with Organization for the Advancement of Structured Information Standards (OASIS). The protocol may support security schemes such as authentication (e.g., using tokens). The protocol may support access delegation standard (e.g., OAuth). The protocol may support granting a first application (and/or website) access to information on a second application (and/or website) without providing the second with a security code (e.g., token and/or password) relating to the first application. The protocol may be a Message Queuing Telemetry Transport (MQTT) or Advanced Message Queuing Protocol (AMQP) protocol. The protocol may be configured for a message rate of at least one (1) message per second per publisher. The protocol may be configured to facilitate a message payload size of at most 64, 86, 96, or 128 bytes. The protocol may be configured to communicate with any device (e.g., from a microcontroller to a server) that operates a protocol compliant (e.g., MQTT) library and/or connects to compliant broker (e.g., MQTT broker) over a network. Each device (e.g., target apparatus, sensor, or emitter) can be a publisher and/or a subscriber. A broker can handle millions of concurrently connected devices, or less than millions. The broker can handle at least about 100, 10000, 100000, 1000000, or 10000000 concurrently connected devices. In some embodiments, the broker is responsible for receiving (e.g., all) messages, filtering the messages, determining who is interested in each message, and/or sending the message to these subscribed device (e.g., broker client). The protocol may require internet connectivity to the network. The protocol may facilitate bi-directional, and/or synchronous peer-to-peer messaging. The protocol may be a binary wire protocol. Examples of such network protocol, control system, and network can be found in U.S. Provisional Patent Application Ser. No. 63/000,342, filed Mar. 26, 2020, titled “MESSAGING IN A MULTI CLIENT NETWORK,” which is incorporated herein by reference in its entirety.

Examples of network security, communication standards, communication interface, messaging, coupling of devices to the network, and control can be found in U.S. Provisional Patent Application Ser. No. 63/000,342, and in International Patent Application Serial No. PCT/US20/70123, filed Jun. 4, 2020, titled “SECURE BUILDING SERVICES NETWORK,” each of which is incorporated herein by reference in its entirety.

In some embodiments, the network allows a target apparatus to couple to the network. The network (e.g., using controller(s) and/or processor(s)) may let the target apparatus join the network, authenticate the target apparatus, monitor activity on the network (e.g., activity relating to the target apparatus), facilitate performance of maintenance and/or diagnostics, and secure the data communicated over the network. The security levels may allow bidirectional or monodirectional communication between a user and a target apparatus. For example, the network may allow only monodirectional communication of the user to the target apparatus. For example, the network may restrict availability of data communicated through the network and/or coupled to the network, from being accessed by a third party owner of a target apparatus (e.g., service device). For example, the network may restrict availability of data communicated through the network and/or coupled to the network, from being accessed by the organization and/or facility into data relating to a third party owner and/or manufacturer of a target apparatus (e.g., service device).

In some embodiments, the control system is operatively coupled to a learning module. The learning module may utilize a learning scheme, e.g., comprising artificial intelligence. The learning module may be learn preference of one or more users associated with the facility. Users associated with the facility may include occupants of the facility and/or users associated with an entity residing and/or owning the facility (e.g., employees of a company residing in the facility). The learning modules may analyze preference of a user or a group of users. The learning module may gather preferences of the user(s) as to one or more environmental characteristic. The learning module may use past preference of the user as a learning set for the user or for the group to which the user belongs. The preferences may include environmental preference or preferences related to a target apparatus (e.g., service machine, and/or production machine). In some embodiments, a control system conditions various aspects of an enclosure.

For example, the control system may condition an environment of the enclosure. The control system may project future environmental preferences of the user, and condition the environment to these preferences in advance (e.g., at a future time). The preferential environmental characteristic(s) may be allocated according to (i) user or group of users, (ii) time, (iii) date, and/or (iv) space. The data preferences may comprise seasonal preferences. The environmental characteristics may comprise lighting, ventilation speed, atmospheric pressure, smell, temperature, humidity, carbon dioxide, oxygen, VOC(s), particulate matter (e.g., dust), or color. The environmental characteristics may be a preferred color scheme or theme of an enclosure. For example, at least a portion of the enclosure can be projected with a preferred theme (e.g., projected color, picture or video). For example, a user is a heart patient and prefers (e.g., requires) an oxygen level above the ambient oxygen level (e.g., 20% oxygen) and/or a certain humidity level (e.g., 70%). The control system may condition the atmosphere of the environment for that oxygen and humidity level when the heart patient occupant is in a certain enclosure (e.g., by controlling the BMS).

In some embodiments, a control system may operate a target apparatus according to preference of a user or a group of users. The preferences may be according to past behavior of the user(s) in relation to the target apparatus (e.g., settings, service selection, timing related selections, and/or location related selections). For example, a user may refer coffee late with 1 teaspoon of sugar at 9 am from the coffee machine near his desk at a first location. The coffee machine at the first location may automatically generate a cup of such coffee at 9 am in the first location. For example, a user group such as a work-team prefers to enter a conference room having a forest background, with a light breeze at 22° C. The control system may control project the forest background (e.g., on a wall and/or on a media screen), adjust the ventilation system to have a light breeze, and adjust the HVAC system for 22° C. in every conference room when this group is holding a meeting. The control system may facilitate such control by controlling the HVAC system, projector, and/or media display.

In some embodiments, the control system may adjust the environment and/or target apparatus according to hierarchical preferences. When several different users (e.g., of different groups) are gathered in an enclosure, which users have conflicting preferences, the control system may adjust the environment and/or target apparatus according to a pre-established hierarchy. The hierarchy may comprise jurisdictional (e.g., health and/or safety) standards, health, safety, employee rank, activity taking place in the enclosure, number of occupants in the enclosure, enclosure type, time of day, date, season, and/or activity in the facility.

In some embodiments, the control system considers results (e.g., scientific and/or research based results) regarding environmental conditions that affect health, safety and/or performance of enclosure occupants. The control system may establish thresholds and/or preferred window-ranges for one or more environmental characteristic of the enclosure (e.g., of an atmosphere of the enclosure). The threshold may comprise a level of atmospheric component (e.g., VOC and/or gas), temperature, and time at a certain level. The certain level may be abnormally high, abnormally low, or average. For example, the controller may allow short instances of abnormally high VOC level, but not prolonged time with that VOC level. The control system may automatically override preference of a user if it contradicts health and/or safety thresholds. Health and/or safety thresholds may be at a higher hierarchical level relative to a user's preference. The hierarchy may utilize majority preferences. For example, if two occupants of a meeting room have one preference, and the third occupant has a conflicting preference, then the preferences of the two occupants will prevail (e.g., unless they conflict health and/or safety considerations).

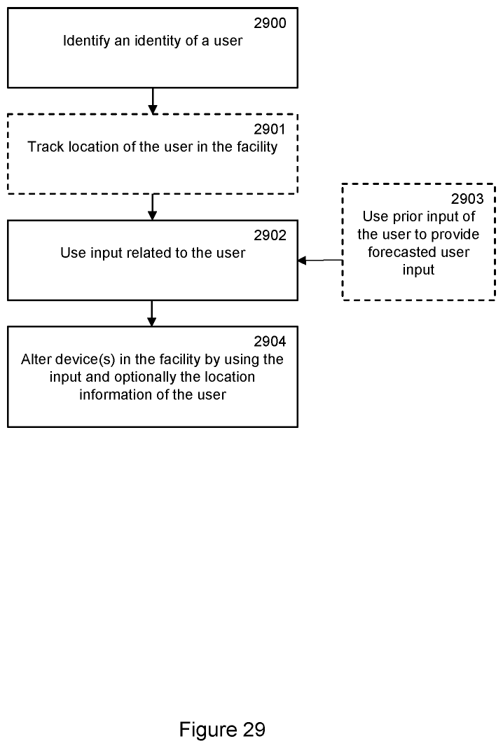

FIG. 29 shows an example of a flow chart depicting operations of a control system that is operatively coupled to one or more devices in an enclosure (e.g., a facility). In block 2900 an identify of a user is identified by a control system. The identity can be identified by one or more sensors (e.g., camera) and/or by an identification tag (e.g., by scanning or otherwise sensing by one or more sensors). In optional block 2901, a location of the user may optionally be tracked as the user spends time in the enclosure. The use may provide input as to any preference. The preference may be relating to a target apparatus, and/or environmental characteristics. A learning module may optionally track such preferences and provide predictions as to any future preference of the user in optional block 2903. Past elective preferences by the user may be recorded (e.g., in a database) and may be used as a learning set for the learning module. As the learning process progress over time and the user provides more and more inputs, the predictions of the learning module may increase in accuracy. The learning module may comprise any learning scheme (e.g., comprising artificial intelligence and/or machine learning) disclosed herein. The user may override recommendations and/or predictions made by the learning module. The user may provide manual input into the control system. In block 2902, the user input is provided (whether directly by the user or by predictions of the learning module) to the control system. In block 2904, the control system may alter (or direct alteration of) one or more devices in the facility to materialize the user preferences (e.g., input) by using the input. The control system may or may not use location of the user. The location may be a past location or a current location. For example, the user may enter a workplace by scanning a tag. Scanning of the identification tag (ID tag) can inform the control system of an identify of the user, and the location of the user at the time of scanning. The user may express a preference for a sound of a certain level that constitutes the input. The expression of preference may be by manual input (including tactile, voice and/or gesture command). A past expression of preference may be registered in a database and linked to the user. The user may enter a conference room at a prescheduled time. The sound level in the conference room may be adjusted to the user preference (i) when the prescheduled meeting was scheduled to initiate and/or (ii) when one or more sensors sense presence of the user in the meeting room. The sound level in the conference room may be return to a default level and/or adjusted to another's preference (i) when the prescheduled meeting was scheduled to end and/or (ii) when one or more sensors sense absence of the user in the meeting room.

In some embodiments, a user expresses at least one preference environmental characteristic(s) and/or target apparatus, which preference constitutes an input. The input may be by manual input (including tactile, voice and/or gesture command). A past expression of preference (e.g., input) may be registered in a database and linked to the user. The user may be part of a group of users. The group of users may be any grouping disclosed herein. The preference of the user may be linked to the group to which the user belongs. The user may enter an enclosure at a prescheduled time. The environmental characteristic(s) of the enclosure may be adjusted to the user preference (i) when the user was scheduled to enter the enclosure and/or (ii) when one or more sensors sense presence of the user in the enclosure. The environmental characteristic(s) of the enclosure may be return to a default level and/or adjusted to another's preference (i) when the scheduled presence of the user in the enclosure terminates and/or (ii) when one or more sensors sense absence of the user in the enclosure. The target apparatus may be adjusted to the user preference (i) when the user was scheduled to use the target apparatus and/or (ii) when one or more sensors sense presence of the user near the target apparatus (e.g., within a predetermined distance threshold). The target apparatus may return to default setting or be adjusted to another's preference (i) when the scheduled use of the target apparatus by the user ends and/or (ii) when one or more sensors sense absence of the user near the target apparatus (e.g., within a predetermined distance threshold).

In some embodiments, data is analyzed by a learning module. The data can be sensor data and/or user input. The user input may be regarding one or more preferred environmental characteristic and/or target apparatus. The learning module may comprise at least one rational decision making process, and/or learning that utilizes the data (e.g., as a learning set). The analysis of the data may be utilized to adjust and environment, e.g., by adjusting one or more components that affect the environment of the enclosure. The analysis of the data may be utilized to control a certain target apparatus, e.g., to produce a product, according to user preferences, and/or choose the certain target apparatus (e.g., based on user preference and/or user location). The data analysis may be performed by a machine based system (e.g., comprising a circuitry). The circuitry may be of a processor. The sensor data analysis may utilize artificial intelligence. The data analysis may rely on one or more models (e.g., mathematical models). In some embodiments, the data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, or generalized linear model (GLM) technique. The data analysis may include a deep learning algorithm and/or artificial neural networks (ANN). The data analysis may comprise a learning schemes with a plurality of layers in the network (e.g., ANN). The learning of the learning module may be supervised, semi-supervised, or unsupervised. The learning module may comprise statistical methodologies. The deep learning architecture may comprise deep neural networks, deep belief networks, recurrent neural networks, or convolutional neural networks. The learning schemes may be ones utilized in computer vision, machine vision, speech recognition, natural language processing, audio recognition, social network filtering, machine translation, bioinformatics, drug design, medical image analysis, material inspection programs, and/or board game programs.

In some examples, a target apparatus is a tintable window (e.g., an electrochromic window). In some embodiments, a dynamic state of an electrochromic window is controlled by altering a voltage signal to an electrochromic device (ECD) used to provide tinting or coloring. An electrochromic window can be manufactured, configured, or otherwise provided as an insulated glass unit (IGU). IGUs may serve as the fundamental constructs for holding electrochromic panes (also referred to as “lites”) when provided for installation in a building. An IGU lite or pane may be a single substrate or a multi-substrate construct, such as a laminate of two substrates. IGUs, especially those having double- or triple-pane configurations, can provide a number of advantages over single pane configurations; for example, multi-pane configurations can provide enhanced thermal insulation, noise insulation, environmental protection and/or durability when compared with single-pane configurations. A multi-pane configuration also can provide increased protection for an ECD, for example, because the electrochromic films, as well as associated layers and conductive interconnects, can be formed on an interior surface of the multi-pane IGU and be protected by an inert gas fill in the interior volume of the IGU.

In some embodiments, a tintable window exhibits a (e.g., controllable and/or reversible) change in at least one optical property of the window, e.g., when a stimulus is applied. The stimulus can include an optical, electrical and/or magnetic stimulus. For example, the stimulus can include an applied voltage. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through them. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as micro-shutters), or any technology known now, or later developed, that is configured to control light transmission through a window. Examples of windows (e.g., with MEMS devices for tinting) are described in U.S. patent application Ser. No. 14/443,353, filed May 15, 2015, titled “MULTI-PANE WINDOWS INCLUDING ELECTROCHROMIC DEVICES AND ELECTROMECHANICAL SYSTEMS DEVICES,” that is incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD, or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g., noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g. cations) into the oxide may induce a visible change in a tint (e.g., color) of the oxide. For example, the oxide may transition from a colorless to a colored state. For example, intercalation of lithium ions into tungsten oxide (WO3-y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

FIG. 23 shows an example of a schematic cross-section of an electrochromic device 2300 in accordance with some embodiments. The EC device coating is attached to a substrate 2302, a transparent conductive layer (TCL) 2304, an electrochromic layer (EC) 2306 (sometimes also referred to as a cathodically coloring layer or a cathodically tinting layer), an ion conducting layer or region (IC) 2308, a counter electrode layer (CE) 2310 (sometimes also referred to as an anodically coloring layer or anodically tinting layer), and a second TCL 2314. Elements 2304, 2306, 2308, 2310, and 2314 are collectively referred to as an electrochromic stack 2320. A voltage source 2316 operable to apply an electric potential across the electrochromic stack 2320 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL. In various embodiments, the ion conductor region (e.g., 2308) may form from a portion of the EC layer (e.g., 2306) and/or from a portion of the CE layer (e.g., 2310). In such embodiments, the electrochromic stack (e.g., 2320) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725, filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 2320. Various layers, including transparent conducting layers (such as 2304 and 2314), can be treated with anti-reflective and/or protective layers (e.g., oxide and/or nitride layers).

In some embodiments, an IGU includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g. connect) one or more electrochromic devices to a voltage source, switches and the like, and may include a frame that supports the IGU or laminate. A window assembly may include a window controller, and/or components of a window controller (e.g., a dock).

FIG. 24 shows an example implementation of an IGU 2400 that includes a first pane 2404 having a first surface S1 and a second surface S2. In some implementations, the first surface S1 of the first pane 2404 faces an exterior environment, such as an outdoors or outside environment. The IGU 2400 also includes a second pane 2406 having a first surface S3 and a second surface S4. In some implementations, the second surface S4 of the second pane 2406 faces an interior environment, such as an inside environment of a home, building or vehicle, or a room or compartment within a home, building or vehicle.

In some embodiments, (e.g., each of the) first and/or the second panes 2404 and 2406 are transparent and/or translucent to light, e.g., in the visible spectrum. For example, (e.g., each of the) first and/or second panes 2404 and 2406 can be formed of a glass material (e.g., an architectural glass or other shatter-resistant glass material such as, for example, a silicon oxide (SOx)-based glass material. The (e.g., each of the) first and/or second panes 2404 and 2406 may be a soda-lime glass substrate or float glass substrate. Such glass substrates can be composed of, for example, approximately 75% silica (SiO₂) as well as Na₂O, CaO, and several minor additives. However, the (e.g., each of the) first and/or the second panes 2404 and 2406 can be formed of any material having suitable optical, electrical, thermal, and mechanical properties. For example, other suitable substrates that can be used as one or both of the first and the second panes 2404 and 2406 can include other glass materials as well as plastic, semi-plastic and thermoplastic materials (for example, poly(methyl methacrylate), polystyrene, polycarbonate, allyl diglycol carbonate, SAN (styrene acrylonitrile copolymer), poly(4-methyl-1-pentene), polyester, polyamide), and/or mirror materials. In some embodiments, (e.g., each of the) first and/or the second panes 2404 and 2406 can be strengthened, for example, by tempering, heating, or chemically strengthening.

In FIG. 24, first and second panes 2404 and 2406 are spaced apart from one another by a spacer 2418, which is typically a frame structure, to form an interior volume 2408. In some embodiments, the interior volume is filled with Argon (Ar) or another gas, such as another noble gas (for example, krypton (Kr) or xenon (Xn)), another (non-noble) gas, or a mixture of gases (for example, air). Filling the interior volume 2408 with a gas such as Ar, Kr, or Xn can reduce conductive heat transfer through the IGU 2400. Without wishing to be bound to theory, this may be because of the low thermal conductivity of these gases as well as improve acoustic insulation, e.g., due to their increased atomic weights. In some embodiments, the interior volume 2408 can be evacuated of air or other gas. Spacer 2418 generally determines the height “C” of the interior volume 2408 (e.g., the spacing between the first and the second panes 2404 and 2406). In FIG. 24, the thickness (and/or relative thickness) of the ECD, sealant 2420/2422 and bus bars 2426/2428 may not be to scale. These components are generally thin and are exaggerated here, e.g., for ease of illustration only. In some embodiments, the spacing “C” between the first and the second panes 2404 and 2406 is in the range of approximately 6 mm to approximately 30 mm. The width “D” of spacer 2418 can be in the range of approximately 5 mm to approximately 15 mm (although other widths are possible and may be desirable). Spacer 2418 may be a frame structure formed around all sides of the IGU 2400 (for example, top, bottom, left and right sides of the IGU 2400). For example, spacer 2418 can be formed of a foam or plastic material. In some embodiments, spacer 2418 can be formed of metal or other conductive material, for example, a metal tube or channel structure having at least 3 sides, two sides for sealing to each of the substrates and one side to support and separate the lites and as a surface on which to apply a sealant, 2424. A first primary seal 2420 adheres and hermetically seals spacer 2418 and the second surface S2 of the first pane 2404. A second primary seal 2422 adheres and hermetically seals spacer 2418 and the first surface S3 of the second pane 2406. In some implementations, each of the primary seals 2420 and 2422 can be formed of an adhesive sealant such as, for example, polyisobutylene (PIB). In some implementations, IGU 2400 further includes secondary seal 2424 that hermetically seals a border around the entire IGU 2400 outside of spacer 2418. To this end, spacer 2418 can be inset from the edges of the first and the second panes 2404 and 2406 by a distance “E.” The distance “E” can be in the range of approximately four (4) millimeters (mm) to approximately eight (8) mm (although other distances are possible and may be desirable). In some implementations, secondary seal 2424 can be formed of an adhesive sealant such as, for example, a polymeric material that resists water and that adds structural support to the assembly, such as silicone, polyurethane and similar structural sealants that form a water-tight seal.

In the example of FIG. 24, the ECD coating on surface S2 of substrate 2404 extends about its entire perimeter to and under spacer 2418. This configuration is functionally desirable as it protects the edge of the ECD within the primary sealant 2420 and aesthetically desirable because within the inner perimeter of spacer 2418 there is a monolithic ECD without any bus bars or scribe lines.

Configuration examples of IGUs are described in U.S. Pat. No. 8,164,818, issued Apr. 24, 2012, titled “ELECTROCHROMIC WINDOW FABRICATION METHODS” (Attorney Docket No. VIEWP006), U.S. patent application Ser. No. 13/456,056, filed Apr. 25, 2012, titled “ELECTROCHROMIC WINDOW FABRICATION METHODS” (Attorney Docket No.

VIEWP006 X1), International Patent Application Serial No. PCT/US12/68817, filed Dec. 10, 2012, titled “THIN-FILM DEVICES AND FABRICATION” (Attorney Docket No. VIEWP036WO), U.S. Pat. No. 9,454,053, issued Sep. 27, 2016, titled “THIN-FILM DEVICES AND FABRICATION” (Attorney Docket No. VIEWP036US), and International Patent Application No. PCT/US14/73081, filed Dec. 13, 2014, titled “THIN-FILM DEVICES AND FABRICATION” (Attorney Docket No. VIEWP036 X1WO), each of which is hereby incorporated by reference in its entirety.

In the example shown in FIG. 24, an ECD 2410 is formed on the second surface S2 of the first pane 2404. The ECD 2410 includes an electrochromic (“EC”) stack 2412, which itself may include one or more layers. For example, the EC stack 2412 can include an electrochromic layer, an ion-conducting layer, and a counter electrode layer. The electrochromic layer may be formed of one or more inorganic solid materials. The electrochromic layer can include or be formed of one or more of a number of electrochromic materials, including electrochemically-cathodic or electrochemically-anodic materials. EC stack 2412 may be between first and second conducting (or “conductive”) layers. For example, the ECD 2410 can include a first transparent conductive oxide (TCO) layer 2414 adjacent a first surface of the EC stack 2412 and a second TCO layer 2416 adjacent a second surface of the EC stack 2412. An example of similar EC devices and smart windows can be found in U.S. Pat. No. 8,764,950, titled ELECTROCHROMIC DEVICES, by Wang et al., issued Jul. 1, 2014 and U.S. Pat. No. 9,261,751, titled ELECTROCHROMIC DEVICES, by Pradhan et al., issued Feb. 16, 2016, which is incorporated herein by reference in its entirety. In some implementations, the EC stack 2412 also can include one or more additional layers such as one or more passive layers. For example, passive layers can be used to improve certain optical properties, to provide moisture or to provide scratch resistance. These or other passive layers also can serve to hermetically seal the EC stack 2412.

In some embodiments, the selection or design of the electrochromic and counter electrode materials generally governs the possible optical transitions. During operation, in response to a voltage generated across the thickness of the EC stack (for example, between the first and the second TCO layers), the electrochromic layer transfers or exchanges ions to or from the counter electrode layer to drive the electrochromic layer to the desired optical state. To cause the EC stack to transition to a transparent state, a positive voltage may be applied across the EC stack (for example, such that the electrochromic layer is more positive than the counter electrode layer). In some embodiments, in response to the application of the positive voltage, the available ions in the stack reside primarily in the counter electrode layer. When the magnitude of the potential across the EC stack is reduced or when the polarity of the potential is reversed, ions may be transported back across the ion conducting layer to the electrochromic layer causing the electrochromic material to transition to an opaque state (or to a “more tinted,” “darker” or “less transparent” state). Conversely, in some embodiments using electrochromic layers having different properties, to cause the EC stack to transition to an opaque state, a negative voltage is applied to the electrochromic layer relative to the counter electrode layer. For example, when the magnitude of the potential across the EC stack is reduced or its polarity reversed, the ions may be transported back across the ion conducting layer to the electrochromic layer causing the electrochromic material to transition to a clear or “bleached” state (or to a “less tinted”, “lighter” or “more transparent” state).

In some implementations, the transfer or exchange of ions to or from the counter electrode layer also results in an optical transition in the counter electrode layer. For example, in some implementations the electrochromic and counter electrode layers are complementary coloring layers. More specifically, in some such implementations, when or after ions are transferred into the counter electrode layer, the counter electrode layer becomes more transparent, and similarly, when or after the ions are transferred out of the electrochromic layer, the electrochromic layer becomes more transparent. Conversely, when the polarity is switched, or the potential is reduced, and the ions are transferred from the counter electrode layer into the electrochromic layer, both the counter electrode layer and the electrochromic layer become less transparent.

In some embodiments, the transition of the electrochromic layer from one optical state to another optical state is caused by reversible ion insertion into the electrochromic material (for example, by way of intercalation) and a corresponding injection of charge-balancing electrons. For example, some fraction of the ions responsible for the optical transition may be irreversibly bound up in the electrochromic material. In some embodiments, suitable ions include lithium ions (Li+) and hydrogen ions (H+) (i.e., protons). In some other implementations, other ions can be suitable. Intercalation of lithium ions, for example, into tungsten oxide (WO_{3-y}(0<y≤˜0.3)) causes the tungsten oxide to change from a transparent state to a blue state.

In some embodiments, a tinting transition is a transition from a transparent (or “translucent,” “bleached” or “least tinted”) state to an opaque (or “fully darkened” or “fully tinted”) state. Another example of a tinting transition is the reverse (e.g., a transition from an opaque state to a transparent state). Other examples of tinting transitions include transitions to and from various intermediate tint states, for example, a transition from a less tinted, lighter or more transparent state to a more tinted, darker or less transparent state, and vice versa. Each of such tint states, and the tinting transitions between them, may be characterized or described in terms of percent transmission. For example, a tinting transition can be described as being from a current percent transmission (% T) to a target % T. Conversely, in some other instances, each of the tint states and the tinting transitions between them may be characterized or described in terms of percent tinting; for example, a transition from a current percent tinting to a target percent tinting.

In some embodiments, a voltage applied to the transparent electrode layers (e.g. across the EC stack) follows a control profile used to drive a transition in an optically switchable device. For example, a window controller can be used to generate and apply the control profile to drive an ECD from a first optical state (for example, a transparent state or a first intermediate state) to a second optical state (for example, a fully tinted state or a more tinted intermediate state). To drive the ECD in the reverse direction—from a more tinted state to a less tinted state—the window controller can apply a similar but inverted profile. In some embodiments, the control profiles for tinting and lightening can be asymmetric. For example, transitioning from a first more tinted state to a second less tinted state can in some instances require more time than the reverse; that is, transitioning from the second less tinted state to the first more tinted state. In some embodiments, the reverse may be true. Transitioning from the second less tinted state to the first more tinted state can require more time. By virtue of the device architecture and materials, bleaching or lightening may not necessarily (e.g., simply) the reverse of coloring or tinting. Indeed, ECDs often behave differently for each transition due to differences in driving forces for ion intercalation and deintercalation to and from the electrochromic materials.

FIG. 25 shows an example control profile 2500 as a voltage control profile implemented by varying a voltage provided to the ECD. For example, the solid line in FIG. 25 represents an effective voltage V_{Eff} applied across the ECD over the course of a tinting transition and a subsequent maintenance period. For example, the solid line can represent the relative difference in the electrical voltages V_{App1} and V_{App2} applied to the two conducting layers of the ECD. The dotted line in FIG. 25 represents a corresponding current (/) through the device. In the illustrated example, the voltage control profile 2500 includes four stages: a ramp-to-drive stage 2502 that initiates the transition, a drive stage that continues to drive the transition, a ramp-to-hold stage, and subsequent hold stage.

In FIG. 25, the ramp-to-drive stage 2502 is characterized by the application of a voltage ramp that increases in magnitude from an initial value at time t₀ to a maximum driving value of V_{Drive} at time t₁. For example, the ramp-to-drive stage 2502 can be defined by three drive parameters known or set by the window controller: the initial voltage at to (the current voltage across the ECD at the start of the transition), the magnitude of V_{Drive} (governing the ending optical state), and the time duration during which the ramp is applied (dictating the speed of the transition). The window controller may also set a target ramp rate, a maximum ramp rate or a type of ramp (for example, a linear ramp, a second degree ramp or an n^{th}-degree ramp). In some embodiments, the ramp rate can be limited to avoid damaging the ECD.

In FIG. 25, the drive stage 2504 includes application of a constant voltage V_{Drive} starting at time t₁ and ending at time t₂, at which point the ending optical state is reached (or approximately reached). The ramp-to-hold stage 2506 is characterized by the application of a voltage ramp that decreases in magnitude from the drive value V_{Drive} at time t₂ to a minimum holding value of V_{Hold} at time t₃. In some embodiments, the ramp-to-hold stage 2506 can be defined by three drive parameters known or set by the window controller: the drive voltage V_{Drive}, the holding voltage V_{Hold}, and the time duration during which the ramp is applied. The window controller may also set a ramp rate or a type of ramp (for example, a linear ramp, a second degree ramp or an n^{th}-degree ramp).

In FIG. 25, the hold stage 2508 is characterized by the application of a constant voltage V_{Hold} starting at time t₃. The holding voltage V_{Hold} may be used to maintain the ECD at the ending optical state. As such, the duration of the application of the holding voltage V_{hold} may be concomitant with the duration of time that the ECD is to be held in the ending optical state. For example, because of non-idealities associated with the ECD, a leakage current/Leak can result in the slow drainage of electrical charge from the ECD. Such a drainage of electrical charge can result in a corresponding reversal of ions across the ECD, and consequently, a slow reversal of the optical transition. The holding voltage V_{Hold} can be continuously applied to counter or prevent the leakage current. In some embodiments, the holding voltage V_{Hold} is applied periodically to “refresh” the desired optical state, or in other words, to bring the ECD back to the desired optical state.

The voltage control profile 2500 illustrated and described with reference to FIG. 25 is only one example of a voltage control profile suitable for some implementations. However, many other profiles may be desirable or suitable in such implementations or in various other implementations or applications. These other profiles also can readily be achieved using the controllers and optically switchable devices disclosed herein. For example, a current profile can be applied instead of a voltage profile. In some embodiments, a current control profile similar to that of the current density shown in FIG. 25 can be applied. In some embodiments, a control profile can have more than four stages. For example, a voltage control profile can include one or more overdrive stages. For example, the voltage ramp applied during the first stage 2502 can increase in magnitude beyond the drive voltage V_{Drive} to an overdrive voltage V_{OD}. The first stage 2502 may be followed by a ramp stage 2503 during which the applied voltage decreases from the overdrive voltage V_{OD} to the drive voltage V_{Drive}. In some embodiments, the overdrive voltage Von can be applied for a relatively short time duration before the ramp back down to the drive voltage V_{Drive}.

In some embodiments, the applied voltage or current profiles are interrupted for relatively short durations of time to provide open circuit conditions across the device. While such open circuit conditions are in effect, an actual voltage or other electrical characteristics can be measured, detected, or otherwise determined to monitor how far along an optical transition has progressed, and in some instances, to determine whether changes in the profile are desirable. Such open circuit conditions also can be provided during a hold stage to determine whether a holding voltage V_{Hold} should be applied or whether a magnitude of the holding voltage V_{Hold} should be changed. Examples related to controlling optical transitions is provided in International Patent Application Serial No. PCT/US14/43514, filed Jun. 20, 2014, titled “CONTROLLING TRANSITIONS IN OPTICALLY SWITCHABLE DEVICES,” which is hereby incorporated by reference in its entirety.

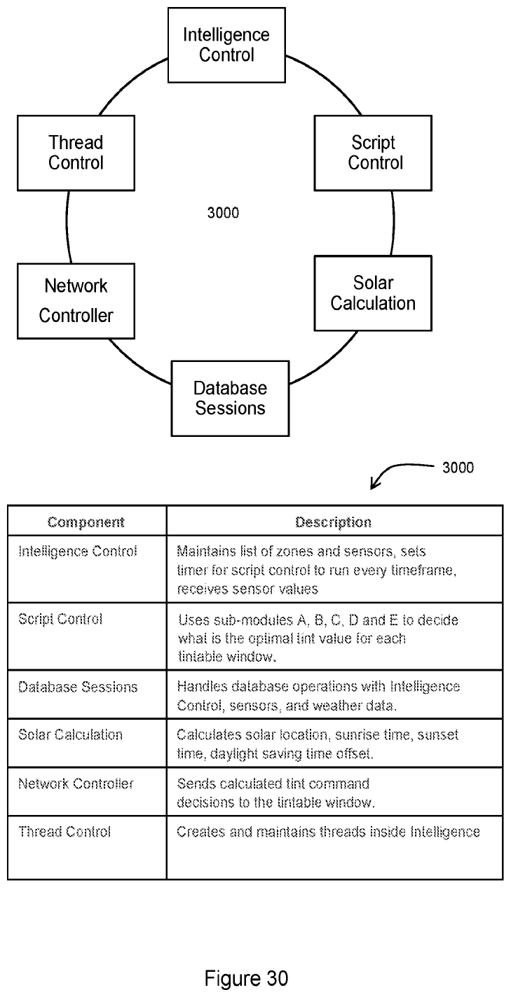

In some embodiments, the control system comprises logic. The logic may comprise one or more logic components (e.g., logic modules). For example, the logic may comprise at least 2, 3, 4, 5, 6, or 8 separate logic components. At least two of the separate logic components may interact with each other (e.g., complementary, symbiotically and/or synergistically). At least two of the logic components may function in parallel to each other. At least two of the separate logic components may merge to a combined logic component. FIG. 30 shows an example of control system 3000 that includes six separate logic components: (1) Intelligence Control, (2) Script control, (3) Solar Calculation, (4) Database Sessions, (5) Network controller, and (6) Thread control. Each of the separate logic components has a different role delineated in table 3001 as follows: The Intelligence control module maintains a list of zones and sensors, setts timer for script control to run every timeframe (e.g., 5 minutes), and obtains sensor values. The Script Control uses various sub-modules (e.g., A-E) to decide on an optimal tint value for each tintable window. The Database Sessions module handles database operations with the Intelligence Control module, sensors, and weather data. The Solar Calculation module calculates solar location, sunrise time, sunset time, and daylight saving time offset. The Network Controller module sends calculated tine-command decision to the tintable window. The Thread Control module creates and maintains threads in the Intelligence Control module. Examples for tintable windows, control system, sensors, artificial intelligence, and modules A, B, C, D, and E can be found in International Patent Application Serial No. PCT/US21/17603, filed Feb. 11, 2021, titled “PREDICTIVE MODELING FOR TINTABLE WINDOWS,” which is incorporated herein by reference in its entirety.

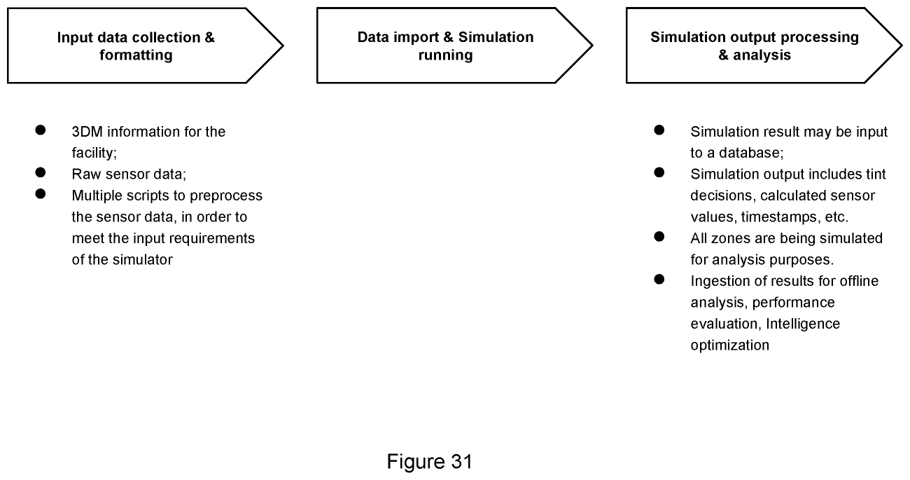

In some embodiments, the control system comprises, or is operatively coupled to a simulator. The simulator may include one or more operations. FIG. 31 shows an example of operations of the simulator comprising (1) Input data collection and formatting, (2) Data import and running the simulation, and (3) Simulation output processing and analysis. The input data may comprise a three dimensional (e.g., architectural) model of the facility, raw sensor data, and scripts to process the (e.g., raw) sensor data to facilitate the simulation. The simulation utilizes the input and runs on one or more processors. The simulation output comprises simulation results. The simulation results may be input to a database. The simulation output includes tint decisions, calculated sensor values, timestamps, and/or the like. In the example of FIG. 31, all zones are being simulated for analysis purposes. The results may be further analyzed offline such as performing evaluation, and optimization (e.g., for the Intelligence Control module).

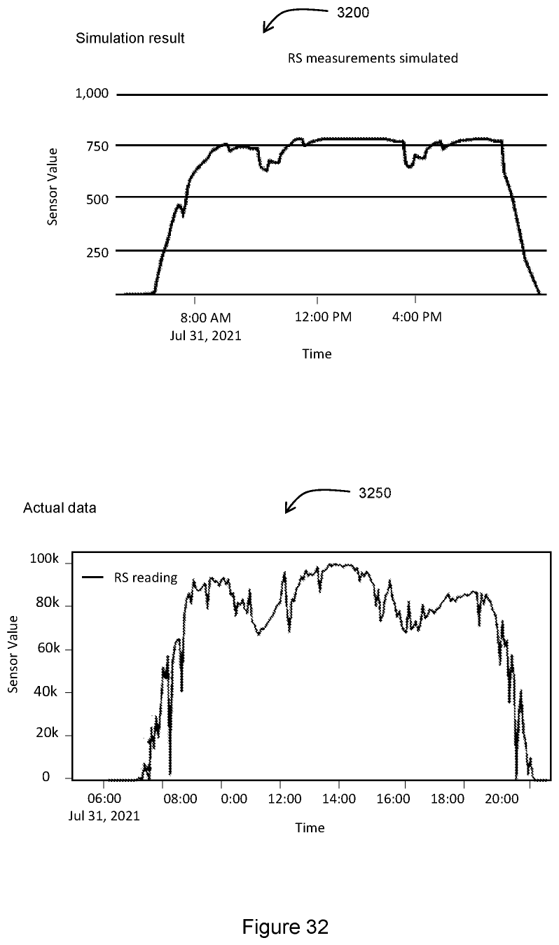

In some embodiments, behavior of one or more devices of the facility can be simulated. The devices can include any controllable device in a facility, for example, sensor (e.g., sensor reading), tintable windows, HVAC system, or any other device (e.g., such as any device disclosed herein). FIG. 32 shows an example of graphs depicting readings of a physical sensor, and simulated data, as a function of time. Graph 3200 shows a simulation of measurements for an infrared temperature sensor (e.g., RS sensor) for a time span on Jul. 31, 2021, before they were actually taken. Graph 3250 shows measurement of a physical infrared temperature sensor (e.g., RS sensor) taken at a time span on Jul. 31, 2021, as a comparison.

In some embodiments, the control system comprises the Intelligence Control logic component module (e.g., software module). In some embodiments, the Intelligence Control module is responsible for calculating and/or relaying tint decisions to one or more tintable windows. The Intelligence Control module may utilize data of two-dimensional and/or three-dimensional model of the facility (e.g., architectural model of the facility), facility zone data, solar data, sensor data (e.g., thermal data, sky sensor data), and weather data. In some embodiments, the Intelligence Control module calculates the optimal tint state and transfers the information to the Network Controller(s). The Intelligence Control module may maintain configuration, listing and/or databases (1) of building zone(s) and/or (2) of sensor(s), for example, the Intelligence Control module can maintain a list of all zones and sensors in the facility (e.g., and their corresponding attributes). In some embodiments, the Intelligence control module stores solar position and/or historical thermal data, to calculate the optimal tint state (e.g., used together with, or along, real-time sensor data). The sensor data may be queried every timeframe. The timeframe may be at most about every 0.5 minutes (min.), min., 2.5 min., 5 min, or 10 min. The timeframe may be at least about every 2.5 min., 5 min, or 10 min. 20 min., 30 min., 45 min., 60 min. or 120 min. The obtained sensor measurements (e.g., IR & RS measurements) may be adjusted through filtering and/or calibration. The filtering may comprise box car calibration. The filtering may comprise high pass or low pass filter. The Intelligence Control module may calculate the projected (e.g., recommended) tint state for a projected time. The final tint decision may be relayed (e.g., by the Intelligence Control module) to other component(s) of the control system such as to network controller(s), to effectuate a change in a status of a controllable device (e.g., change the tint of the tintable window).

In some embodiments, the Intelligence Control module may receive inputs. The inputs may include precomputed fields from a model of the facility structure. The model of the facility may comprise architectural modeling of the facility. The model of the facility may comprise a two dimensional (2D) or a three dimensional (3D) model. The model of the facility may comprise window mapping in the facility, tint mapping of windows in the facility, sensor mapping in the facility, sensor orientation relative to the facility and/or geographic location, window orientation with respect to the facility and/or geographic location, radiation penetration depth through a window into the facility, geographic configuration of the facility, or tint zone preferences. The inputs may include dynamic fields such as sensor data and/or weather data. The data may comprise sensor readings (e.g., for any sensor disclosed herein). The data may comprise weather data. The data may comprise infrared sensor readings, oriented light sensor readings, ambient temperature readings, solar elevation and azimuth, humidity readings, pressure readings, cloud coverage, wind speed, or wind direction.

In some embodiments, the Intelligence Control module has several configurable parameters. The configurable parameters may comprise thresholds for solar position, thresholds for solar penetration depth into the facility, (e.g., sky) sensor reading thresholds, weather condition settings, or facility configurations (e.g., to account for the external environment to the facility). The facility Configuration(s) may comprise pre-tinting parameters, or tint-delay timeframes. The Solar Position Configurations may comprise elevation values, Azimuth values, penetration depth thresholds of light into the facility, irradiance thresholds, time based thresholds (e.g., based at least in part on morning, noon, or evening). The thermal and/o Light Sensor Thresholds may comprise thermal radiation threshold, sensor-level threshold, sensor-to-tint level mapping, or sensor-data smoothing parameters. The dynamic weather conditions may comprise tint-state hold time, cloud-cover thresholds and offsets, bright tint to dark tint delta values, dark tint to bright tint delta values, or ambient temperature thresholds. Ambient temperature refers to a temperature of the surrounding environment. For example, ambient room temperature, refers to an average temperature in the room. For example, ambient temperature external to the facility, refers to an average temperature external to the facility.

In some embodiments, the control system is operatively coupled to, or includes, a simulation module component. The simulation module component may be referred to as “IntelliSim.” The simulation module may be used to identify parameterizations that resulted in certain occupant behaviors (such as overriding present or future decision of the control system). The simulation module may be used to understand and/or learn how the conditions leading to those occupant behaviors could be proactively remediated with preferential parameter configuration that would predict (with high accuracy) the behavior of the occupant of the facility. The occupant may be identified (e.g., automatically) by the simulation module, or may be self-identify themselves using a user input (e.g., through an app such as any of the apps disclosed herein). The simulation module may incorporate, or be operatively coupled to, a learning module. The learning module may utilize artificial intelligence (e.g., as disclosed herein). For example, the learning module may utilize artificial intelligence computational scheme. The simulation module may have one or more functions comprising: (1) simulate decisions regarding controllable state of a device for any facility based on real (e.g., sensor and/or user input) data, (2) ingests real sensor readings and structural (e.g., 3D or 2D) models for a given facility, (3) output Intelligence Control related decisions for a longer period in a shorter time, or (4) test, evaluate, and/or optimize Intelligence Control parameterization to simplify its control logic. The longer period of time may be at least about a day, a week, a month, a quarter, a semester, or a year. The longer period of time may be at least about a day, five days, a week, two weeks, a month, three months, four months, six months, or a year. The longer time may be any value between (inclusive) the aforementioned longer time values. The shorter period of time may be at most about 1 hour (h), 2 h, 3 h, 4 h, 5 h, 10 h, 20 h, or 24 h. The shorter period of time may be any value between (inclusive) the aforementioned shorter time values. For example, the simulation module may have one or more functions comprising: (1) simulate tint decisions for any facility based on real data, (2) ingests real sky sensor readings and 3D models for a given facility, (3) output all Intelligence Control related decisions for a prolonged period in a short time (e.g., for one week (all window zones) in about four hours), or (4) test, evaluate, and optimize Intelligence Control parameterization to simplify its control logic. The simulation module may simulate Intelligence Control decisions over the longer time frames for rapid iterative improvement. The simulation module may (e.g., automatically) identify and/or test Intelligence Control recipes for standard deployment types and verticals. The simulation module may inform and/or facilitate development of next generation (e.g., improvement to) Intelligence Control logic, behavior, and/or computational scheme. the simulation module may remediate on-site Intelligence issues with insight into impact of reparameterization related to the Intelligence Control module.

The simulation module may utilize (1) a list of zones and/or their current states (e.g., current state of the controllable device(s) in the zone), (2) a list of sensors and their attributes, (3) quarry sensors every time interval (e.g., five minutes), (3) utilized adjusted sensor values (e.g., filtered and/or calibrated values), (4) adjust (e.g., calibrate) sensor values in susceptible environmental conditions (e.g., adjust light and/or temperature sensors in conditions such as bright-to-dark and dark-to-bright), (5) operatively couple to a Solar Calculation module to calculate sun position at a (e.g., projected) time, (6) for each zone, call script control's functions to calculate the ideal state for each device in a zone (e.g., ideal tint state for a tintable window in a zone), (7) use zone map table to convert tint result to user preferred tint, and/or (8) operatively couple to a Network Controller module to set a target state command to the controllable device to transit or maintain the target state in the controllable device (e.g., set the target tint command to the tintable window). The simulation module (IntelliSim) may function to (a) maintain and/or use a list of zones, (b) maintain and/or use a list of devices in at least one (e.g., in each) zone, (c) maintain and/or use current state(s) of device(s) in at least one zone, (d) maintain and/or user a list of sensors and their attributes, (e) querry sensor measurements every time frame, (f) maintain and/or use filtered sensor values, (g) adjust sensor values in conditions identified as requiring adjustments, (h) operatively couple to external modules (e.g., Solar Calculation module to calculate sun position), (i) for at least one zone of the facility, call script control's functions to calculate the ideal state of the controllable device in the zone, (j) maintain and/or use zone map (or table) to convert controllable state (e.g., tint) result to user preferred state of the controllable device (e.g., preferred tint of the tintable window), (k) Call Network Controller modules to set the target state command to the controllable device, or (l) any combination thereof.

### Examples Embodiments

Clause 1: A method for controlling a facility, the method comprising: receiving an input from a user indicating that a first state of a device of the facility is to be altered to a second state, which input is received through a network; predicting a third state for the device at a future time at least in part by using a machine learning model that considers the input from the user; and (I) suggesting the third state and/or (II) conditioning the device to be at the third state at the future time.

Clause 2: The method of clause 1, wherein the input is received via an application executing on a user device of the user.

Clause 3: The method of clause 2, wherein suggesting the third state is to the user via the application executing on the user device.

Clause 4: The method of any one of clauses 1-3, wherein suggesting the third state comprises (a) suggesting conditioning the device to be at the third state at the future time and/or (b) suggesting conditioning the device to be at the third state at a plurality of future times responsive to determining that a set of conditions have occurred, which set of conditions are under which the input was received.

Clause 5: The method of clause 4, further comprising providing a user response to the suggestion to the machine learning model.

Clause 6: The method of any one of clauses 1-5, wherein the machine learning model constructs a training sample based at least in part on the input received, and wherein the training sample is usable to generate future predictions by the machine learning model.

Clause 7: The method of clause 6, wherein the facility is a first facility, wherein the user is a first user, and wherein the future predictions (i) are related to a second facility other than the first facility and/or (ii) are related to a second user other than the first user.

Clause 8: The method of any one of clauses 1-7, wherein the device is a tintable window.

Clause 9: The method of any one of clauses 1-8, wherein the device is an environmental conditioning system component, a security system component, a health system component, an electrical system component, a communication system component, and/or a personnel convection system component.

Clause 10: The method of clause 9, wherein the personnel convection system comprises an elevator.

Clause 11: The method of any one of clauses 9 or 10, wherein the environmental conditioning system comprises an HVAC component, or a lighting system component.

Clause 12: The method of any one of clauses 9-11, wherein the communication system comprises a transparent media display.

Clause 13: The method of any one of clauses 9-12, wherein the transparent media display (i) comprises a transparent organic light emitting diode array, and/or (ii) is operatively coupled to a tintable window.

Clause 14: The method of any one of clauses 1-13, wherein the input is indicative of a user request to override the first state of the device to the second state of the device.

Clause 15: The method of any one of clauses 1-14, wherein the input is received under a set of conditions, and wherein conditioning the device to be at the third state at the future time is responsive to detection of the set of conditions occurring at the future time.

Clause 16: The method of any one of clauses 1-15, wherein suggesting the third state comprises suggesting the third state to a user other than the user from whom the input was received.

Clause 17: The method of any one of clauses 1-16, wherein the third state is equal to the first state or the second state.

Clause 18: The method of any one of clauses 1-17, wherein the machine learning model considers the input at least in part by causing the device to be conditioned at the third state at the future time.

Clause 19: The method of any one of clauses 1-18, wherein the machine learning model considers the input at least in part by determining whether one or more parameters associated with the input match one or more parameters of (i) a rule-based pattern generated by the machine learning model and/or (ii) a heuristic used by the machine learning model.

Clause 20: The method of clause 19, wherein the one or more parameters comprise timing information, user identifier information, building type information associated with the facility, and/or sensor information.

Clause 21: The method of clause 20, wherein the sensor information is indicative of sun penetration depth, vertical and/or horizontal shadow, and/or light level.

Clause 22: The method of any one of clauses 20 or 21, wherein the sensor information is indicative of activity level and/or occupancy level, in an enclosure of the facility.

Clause 23: The method of any one of clauses 1-22, wherein the machine learning model further considers a location of the user within and/or relative to the facility.

Clause 24: The method of clause 23, wherein the location of the user within the facility is determined based at least in part on geolocation techniques, wherein the geolocation techniques optionally comprise radio frequency (RF) transmitting and/or sensing, and wherein the radio frequency optically comprises ultra-wideband (UWB) frequency.

Clause 25: The method of any one of clauses 23 or 24, wherein the device is identified based at least in part on the location of the user within the facility.

Clause 26: An apparatus for controlling a facility, the apparatus comprising at least one processor configured to (I) operatively couple to a network and ((II) execute, or direct execution of any of the methods of clauses 1-25.

Clause 27: An apparatus for controlling a facility, the apparatus comprising at least one processor configured to: operatively couple to a network; receive, or direct receipt of, an input from a user indicating that a first state of a device of the facility is to be altered to a second state, which input is received through the network; receive, or direct receipt of, information indicative of a predicted third state for the device at a future time, wherein the predicted third state is determined by a machine learning model that considers the input from the user; and (I) suggest, or direct suggesting, to transition the device to the third state to be presented to the user and/or (II) receive, or direct receipt of, an indication that the device has been conditioned to be at the third state.

Clause 28: A non-transitory computer-readable program instructions for controlling a facility, the non-transitory computer-readable program instructions, when read by one or more processors operatively coupled to a network, cause the one or more processors to execute operations comprising executing, or directing execution of, any of the methods of clauses 1-25.

Clause 29: A system for controlling a facility, the system comprising: a network configured to: operatively couple to a device of the facility; transmit an input from a user indicating that a first state of the device of the facility is to be altered to a second state, which input is received through the network; transmit a prediction of a third state for the device at a future time, wherein the prediction is determined at least in part by using a machine learning model that considers the input from the user; and transmit (I) a suggestion of the third state and/or (II) instructions that condition the device to be at the third state at the future time.

Clause 30: An apparatus for controlling a facility, the apparatus comprising at least one controller that is configured to: operatively couple to a device of the facility; condition, or direct conditioning of, the device of the facility to be in a first state of a plurality of state comprising the first state, a second state, and a third state; and condition, or direct conditioning of, the device to be at the third state at a future time, wherein the third state is predicted at the future time by a machine learning model that considers input from a user indicating that the first state of the device of the facility is to be altered to a second state, which input is received through a network.

Clause 31: A non-transitory computer-readable program instructions for controlling a facility, the non-transitory computer-readable program instructions, when read by one or more processors operatively coupled to the device of the facility, cause the one or more processors to execute operations comprising: operatively couple to a device of the facility; conditioning, or causing conditioning of, a device of the facility to be in a first state of a plurality of state comprising the first state, a second state, and a third state; and conditioning, or causing conditioning of, the device to be at the third state at a future time, wherein the third state is predicted at the future time by a machine learning model that considers input from a user indicating that the first state of the device of the facility is to be altered to a second state, which input is received through a network.

Clause 32: A method for controlling a facility, the method comprising: obtaining from a user an input indicative of a preference associated with a present state of a device of the facility under a set of conditions, which input is obtained through a network; updating a database to include the input of the user; identifying, based at least in part on the database, an action to be associated with the set of conditions; and transmitting through the network one or more signals associated with the action.

Clause 33: The method of clause 32, wherein the input comprises feedback from the user regarding the present state of the device.

Clause 34: The method of any one of clauses 32-33, wherein the action comprises conditioning the device to be at a future time at a different state other than the present state.

Clause 35: The method of any one of clauses 32-34, wherein the action comprises suggesting conditioning the device to be at a future time at a different state other than the present state.

Clause 36: The method of clause 35, wherein suggestion of the conditioning is provided to a user other than the user from whom the input is obtained.

Clause 37: The method of any one of clauses 32-36, wherein the action to be associated with the set of conditions is identified at least in part by identifying (i) a rule-based pattern and/or (ii) heuristic associated with the set of conditions.

Clause 38: The method of clause 37, wherein the set of conditions comprises timing information, user identifier information, building type information associated with the facility, and/or sensor information.

Clause 39: The method of clause 38, wherein the sensor information is indicative of sun penetration depth, vertical and/or horizontal shadow, and/or light level.

Clause 40: The method of any one of clauses 32-39, wherein the action is identified based at least in part on input obtained from a plurality of users other than the user.

Clause 41: The method of any one of clauses 32-40, wherein the action is identified based at least in part on input obtained in association with a plurality of enclosures of the facility, a plurality of facilities other than the facility, or any combination thereof.

Clause 42: The method of any one of clauses 32-41, wherein the device is a tintable window, and wherein the present state comprises a present tint level of the tintable window.

Clause 43: The method of clause 42, wherein the one or more signals transmitted through the network cause the tintable window to transition to a different tint level associated with the action identified.

Clause 44: The method of any one of clauses 32-43, wherein the device is: (i) an environmental conditioning system component, (ii) a security system component, (iii) a health system component, (iv) an electrical system component, (v) a communication system component, and/or (vi) a personnel convection system component.

Clause 45: The method of any one of clauses 32-44, further comprising: (I) obtaining a user response to the action identified; and (II) updating the database to include the user response to the action identified.

Clause 46: An apparatus for controlling a facility, the apparatus comprising at least one processor configured to: operatively couple to a device of the facility; obtain from a user, or direct obtainment of, an input indicative of a preference associated with a present state of the device of the facility under a set of conditions, which input is obtained through a network; transmit an indication of the input of the user, which transmission causes a database to be updated to include the input of the user; and receive one or more signals associated with an action, wherein the action is associated with the set of conditions, and wherein the action has been identified based at least in part on the database.

Clause 47: A non-transitory computer-readable program instructions for controlling a facility, the non-transitory computer-readable program instructions, when read by one or more processors operatively coupled to a network, cause the one or more processors to execute operations comprising executing, or directing execution of any of the methods of clauses 32-45.

Clause 48: A system for controlling a facility, the system comprising: a network configured to: operatively couple to a device of the facility; transmit an input obtained from a user, the input indicative of a preference associated with a present state of a device of the facility under a set of conditions, which input is obtained through the network; transmit an indication of the input to a database, which transmission causes the database to be updated to include the input of the user; transmit an identification of an action, wherein the action is associated with the set of conditions, and wherein the action is identified based at least in part on the database; and transmit one or more signals associated with the action.

Clause 49: An apparatus for controlling a facility, the apparatus comprising at least one controller configured to: operatively couple to a device of the facility; condition, or direct conditioning of, the device of the facility to a present state; and receive, or direct receipt of, one or more signals associated with an action, wherein the action is associated with a set of conditions and is identified based at least in part on a database, and wherein the action is identified in response to a user input indicative of a preference associated with the present state of the device of the facility under the set of conditions, which input is obtained through a network.

Clause 50: A non-transitory computer-readable program instructions for controlling a facility, the non-transitory computer-readable program instructions, when read by one or more processors, cause the one or more processors to execute operations comprising: operatively couple to a device of the facility; causing the device of the facility to be conditioned to a present state; and receiving, or directing receipt of, one or more signals associated with an action, wherein the action is associated with a set of conditions and is identified based at least in part on a database, and wherein the action is identified response to a user input indicative of a preference associated with the present state of the device of the facility under the set of conditions, which input is obtained through a network.

Clause 51: A method for controlling a facility, the method comprising: receiving an input from a user, which input is indicative of a preference associated with a state of a device of the facility, which input is received through a network; determining whether to alter the state of the device based at least in part (i) on the input and (ii) on a user permission scheme, which determination of whether to alter the state of the device results in a positive determination or in a negative determination; and using the positive determination to alter the state of the device.

Clause 52: The method of clause 51, wherein the input is a feedback on a recommended state of the device.

Clause 53: The method of any one of clauses 51-52, wherein the positive determination occurs in response to determining that the input indicates change of the state of the device of the facility and the user has permission to alter the state of the device.

Clause 54: The method of any one of clauses 51-53, wherein the negative determination occurs in response to determining that the input does not indicate a change in the state of the device of the facility and/or the user does not have permission to alter the present state of the device.

Clause 55: The method of any one of clauses 51-54, wherein the device is a tintable window, and wherein the state of the device comprises a tint state of the tintable window.

Clause 56: The method of any one of clauses 51-55, wherein in response to the determination of whether to alter the state of the device results in the negative determination, the state of the device is not altered.

Clause 57: The method of any one of clauses 51-56, wherein the device is an environmental conditioning system component, a security system component, a health system component, an electrical system component, a communication system component, and/or a personnel convection system component.

Clause 58: The method of any one of clauses 51-57, wherein the user permission scheme varies over time.

Clause 59: The method of any one of clauses 51-58, wherein the user permission scheme indicates permissions for the user that vary based at least in part on a geographic location of the user relative to the facility.

Clause 60: The method of any one of clauses 51-59, wherein the user permission scheme is based at least in part on a role of the user within an organization.

Clause 61: The method of any one of clauses 51-60, wherein the user permission scheme is based at least in part on input from a plurality of users other than the user.

Clause 62: The method of clause 61, wherein the user permission scheme indicates that the user is not permitted to alter the state of the device in response to determining that a majority of the plurality of users disagree with the input indicative of the preference.

Clause 63: An apparatus for controlling a facility, the apparatus comprising at least one processor configured to: operatively couple to a device of the facility and to a network; receive, or direct receipt of, an input from a user, which input is indicative of a preference associated with a state of the device of the facility, which input is received through the network; determine, or direct determination of, whether to alter the state of the device based at least in part (i) on the input and (ii) on a user permission scheme, which determination of whether to alter the state of the device results in a positive determination or in a negative determination; and alter, or direct alteration of, the state of the device based at least in part on the positive determination.

Clause 64: A non-transitory computer-readable program instructions for controlling a facility, the non-transitory computer-readable program instructions, when read by one or more processors operatively coupled to a network, cause the one or more processors to execute operations comprising executing, or directing execution of any of the methods of clauses 51-62.

Clause 65: A system for controlling a facility, the system comprising: a network configured to: transmit an input from a user, which input is indicative of a preference associated with a state of a device of the facility, which input is received through the network; transmit a determination of whether to alter the state of the device, wherein the determination is based at least in part (i) on the input and (ii) on a user permission scheme, which determination of whether to alter the state of the device results in a positive determination or in a negative determination; and transmit instructions to alter the state of the device using the positive determination.

Clause 66: An apparatus for controlling a facility, the apparatus comprising at least one controller configured to: operatively couple to a device of the facility, and to a network; condition, or direct conditioning of, the device to a state of the device; determine, or direct determination of, whether to alter the state of the device based at least in part (i) on an input from a user and (ii) on a user permission scheme, which determination of whether to alter the state of the device results in a positive determination or in a negative determination, which input is received through the network; and alter, or direct alteration of, the state of the device based at least in part on the positive determination.

Clause 67: A non-transitory computer-readable program instructions for controlling a facility, the non-transitory computer-readable program instructions, when read by one or more processors, cause the one or more processors to execute operations comprising: operatively couple to a device of the facility and to a network; conditioning, or directing conditioning of, the device to a state of the device; determining, or directing determination of, whether to alter the state of the device based at least in part (i) on an input from a user and (ii) on a user permission scheme, which determination of whether to alter the state of the device results in a positive determination or in a negative determination; and altering, or directing alteration of, the state of the device based at least in part on the positive determination, which input is received through the network.

In one or more aspects, one or more of the functions described herein may be implemented in hardware, digital electronic circuitry, analog electronic circuitry, computer software, firmware, including the structures disclosed in this specification and their structural equivalents thereof, or in any combination thereof. Certain implementations of the subject matter described in this document also can be implemented as one or more controllers, computer programs, or physical structures, for example, one or more modules of computer program instructions, encoded on a computer storage media for execution by, or to control the operation of window controllers, network controllers, and/or antenna controllers. Any disclosed implementations presented as or for electrochromic windows can be more generally implemented as or for switchable optical devices (including windows, mirrors, etc.).

Various modifications to the embodiments described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the devices as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

While operations are depicted in the drawings in a particular order, this does not necessarily mean that the operations are required to be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for controlling a facility, the method comprising:
receiving an input from a user indicating that a first state of a device of the facility is to be altered to a second state, wherein the input is received through a network;
predicting a third state for the device at a future time at least in part by using a machine learning model that considers the input from the user; and
(I) suggesting the third state and/or (II) conditioning the device to be at the third state at the future time.

2. (canceled)

3. (canceled)

4. The method of claim 1, wherein suggesting the third state comprises (a) suggesting conditioning the device to be at the third state at the future time and/or (b) suggesting conditioning the device to be at the third state at a plurality of future times responsive to determining that a set of conditions have occurred, which set of conditions are under which the input was received.

5. The method of claim 4, further comprising providing a user response to the suggestion to the machine learning model.

6. The method of claim 1, wherein the machine learning model constructs a training sample based at least in part on the input received, and wherein the training sample is usable to generate future predictions by the machine learning model.

7. The method of claim 6, wherein the facility is a first facility, wherein the user is a first user, and wherein the future predictions (i) are related to a second facility other than the first facility and/or (ii) are related to a second user other than the first user.

8.-14.

15. The method of claim 1, wherein the input is received under a set of conditions, and wherein conditioning the device to be at the third state at the future time is responsive to detection of the set of conditions occurring at the future time.

16. (canceled)

17. (canceled)

18. The method of claim 1, wherein the machine learning model considers the input at least in part by causing the device to be conditioned at the third state at the future time.

19. The method of claim 1, wherein the machine learning model considers the input at least in part by determining whether one or more parameters associated with the input match one or more parameters of (i) a rule-based pattern generated by the machine learning model and/or (ii) a heuristic used by the machine learning model.

20.-31. (canceled)

32. A method for controlling a facility, the method comprising:
obtaining from a user an input indicative of a preference associated with a present state of a device of the facility under a set of conditions, wherein the input is obtained through a network;
updating a database to include the input of the user:
identifying, based at least in part on the database, an action to be associated with the set of conditions; and
transmitting through the network one or more signals associated with the action.

33. The method of claim 32, wherein the input comprises feedback from the user regarding the present state of the device.

34. (canceled)

35. The method of claim 32, wherein the action comprises suggesting conditioning the device to be at a different state other than the present state at a future time.

36. The method of claim 35, wherein suggestion of the conditioning is provided to a user other than the user from whom the input is obtained.

37. The method of claim 32, wherein the action to be associated with the set of conditions is identified at least in part by identifying (i) a rule-based pattern and/or (ii) heuristic associated with the set of conditions.

38. (canceled)

39. (canceled)

40. The method of claim 32, wherein the action is identified based at least in part on input obtained from a plurality of users other than the user.

41.-50. (canceled)

51. A method for controlling a facility, the method comprising:
receiving an input from a user, which input is indicative of a preference associated with a state of a device of the facility, which input is received through a network:
determining whether to alter the state of the device based at least in part (i) on the input and (ii) on a user permission scheme, wherein the determination of whether to alter the state of the device results in a positive determination or in a negative determination; and
using the positive determination to alter the state of the device.

52. (canceled)

53. The method of claim 51, wherein the positive determination occurs in response to determining that the input indicates change of the state of the device of the facility and the user has permission to alter the state of the device.

54. (canceled)

55. (canceled)

56. (canceled)

57. The method of claim 51, wherein the device is an environmental conditioning system component, a security system component, a health system component, an electrical system component, a communication system component, and/or a personnel convection system component.

58. The method of claim 51, wherein the user permission scheme varies over time.

59. (canceled)

60. The method of claim 51, wherein the user permission scheme is based at least in part on a role of the user within an organization.

61. The method of claim 51, wherein the user permission scheme is based at least in part on input from a plurality of users other than the user.

62. The method of claim 61, wherein the user permission scheme indicates that the user is not permitted to alter the state of the device in response to determining that a majority of the plurality of users disagree with the input indicative of the preference.

63.-67. (canceled)
